(19) United States
(12) Patent Application Publication
(10) Pub. No.: US 2017/0316324 A1
(43) Pub. Date: Nov. 2, 2017

(54) Computerized Event-Forecasting System and User Interface

(71) Applicant: Virginia Polytechnic Institute and State University, Blacksburg, VA (US)

(72) Inventors: Christopher L. Barrett, Blacksburg, VA (US); Madhav V. Marathe, Blacksburg, VA (US); Bryan Lewis, Blacksburg, VA (US); Vivek Bharath Akupatni, Jersey City, NJ (US)

(21) Appl. No.: 15/499,423

(22) Filed: Apr. 27, 2017

Related U.S. Application Data
(60) Provisional application No. 62/328,076, filed on Apr. 27, 2016.

(51) Int. Cl. G06N 5/04

(52) U.S. Cl. CPC G06N 5/04

(57) ABSTRACT

Systems, methods, and computer-readable media for simulating the course of an event or for collecting data for the simulation are provided. A processing unit can receive attributes of synthetic populations and corresponding forecasts of progress of an event, e.g., an epidemic. The processing unit can determine a disease model based on the forecasts and historical data of the event. The disease model can be associated with at least one attribute of each of the synthetic populations. The processing unit can determine a forecast of the progress of the event based on the received forecasts and weights associated with user accounts. In some examples, the processing unit can receive the attributes, present via a user interface a plurality of candidate forecasts of an epidemic, and receive via the user interface a forecast, e.g., rankings or data, of the epidemic with respect to the synthetic population indicated by the attributes.

### CROSS-REFERENCE TO RELATED APPLICATIONS

This application is a nonprovisional application of, and claims priority to and the benefit of, U.S. Provisional Patent Application Ser. No. 62/328,076, filed Apr. 27, 2016, and entitled “Event Forecasting System,” the entirety of which is incorporated herein by reference.

### STATEMENT OF FEDERALLY SPONSORED RESEARCH OR DEVELOPMENT

This invention was made with Government support under Contract No. HDTRA1-11-D-0016-0001 awarded by the Defense Threat Reduction Agency, Contract No. HDTRA1-11-1-0016 awarded by the Defense Threat Reduction Agency, Contract No. 2U01GM070694-09 awarded by the National Institutes of Health, and Contract No. CNS-1011769 awarded by the National Science Foundation. The government has certain rights in the invention.

### BACKGROUND

The progress of an epidemic or other extended-duration event can be subject to a wide variety of influences. Consequently, it can be difficult to forecast the progress of such events.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items. The attached drawings are for purposes of illustration and are not necessarily to scale. For brevity of illustration, in the diagrams herein, an arrow beginning with a diamond connects a first component or operation (at the diamond end) to at least one second component or operation that is or can be included in the first component or operation.

FIG. 1 is a block diagram illustrating a data-collection or analysis system according to some implementations.

FIG. 2 is a block diagram illustrating components of a data-collection or analysis system according to some implementations.

FIG. 3 shows an example system architecture.

FIG. 4 is a dataflow diagram of an example process for determining a disease model.

FIG. 5 is a dataflow diagram of an example process for determining a disease model.

FIG. 6 is a dataflow diagram of an example process for determining a disease model or an epidemic forecast.

FIG. 7 is a dataflow diagram of an example process for determining a disease model.

FIG. 8 is a dataflow diagram of an example process for determining a forecast of progress of an event (e.g., an epidemic).

FIG. 9 is a dataflow diagram of an example process for determining a forecast of progress of an event.

FIG. 10 is a dataflow diagram of an example process for collecting forecasts of an epidemic.

FIG. 11 is a dataflow diagram of an example process for collecting forecasts of an epidemic.

FIG. 12 illustrates example process(es), data items, and components, for collecting and processing forecasts.

FIG. 13 shows an example user interface including a ranking widget.

FIG. 14 shows an example user interface including a different ranking widget prepared to collect data.

FIG. 15 shows the ranking widget of FIG. 14 after collecting data.

FIG. 16 shows an example widget prepared to receive a modification of a forecast curve.

FIG. 17 shows the widget of FIG. 16 after collecting data of the modification.

FIG. 18 shows an example system model.

FIG. 19 shows an example database schema.

FIG. 20 shows an example of combining forecasts.

FIG. 21 illustrates an organizational chart for a situation analysis system, according to an example embodiment.

FIG. 22A illustrates a flow diagram showing the flow and structure of information using the situation analysis system, according to an example embodiment.

FIG. 22B illustrates a flow diagram of a process that may be used by the situation analysis system to construct a synthetic population, according to an example embodiment.

FIG. 22C illustrates an example of the flow of information described in FIGS. 2A and 2B using the situation analysis system, according to an example embodiment.

FIG. 22D illustrates an example of the flow of information that may be used to allocate spectrum, according to an example embodiment.

FIG. 23 illustrates a hierarchical block diagram showing components of a synthetic data set subsystem of the situation analysis system, according to an example embodiment.

FIG. 24A illustrates a flow diagram showing an example data retrieval and broker spawning process that may be performed by the synthetic data set subsystem, according to an example embodiment.

FIGS. 24B through 24D illustrate three example broker structures showing different ways the synthetic data set subsystem may partition information using brokers, according to an example embodiment.

FIG. 24E illustrates a diagram of a control structure relating to a management module of the synthetic data set subsystem, according to an example embodiment.

FIG. 25 illustrates a flow diagram for a process that may be used by a population construction module of the synthetic data set subsystem to create and/or modify a synthetic population, according to an example embodiment.

FIG. 26 illustrates a sample user interface that may be utilized by a user to interact with the situation analysis system, according to an example embodiment.

### DETAILED DESCRIPTION

### Overview

Various examples relate generally to the field of computerized analysis systems. Various examples relate to systems for performing predictive analysis of various types of events or other complex situations, such as epidemiological events.

Reliably forecasting complex events such as influenza epidemics and other types of epidemics can be challenging. Computerized forecasting of influenza epidemics, as one example, is subject to a variety of difficulties. For example, each flu season varies in timing and intensity, new virus strains are introduced, surveillance data may not be available, and the rate of occurrence can depend on a variety of variables (biological, behavioral, climate factors). Many forecasting models make certain assumptions regarding the events. For example, for infectious disease, the models may make assumptions regarding disease transmission, effect of control measures, etc.

According to various example embodiments, the present disclosure provides systems and methods for forecasting complex events, such as the spread of an epidemic, e.g., using input from multiple data sources. The data sources can include computerized sources, users, experts, or other entities. Example implementations of the present disclosure can utilize such input in conjunction with surveillance and/or other types of data to improve forecasting models of epidemic spread and other complex events.

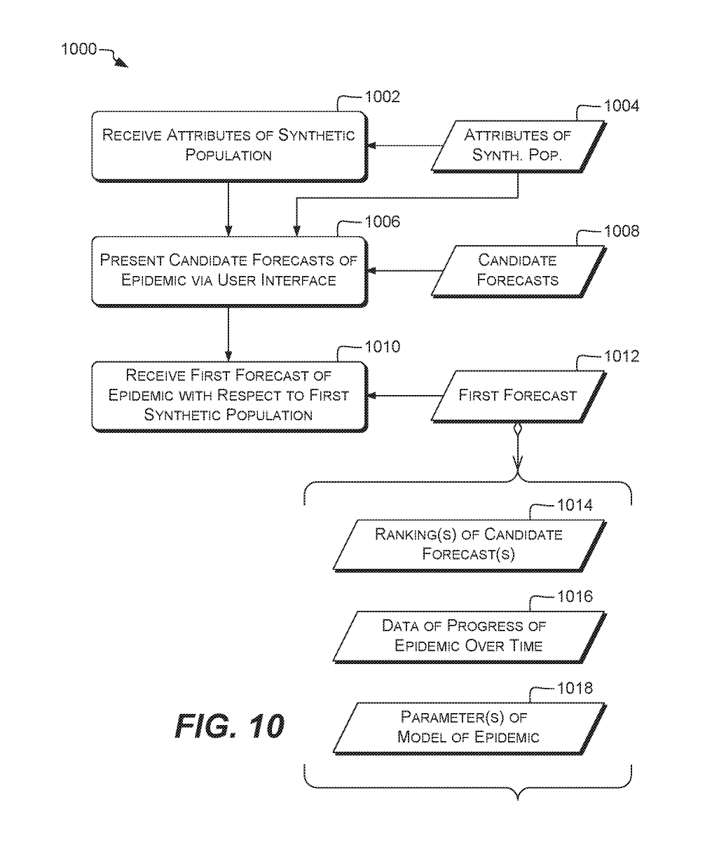

In some embodiments, on a periodic (e.g., weekly) basis, registered users can log in to a user interface of the system, e.g., via a web portal, an application on a computing device (such as a smartphone app or native desktop application), a kiosk interface, etc. Examples user interfaces are described herein with reference to at least user interface 240, client 304, or FIG. 10-17 or 26. Via the user interface, users can, e.g., based on their own past experience and/or using surveillance data (e.g., surveillance plots) as a guide, rank or set in a desired order a series of epidemic forecasts. For example, using drag-and-drop or other user interface functionality, a user may designate a graph the user thinks best indicates the epidemic's path forward as a first selection (e.g., drag the graph into a first position in the interface), then designate a second graph thought by the user to be the second-best indication of the epidemic's path forward as a second selection, and so on. The user can also modify forecasts and save them as his or her own predictions (“individualized forecasts”) of how the epidemic will progress, in some implementations. The system may generate analytical reports that allow users to see how the responders are ranking forecasts. In some examples, access can be provided to non-registered users, e.g., who complete a CAPTCHA. In some examples, users (e.g., registered users or non-registered users) can provide input other than periodically. Some examples herein can be configured to receive user inputs at any time, using candidate forecasts or other information available at that time.

In some embodiments, a geolocation map or other indication of geographic origin may provide an analyst with an indication of the geographic origin from which the responses are received (e.g., city, state, county, county, CDC HHS region, etc.). In various embodiments, the systems and methods of the present disclosure may combine data received by way of user input with forecasts generated by computer models to develop aggregate forecasts of public health, social, and/or economic phenomena, among other types of phenomena (e.g., physical occurrences). In some examples, using a wider range of input sources can permit improving epidemiological or other event forecasting models, compared to some prior schemes. For example, by capturing data from users regarding disease forecasts (data unavailable to some prior schemes), the uncertainty of the computational models can be reduced and the predictive accuracy of the models can be improved. Further, various implementations of the present disclosure permit readily deploying and seamlessly integrate new processes (e.g., algorithms) for combining human experiential knowledge with system-generated predictions.

Various examples can permit estimating the progress of an event, e.g., an extended event that goes on over a period of time, or a point-in-time event that has consequences that extend over time or occur after the event itself. For point-in-time events, the “progress of the event” as used herein includes a time period after the event during which the consequences of the event occur or play out. Events can include epidemics, e.g., Ebola, influenza, SARS, Zika, or other infectious diseases. Additionally or alternatively, events can include life-changing events, such as changing jobs, relocating, adding a child to a family (e.g., by birth or adoption), marriage, or other events that significantly affect an entity over time.

As used herein, “consequences” are any results or outcomes of the event, or changes in event state or state of systems affected by the event. The “progress of an event” refers to the progress of the event itself or of its consequences, e.g., as determined via simulation or forecasting as described herein. The term “consequence” is used herein without regard to whether any particular consequence may be considered by any party to be beneficial or harmful. Consequences themselves can be ongoing or point-in-time. For example, the spread of a disease can be a consequence of an epidemic, since it involves changes in the state of the epidemic (the event) itself. In another example, closure of schools and offices can be a consequence of an electric blackout (an event), since it involves changes in the state of systems (the schools or offices) affected by the event.

Various examples herein can more effectively account for diversity along a number of event dimensions. In some implementations of an epidemic forecasting system, such dimensions may include, but are not limited to: types of infectious diseases; geographic regions; different types of forecasting models; varying uncertainty bounds for the models; varying time periods/seasons; different surveillance data sources; and/or different quality metrics for evaluating the forecasting models.

Some examples may provide a flexible architecture for receiving input data from various sources, and the architecture may allow the system to integrate with forecasting pipelines provided by other systems (e.g., to share data across the systems). Some examples may provide a functional user interface that allows users to develop scripts for populating data from different surveillance and/or forecasting data sources without requiring the users to have specialized technical knowledge regarding generation of the scripts. For example, the system back end may include a functional user interface (e.g., graphical user interface, or GUI) that can be used for data population that abstracts many of the complex details of the system by providing a simple user interface (e.g., web-based form) for entering and modifying data (e.g., dynamically).

In some examples, the front end and back end may be de-coupled from one another, and application programming interfaces (APIs) may be used to communicate between the front end and back end components. This may provide flexibility and allow the system to scale horizontally. Some examples may reduce the amount of time and effort involved in launching predictions for new diseases, geographic regions, forecasting models, etc., as well as for deploying new APIs. Some examples may use a platform providing access to flexible queries, data collection features, and/or machine-learning algorithms. Some examples may register users and authenticate the user through a login interface before receiving input, which helps the system track user participation, compute user-related analytics, and ensure accuracy of the received data (e.g., helps ensure the data is not corrupted by a large number of anonymous responses from a single user).

Various example systems and methods herein may conduct analyses through interaction with various information resources. For example, information about population characteristics, disease characteristics, intervention options, and/or various other types of information may be retrieved from one or more of a variety of information sources. Such information can be used in combination with data received via user interfaces such as those described herein with reference to FIGS. 10-17 to perform epidemic forecasting, in some examples. In some implementations of the present disclosure, the analysis system may incorporate and/or work in coordination with a system that incorporates components designed to transmit requests for information to different information sources and retrieve the information from those sources to perform various tasks.

Various examples permit integrating user-provided data with machine-generated forecasts to develop better predictive models. Various examples simplify the addition of new diseases, forecasting models, geographical regions, and other dimensions of epidemics. Various examples provide a platform having the ability to quickly deploy, and seamlessly integrate, new algorithms for performing data integration.

### Illustrative Systems and Components

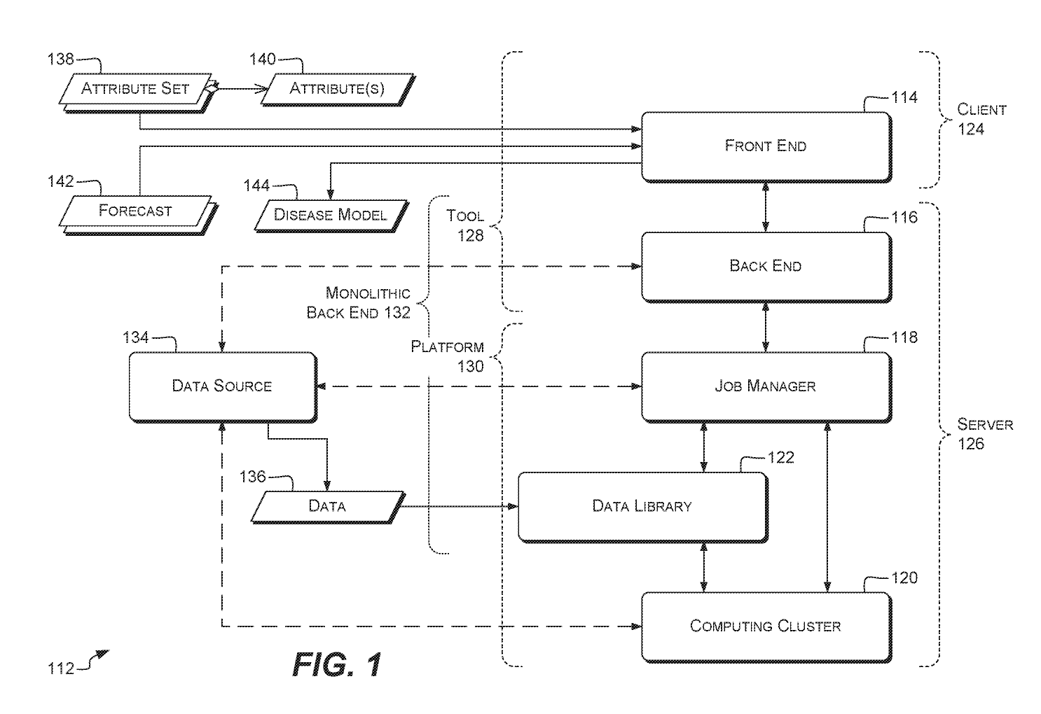

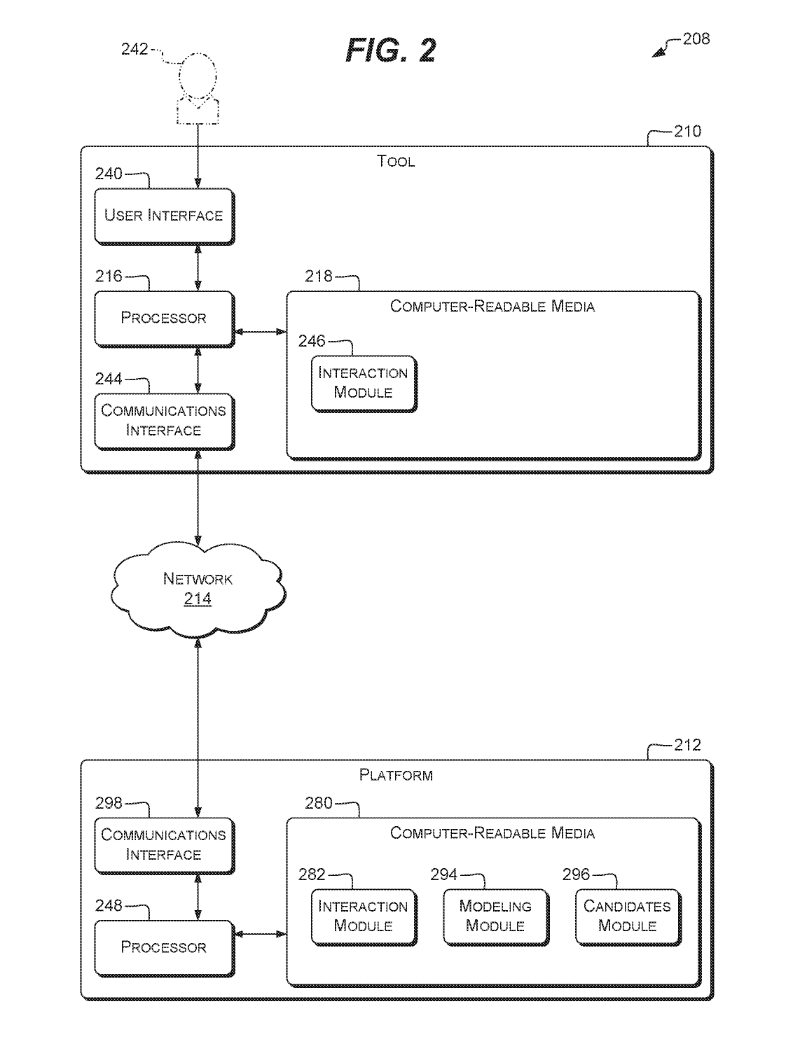

FIG. 1 is a block diagram illustrating a system 112 according to some examples. The system includes various computing devices and services, which can be connected with each other via, e.g., a telecommunications network such as the Internet or a private Ethernet. Front end 114 can include, e.g., a Web browser executable on a user's computer, a smartphone app, or a native (e.g., Win32) PC application. Back end 116 can include, e.g., a Hypertext Transfer Protocol (HTTP) server or code executing thereon (e.g., a servlet or Common Gateway Interface script), a Web Services server, or another server configured to exchange data with the front end 114. A job manager 118 can interact with a computing cluster 120 (or, for brevity, “cluster”) to provide responses to requests. For example, job manager 118 can include middleware configured to receive requests from the back end 116, determine and run corresponding jobs on the cluster 120, and provide the results to the back end 116 for transmission to the front end 114. Examples of the front end 114 are described herein with reference to at least FIGS. 2, 3, 10-20, and 26. Examples of the back end 116, the job manager 118, and the computing cluster 120 are described herein with reference to at least FIGS. 2-9 and 21-25.

The job manager 118 and the computing cluster 120 can communicate at least partly via, or can share access to, a data library 122. Data library 122 can include data of a synthetic population. For example, data library 122 can include a graph comprising nodes representing synthetic entities, such as people, plants, animals, cells in a body, or other entities capable of interacting. Data library 122 can include edges linking the nodes. The edges can include labels, e.g., indicating that two linked entities interact in certain locations or contexts, or with certain frequencies.

As shown, in some examples, front end 114 is a client 124 of services provided by a server 126. Server 126, which can represent one or more intercommunicating computing devices, can include at least one of each of: back end 116, job manager 118, cluster 120, or data library 122. In some examples, server 126 can include a single data library 122 and multiple back ends 116, job managers 118, or clusters 120. In some examples, client 124 and server 126 are disjoint sets of one or more computing devices.

System 112 can include at least two types of functionality, illustrated as tool 128 and platform 130. Tool 128 can include front end 114 and back end 116. Platform 130 can include job manager 118, cluster 120, and data library 122. In some examples, tool 128 implements a solution for a specific use case. For example, tool 128 can provide facilities for estimating the progress of an epidemic, for estimating the progress of another type of event, for collecting estimates of the progress of an event, for determining models representing an event, e.g., disease models representing an epidemic, or for performing other specific analyses. Platform 130 can provide services usable by various tools 128, e.g., computational resources and access to the data library 122. Although only one tool 128 is shown, multiple tools 128 can access the platform 130 sequentially or concurrently. In some examples, multiple tools 128 can interact with each other directly or via services provided by platform 130. In some examples, one tool 128 writes specific data to the data library 122 and a different tool 128 reads the specific data from the data library 122.

In some examples, a tool 128 may include at least some functions of the job manager 118 or the data library 122. For example, at least a portion of a back end 116 for a specific tool 128 may be combined with at least portions pertinent to that tool of the job manager 118 or the data library 122. Such a combination is referred to herein as a “monolithic back end” or “MBE.” An example monolithic back end 132 is shown. In some examples, front end 114 communicates with monolithic back end 132, which in turn communicates with computing cluster 120.

In some examples, a specific tool 128, or the platform 130, can interact with a data source 134, as shown by the dashed lines. The data source can be or include, e.g., a Web server, sensor, or other source of data 136 to be loaded into data library 122. The platform 130 can load the data 136 into the data library 122.

In some examples herein, tool 128 is a tool for forecasting, or for collecting and processing forecasts of, the progress of an event, e.g., an extended event that goes on over a period of time, or a point-in-time event with extended consequences. An example of such an event is an epidemic among human, animal, or plant populations. As discussed in more detail below, the front end 114 can receive attribute sets 138 including attributes 140 of respective synthetic populations. Each synthetic population can include, e.g., a subset of the data library 122. The tool 128 can select a synthetic-population (SP) graph from the data library 122, e.g., using services provided by the job manager 118. The front end 114 can receive data of forecasts 142 of progress of the event in respective ones of the synthetic populations. The tool 128 can then determine a disease model 144 of the epidemic. Disease model 144 can represent a progress model of an event other than an epidemic. The front end 114 can present the disease model 144, e.g., via a user interface such as a Web page.

The illustrated computing devices, e.g., front end 114, back end 116, job manager 118, or devices of cluster 120, can be or include any suitable computing devices configured to communicate over a wireless and/or wireline network. Examples include, without limitation, mobile devices such as a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar devices. Other examples include, without limitation, devices that are generally stationary, such as televisions, desktop computers, game consoles, set top boxes, rack-mounted servers, and the like. As used herein, a message “transmitted to” or “transmitted toward” a destination, or similar terms, can be transmitted directly to the destination, or can be transmitted via one or more intermediate network devices to the destination.

FIG. 2 is a block diagram illustrating a system 208 permitting collecting data about events and determining models of those events according to some implementations. The system 208 includes a tool 210, which can represent tool 128. Solely for brevity of explanation, tool 210 is shown as an integrated computing device without distinguishing front end 114 from back end 116. Tool 210 can be coupled to platform 212, which can represent platform 130, via network 214, e.g., a cellular network or a wireline data network. In some examples, network 214 can include at least one cellular network, IEEE 802.1* network such as an 802.11 (WIFI) or 802.15.1 (BLUETOOTH) network, wired Transmission Control Protocol/Internet Protocol (TCP/IP) or IPv6 network, Asynchronous Transfer Mode (ATM) network, Public Switched Telephone Network (PSTN), or optical network (e.g., Synchronous Optical NETwork, SONET). In examples using an MBE 132, the MBE 132 can perform some, but fewer than all, of the illustrated functions of tool 210 and some, but fewer than all, of the illustrated functions of platform 212.

Tool 210 can be or include a wireless phone, a wired phone, a tablet computer, a laptop computer, a wristwatch, or other type of computing device as noted above. Tool 210 can include at least one processor 216, e.g., one or more processor devices such as microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs). Tool 210 can further include one or more computer readable media (CRM) 218, such as memory (e.g., random access memory, RAM, solid state drives, SSDs, or the like), disk drives (e.g., platter-based hard drives), another type of computer-readable media, or any combination thereof.

The tool 210 can further include a user interface (UI) 240 configured for communication with a user 242 (shown in phantom). User 242 can represent an entity, e.g., a system, device, party, and/or other feature with which tool 210 can interact. For brevity, examples of user 242 are discussed herein with reference to users of a computing system; however, these examples are not limiting. In some examples, the entity depicted as user 242 can be a computing device. The user interface 240 or components thereof, e.g., the electronic display device, can be part of the front end 114 (e.g., as illustrated in FIG. 1) or integrated with other components of tool 210.

User interface 240 can include one or more input devices, integral and/or peripheral to tool 210. The input devices can be user-operable, and/or can be configured for input from other computing devices of tool 210 or separate therefrom. Examples of input devices can include, e.g., a keyboard, keypad, a mouse, a trackball, a pen sensor and/or smart pen, a light pen and/or light gun, a game controller such as a joystick and/or game pad, a voice input device such as a microphone, voice-recognition device, and/or speech-recognition device, a touch input device such as a touchscreen, a gestural and/or motion input device such as a depth camera, a grip sensor, an accelerometer, another haptic input, a visual input device such as one or more cameras and/or image sensors, a pressure input such as a tube with a pressure sensor, a Braille input device, and the like. User queries, forecasts, or other input can be received, e.g., from user 242, via user interface 240. In some nonlimiting examples, the input received from the user 242 via the user interface 240 can represent, include, or be based on data or factors the user deems to be relevant to an epidemic or other event being simulated, or for which forecasts are being or have been prepared.

User interface 240 can include one or more result devices configured for communication to a user and/or to another computing device of or outside tool 210. Result devices can be integral and/or peripheral to tool 210. Examples of result devices can include a display, a printer, audio speakers, beepers, and/or other audio result devices, a vibration motor, linear actuator, Braille terminal, and/or other haptic result device, and the like. Actions, e.g., presenting to user 242 information of or corresponding to a result of an analysis (e.g., disease model 144), can be taken via user interface 240.

The tool 210 can further include one or more communications interface(s) 244 configured to selectively communicate via the network 214. For example, communications interface(s) 244 can include or operate one or more transceivers or radios to communicate via network 214. In some examples, communications interface(s) 244, or an individual communications interface 244, can include or be communicatively connected with transceivers or radio units for multiple types of access networks.

The computer readable media 218 can be used to store data or to store components that are operable by the processor 216 or instructions that are executable by the processor 216 to perform various functions as described herein. The computer readable media 218 can store various types of instructions and data, such as an operating system, device drivers, etc. Stored processor-executable instructions can be arranged in modules or components. Stored processor-executable instructions can be executed by the processor 216 to perform the various functions described herein.

The computer readable media 218 can be or include computer storage media. Computer storage media can include, but are not limited to, random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or memories, storage, devices, or any other tangible, non-transitory medium which can be used to store the desired information and which can be accessed by the processor 216. Tangible computer-readable media can include volatile and nonvolatile, removable and non-removable media implemented in any method or technology for storage of information, such as computer readable instructions, data structures, program modules, or other data. In contrast to computer storage media, computer communication media can embody computer-readable instructions, data structures, program modules, or other data in a modulated data signal, such as a carrier wave, or other transmission mechanism. As defined herein, computer storage media does not include computer communication media.

The computer readable media 218 can include processor-executable instructions of an interaction module 246 or other modules or components. In some example, the processor-executable instructions of the module 246 can be executed by the processor 216 to perform various functions described herein, e.g., with reference to at least one of FIG. 1, 3, 10-20, 22B, 23, 25, or 26.

The platform 212 can include at least one processor 248. The platform 212 can include one or more computer readable media (CRM) 280. The computer readable media 280 can be used to store processor-executable instructions of an interaction module 282 or other modules or components. Such modules or components can include, e.g., a modeling module 294 or a candidates module 296. The processor-executable instructions of the modules 282, 294, or 296 can be executed by the processor 248 to perform various functions described herein, e.g., with reference to at least one of FIG. 1, 3-9, 12, 18, 19, or 21-25. In some examples, an MBE 132 can perform at least some functions of modules 246, 282, 294, or 296.

In some examples, processor 248 and, if required, CRM 280 are referred to for brevity herein as a “processing unit.” Similarly, processor 216 and, if required, CRM 218 can be referred to as a “processing unit.” For example, a processing unit can include a CPU or DSP and instructions executable by that CPU or DSP to cause that CPU or DSP to perform functions described herein. Additionally or alternatively, a processing unit can include an ASIC, FPGA, or other logic device(s) wired (e.g., physically, via blown fuses, or via logic-cell configuration data) to perform functions described herein.

The platform 212 can include one or more communications interface(s) 298, e.g., of any of the types described above with reference to communications interface(s) 244. For example, platform 212 can communicate via communications interface(s) 298 with tool 210.

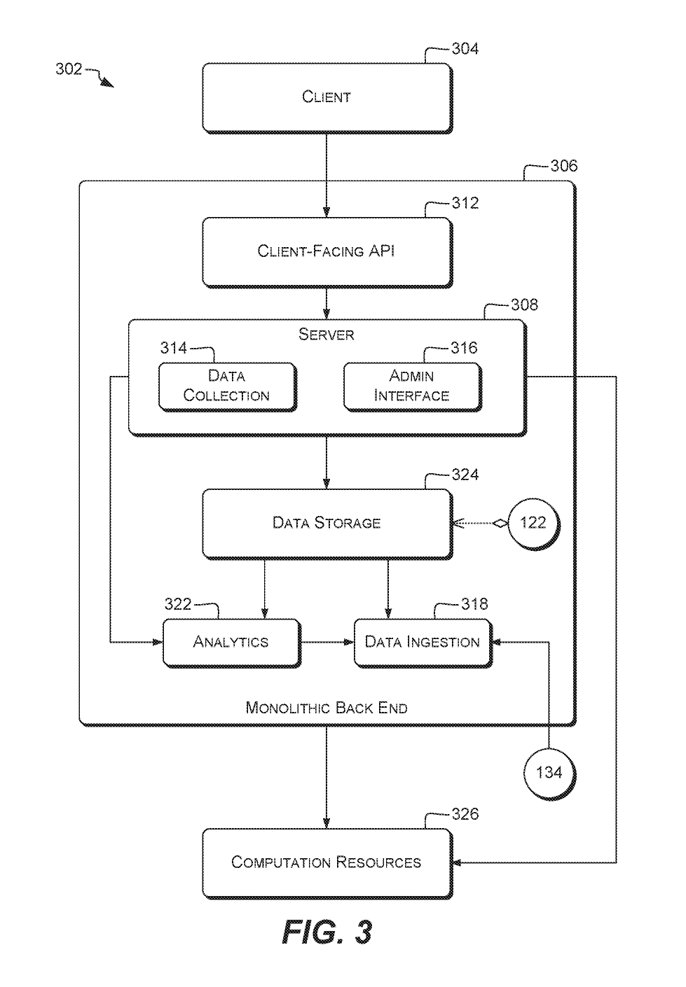

FIG. 3 shows an example system architecture 302. The architecture 302 illustrated in FIG. 3 includes a number of front end and back end components working in conjunction with one another to implement features of the system. The client component 304 can be executed on a client device (e.g., client 124 or tool 210), such as a desktop or laptop computer, smartphone, tablet, or other type of computing/processing device.

The client component 304 includes a user interface, e.g., user interface 240, through which input is received and output is provided to a user, e.g., user 242, via the client device, e.g., front end 114 or tool 210. In some implementations, the user interface may be provided via a web portal (e.g., using HTML5). In some implementations, the user interface may additionally or alternatively be provided through an application executing on the client device, such as a smartphone app. The client component 304 can interact with a monolithic back end (MBE) 306, which can represent MBE 132. For example, the client component 304 can communicate with a server 308 (e.g., a web server) of the MBE 306. The client component 304 can communicate with the server 308, e.g., through an API 312 (e.g., a web API). The API may be configured to enable communication with a variety of different types of client devices and/or platforms.

In some examples, architecture 302 is implemented using several independent components which interact with each other using well-designed APIs, e.g., API 312. In some examples, the front end 114 and back end 116 are decoupled, and data only flows between them through RESTful APIs. As a result, epidemiological data and machine learning algorithms are available to other researchers and third-party sources, e.g., as web services.

The server 308 can be configured to receive input data from and transmit output data to the client component 304 via the API 312. The server 308 can generate or provide a number of different interfaces designed to solicit input from the user and/or provide the user with information (e.g., prediction results). The server can include a data collection component 314 configured to generate interface data soliciting input from the user to be used in conjunction with forecasting models and/or surveillance data to improve prediction of future states of events. In some implementations, the data collection component 314 may also obtain data from external systems for use in predicting the future states of the events, such as systems configured to provide surveillance reporting data.

The server can additionally or alternatively include an administrative interface component 316. The administrative interface component 316 can generate or provide interfaces through which the user can implement administrative functions, such as adding or removing authorized users, customizing various aspects of the user interface, changing analysis and output parameters, etc. In some implementations, the administrative interface may be customized to the authenticated user (e.g., a user with a higher authorization level may be given different options than a user with a lower authorization level, such as changing a list of authorized users).

The MBE 306 can also include a data ingestion component 318 (which can be part of server 308 or separate therefrom). The data ingestion component 318 can inject forecasting model outputs into the system. The forecasting models may be any type of forecasting models, and may vary according to the type of event for which prediction is being performed. For example, the data ingestion component 318 may retrieve models or other data from data source(s) 134 or from data library 122.

The MBE 306 can also include an analytics component 322 (which can be part of server 308 or separate therefrom). The analytics component 322 can receive the forecasting model outputs and input from the users. The analytics component 322 can generate a consolidated (e.g., final) forecast output based on the forecasting model outputs and user feedback. The web server 308, data ingestion component 318, and/or analytics component 322 can retrieve data from and transmit data to a physical data storage component 324 of the MBE 306. The physical data storage component 324 may be or include any machine-readable storage medium. The physical data storage component 324 can be part of server 308 or separate therefrom. Additionally or alternatively, the physical data storage component 324 can be or can be a portion of data library 122, as indicated by the stippled arrow.

The server 308, data ingestion component 318, and/or analytics component 322 can utilize one or more computation resources 326, e.g., provided by the back end 116, the job manager 118, or the computing cluster 120, to perform various tasks. In some implementations, each computation resource 326 may be dedicated to performing a particular task or set of tasks. For example, a first computation resource 326 may be dedicated to submitting queries to and/or retrieving data from a first set of data sources, a second computation resource 326 may be dedicated to submitting queries to and/or retrieving data from a second set of data sources, and so on. In some implementations, each computation resource 326 may be capable of performing a variety of computational tasks, and tasks may be distributed to the computation resources 326 according to resource availability or other characteristics.

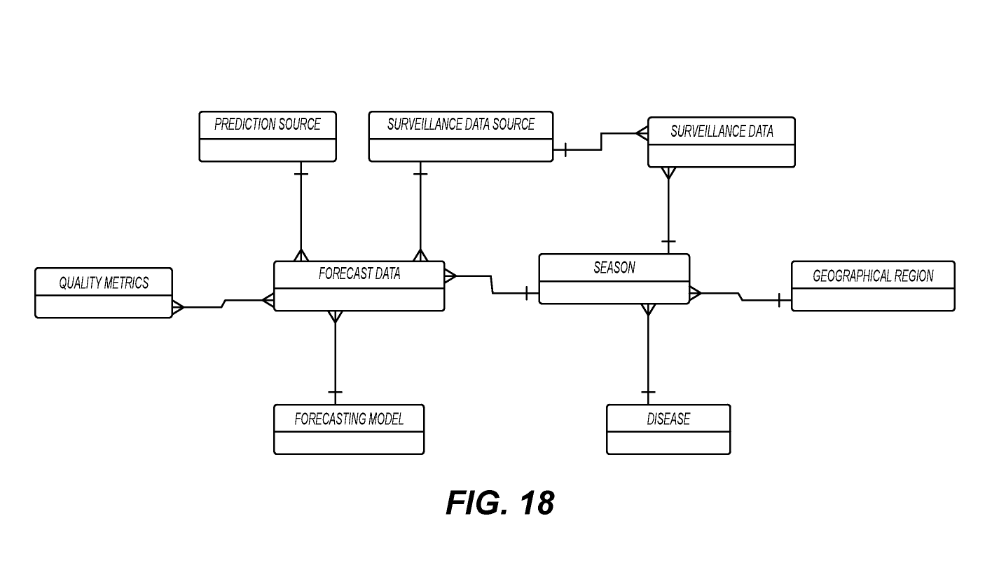

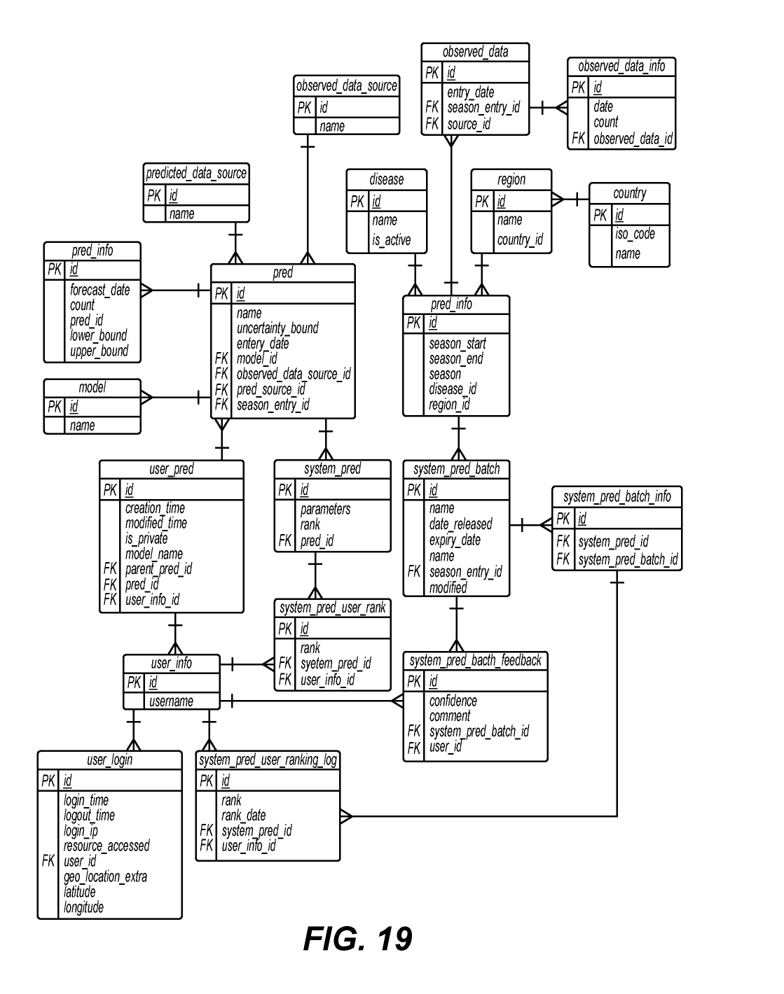

In some embodiments, the front end and back end components (e.g., client 304 and MBE 306) may communicate with one another through APIs, e.g., client-facing API 312. For example, in some implementations, various components may communicate through the use of RESTful APIs. Such APIs may provide advantages such as, but not limited to, provision of multiple versions for backward compatibility, allowing multiple representations/formats for system resources like prediction data, surveillance data sources, etc., identifying each system resource using a unique identifier (e.g., unique URL), authentication to provide security for certain system resources, and allowance of query parameters to be provided within the URL. In some implementations, every resource may have a unique identifier (e.g., URL), and the responses to APIs can be cached on both the client and server side to improve scalability and efficiency. One illustrative API structure can provide access to objects shown in FIG. 18 or 19.

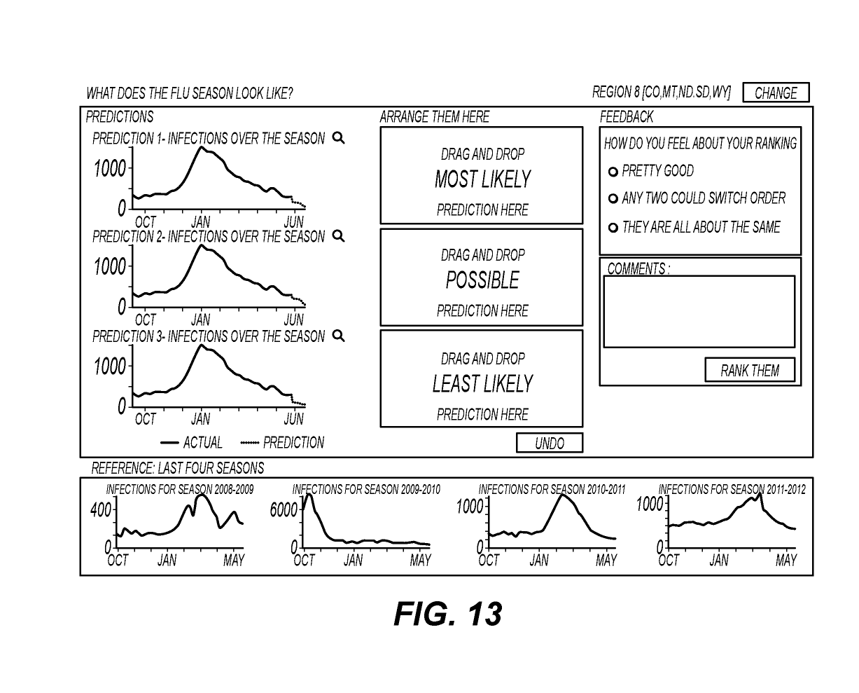

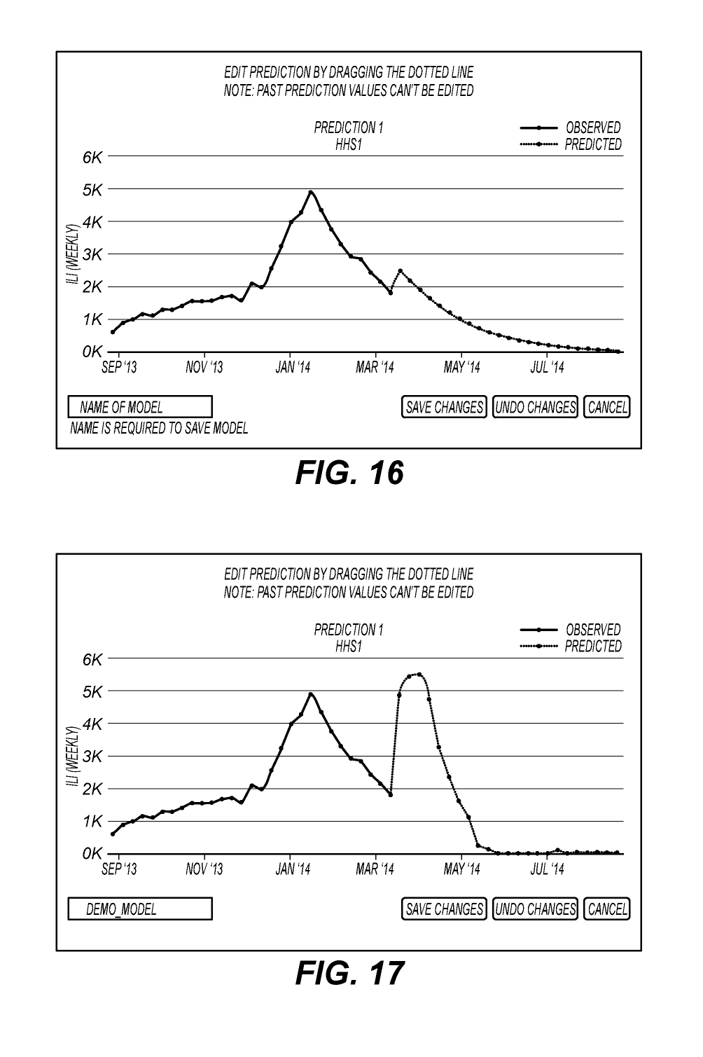

In some examples, the front end 114 or client component 304 may provide rich interactions to the user to support ranking and individualized forecasting tasks, among other possible tasks. According to some implementations, at least one of the following tasks is supported for users: (1) ranking system-generated event forecasts (e.g., in order of estimated likelihood or preference) (e.g., FIG. 13-15); or (2) providing user-specified individual predictions by modifying the system-generated forecasts and/or by providing separate data for use in generating a new forecast (e.g., FIGS. 16 and 17).

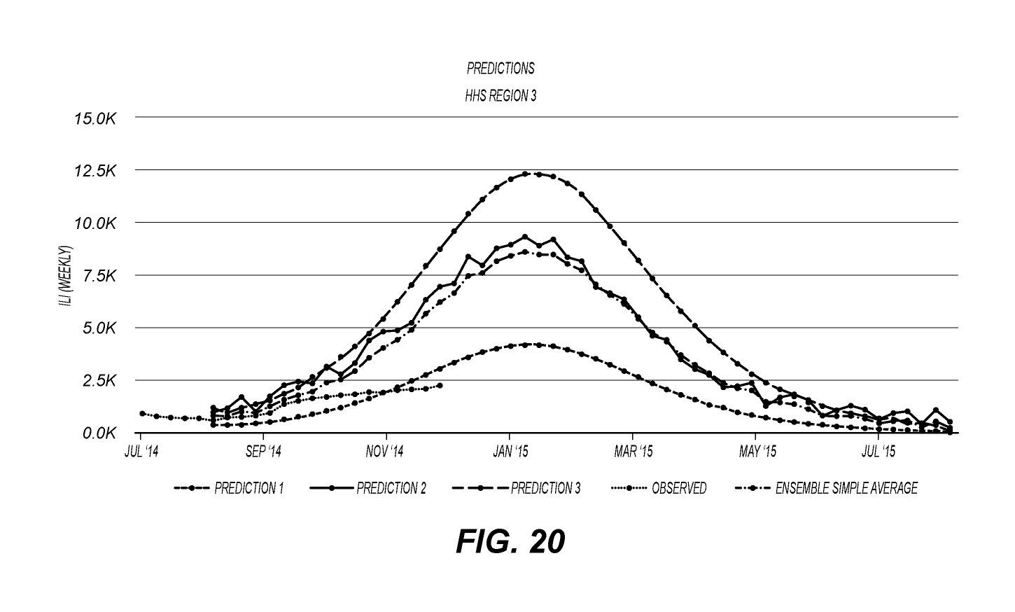

In some implementations, the client 304 can permit users 242 to rank the forecasts generated by the system in order of likelihood of occurrence, such as by dragging visual representations (e.g., graphs) of the system-generated forecasts into slots within an interface associated with different ranks. The MBE 306 can aggregate results of rankings from multiple users and use the results to modify system forecasting operations, as discussed in further detail herein, e.g., with reference to FIG. 20 or blocks 468, 654, 722, 828, or 914. Additionally or alternatively, the client 304 can permit the user 242 to provide individualized data by modifying the forecast representation and/or underlying data, e.g., by dragging portions of a curve, modifying one or more textual data points, or other operations that involve data or parameters of a forecast. Such interfaces can permit subject matter experts to provide data to the architecture 302 based on their own beliefs or intuition about how an event is likely to progress. In some prior schemes, no user interface exists to permit collecting such data. In some implementations for epidemic forecasting, the interface may allow users to modify parameters of the forecasting data such as peak value/time, first-take off value/time, intensity, duration, velocity of the epidemic, start time of the season, etc. Data collected, e.g., provided by users 242 in response to the system-generated forecasts, can be processed using machine-learning algorithms to improve the back-end disease (or other event-progress) models that provide forecasts.

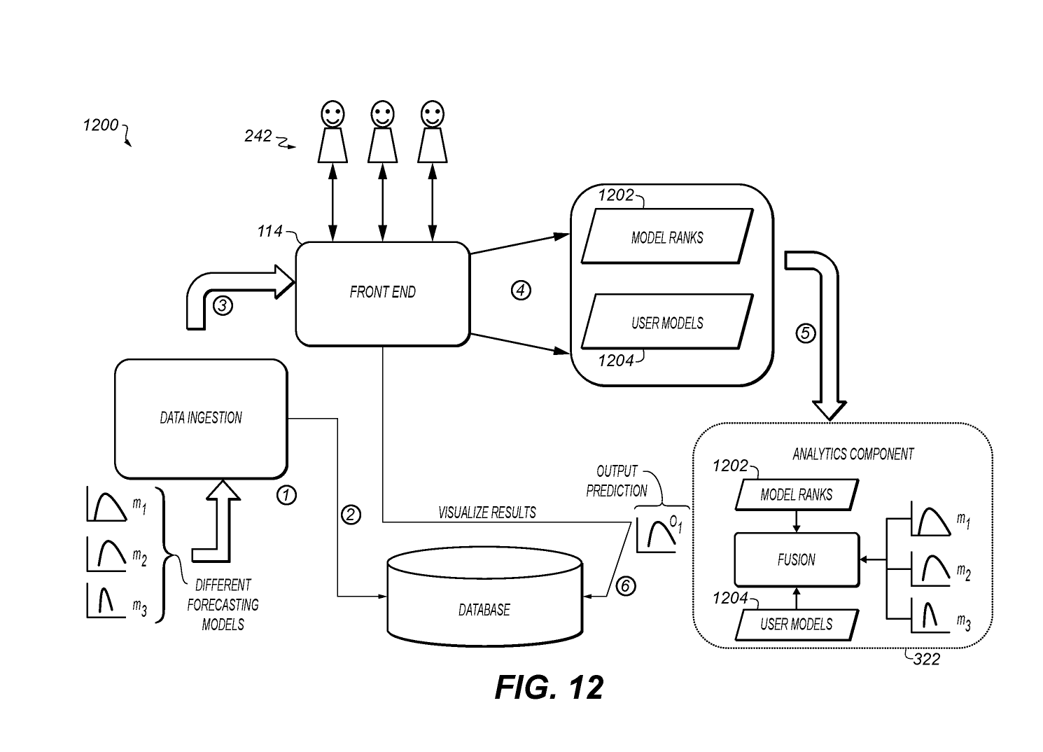

In some examples, interaction module 246 (i.e., processor 216 executing instructions of interaction module 246, and likewise throughout this document) or client 304 may perform operations described herein with reference to FIG. 10-20 or 26, e.g., blocks 1002-1010 or 1102-1120, or FIG. 12 stages 3 or 4. In some examples, data collection component 314, data ingestion component 318, administrative interface component 316, or interaction module 282 may perform operations described herein with reference to blocks 428, 436, 450, 464, 504, 516, 522, 526, 532, 536, 710, 716, 718, 802, 810, 818, or 918, or FIG. 12 stages 1, 2, or 4. In some examples, data ingestion component 318, analytics component 322, or modeling module 294 may perform operations described herein with reference to 432, 454, 468, 636-654, 706, 722, 824, 828, or 902-914, or FIG. 12 stages 1, 2, 5, or 6. In some examples, analytics component 322 or candidates module 296 may perform operations described herein with reference to blocks 506, 512, 712, 810, or 816, or FIG. 12 stages 1-3.

In some embodiments, the system may provide incentives for participation. In some embodiments, the system may provide a competition to encourage participants to participate regularly and/or invite friends/colleagues to participate. Incentives can include, or competitions can be based on, virtual points for performing particular tasks (e.g., logging in, ranking forecasts, providing individual modifications of forecasts, etc.), in some examples.

The user interface provided by the front end client 304 may utilize a Single Page Application (SPA) design, in some embodiments. Under such a design, a selection by the user 242 of a link or button causes the browser to transmit only a request for specific information to the server, and not a request for an entirely new Web page. Page elements can be preloaded onto the client device and altered on the client side. This mechanism can improve the functionality and usability of the client-side interface in a Web scenario, and can reduce the amount of data transmitted back and forth from the server to construct full pages. One implementation of a front end architecture that may be used to implement the client-side interface is shown and described below.

SPAs are a style of rich and responsive web applications, and aim to bring desktop-like user experiences to the browsers. In traditional web applications, whenever a user clicks on a link or button, the browser sends a request to the server. The server responds to the request by constructing a completely new page, and this is displayed to the user. However, in SPA, a website is loaded for the first time by fetching the necessary resources, like CSS, JavaScript, and HTML. After the first page load, only the requested information is fetched from the server on demand, and partial pages are redrawn on the client side. This mechanism reduces server round trips to construct a full HTML page as seen in traditional web applications, thereby providing an enhanced user experience. The client 304 can include at least one of the following components. Services: Responsible for communicating with the back end using web services APIs. Models: Maintains user- and system-related data at the client side. View: Responsible for displaying the data to the user. Controller: Handles user interactions and coordinates the communication between models and services. Various examples use a client-side JavaScript framework such as ANGULARJS.

In some implementations, the system may be designed using a modular architecture and/or system data may be represented in a relational format. Using a relational format can permit execution of flexible queries based on combinations of parameters, such as geographical region, surveillance data source, forecasting method, etc. One illustrative conceptual model and database schema useful for forecasting of an epidemic such as the flu is provided in FIGS. 18 and 19.

FIGS. 12-20 show various aspects of an epidemic forecasting system according to an illustrative implementation. In some examples, the back end is written in Python and uses Django, a high-level Python web framework, to provide the server component. The reasons for choosing the Python ecosystem (Django can be viewed as Python extension) are that it encourages rapid application development and has excellent libraries for scientific programming, data statistics, and data manipulation. Thus, the Python ecosystem provides building blocks to permit reusing existing components. An example system uses the MySQL database for its storage needs, although this could easily be configured to use other back end databases like PostgreSQL or Oracle.

### Illustrative Processes

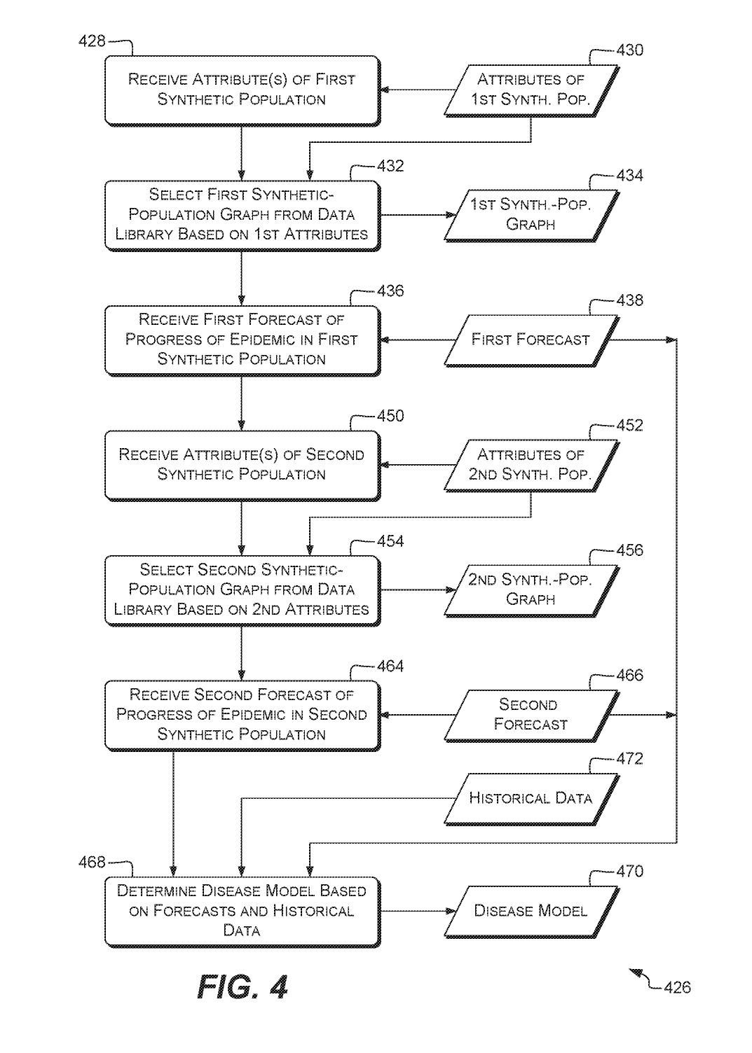

FIG. 4 illustrates an example process 426 for determining a disease model (or other progress model of an event), and associated data items. In some examples, operations described below with reference to FIGS. 4-7 can be performed by a server 126 including one or more computing devices or processors, e.g., in response to computer program instructions of modules 282, 294, or 296.

Operations shown in FIGS. 4-11 can be performed in any order except when otherwise specified, or when data from an earlier step is used in a later step. Any operation shown in multiple figures can be as discussed with reference to the first figure in which that operation is shown. For clarity of explanation, reference is made in the discussion of the flowcharts to various components or data items shown in FIG. 1-3 or 12-26 that can carry out or participate in the steps or operations of the example method. It should be noted, however, that other components can be used; that is, example method(s) shown and described herein are not limited to being carried out by the identified components.

In some examples, at block 428, server 126 can receive an attribute set 138 including first attributes 430 of (e.g., designating or defining) a first synthetic population (referred to as “synth. popin.,” “synth. pop.,” “s. p.,” or “SP” throughout this description and figures). For example, attribute set 138 can be, or be included in, a query received via a user interface 240 of front end 114 or client 304. Block 428 can be performed, e.g., by the user interface 240 or the interaction module 282 shown in FIG. 2. The attributes can specify, e.g., a geographic area in which an event, e.g., an epidemic, is taking place, or which people are in affected or vulnerable populations. The attributes 430 can be part of a set of initial conditions.

The initial conditions can indicate synthetic entities to be initially marked as infected with a disease or otherwise affected by an event. This can provide users, e.g., researchers, an increased degree of control at simulating specific situations, e.g., travelers carrying diseases between countries. Initially-infected entities can be indicated by identification or by characteristics of those to be marked as infected before the beginning of the simulation. In some examples, the synthetic entities initially marked as infected can be selected at random (or pseudorandom, and likewise throughout this document) from an entire synthetic population or from sub-populations thereof matching specified conditions.

In some examples, at block 432, server 126 can select a first synthetic-population graph 434 from the data library 122 based at least in part on the first attributes 430 in the attribute set 138. This can be performed, e.g., by the modeling module 294. The SP graph 434 can include nodes representing synthetic entities, and edges between at least some of the nodes. The SP graph 434 can include labels associated with some of edges, referred to as labeled edges herein. All edges can be labeled, or fewer than all. In some examples, the SP graph 434 is or comprises a social-interaction graph. In such a graph, labels can represent, e.g., locations at which the connected entities come into contact or interact, such as home, work, or school.

In some examples, at block 436, server 126 can receive a first forecast 438 of progress of an epidemic in the first synthetic population. As discussed herein with reference to FIG. 4-6, 10, 12-17, or 20, the first forecast 438 can include data points representing, e.g., number of newly-infected entities per week of an epidemic. Additionally or alternatively, the first forecast 438 can include parameters of a disease model describing the progress of the epidemic (e.g., block 468 or parameter(s) 1018). Additionally or alternatively, the first forecast 438 can include a ranking or selection of the relative likelihoods of a plurality of candidate forecasts (e.g., rankings 524, 1014; FIGS. 12-15). The first forecast 438 can include data formatted, e.g., in any of: MIME multipart/mixed; XML; JSON; HTML; spreadsheet formats such as CSV; archive formats such as gzip; or others.

In some examples, at block 450, server 126 can receive second attributes 452 of a second synthetic population. The second attributes 452 can be received, e.g., from a different user than the user from which the first attributes 430 were received, though this is not required. Examples are discussed herein, e.g., with reference to first attributes 430 and block 428.

In some examples, at block 454, server 126 can select a second SP graph 456 from the data library 122 based at least in part on the second attributes 452. Examples are discussed herein, e.g., with reference to block 432.

In some examples, at block 464, server 126 can receive a second forecast 466 of progress of the epidemic in the second synthetic population. Examples are discussed herein, e.g., with reference to block 436. The second forecast 466 can be formatted in any of the ways described above with reference to the first forecast 438.

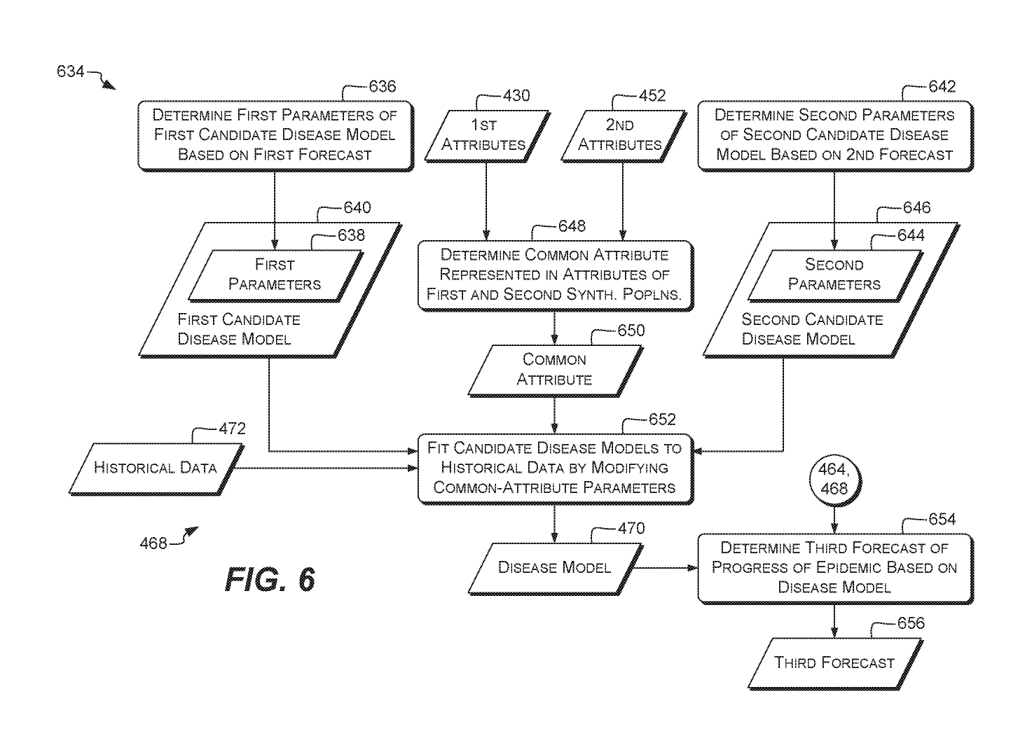

In some examples, at block 468, server 126 can determine a disease model 470 based at least in part on the first forecast 438, the second forecast 466, and historical data 472 of the epidemic. In some examples, the disease model 470, which can represent disease model 144, is associated with the epidemic, at least one of the first attributes 430, and at least one of the second attributes 452. For example, determining the disease model 470 associated with at least one attribute 430 and at least one attribute 452 can reduce the chance of mis-extrapolating forecasts and thereby developing an inaccurate disease model 470. Determining the disease model 470 based on the historical data 472 of the epidemic can permit determining the disease model 470 consistent with observed data, which can reduce the risk chance of inaccuracy due to erroneous forecasts. Examples of determining the disease model are described herein with reference to FIG. 6. In some examples, block 468 can include determining parameters of the disease model 470 based on the forecasts 438 and 466, then fitting the resulting model to the historical data 472. In some examples, block 468 can include discarding, or omitting from computation of the disease model 470, one(s) of the forecasts 438 and 466 that are not consistent with previously-observed data.

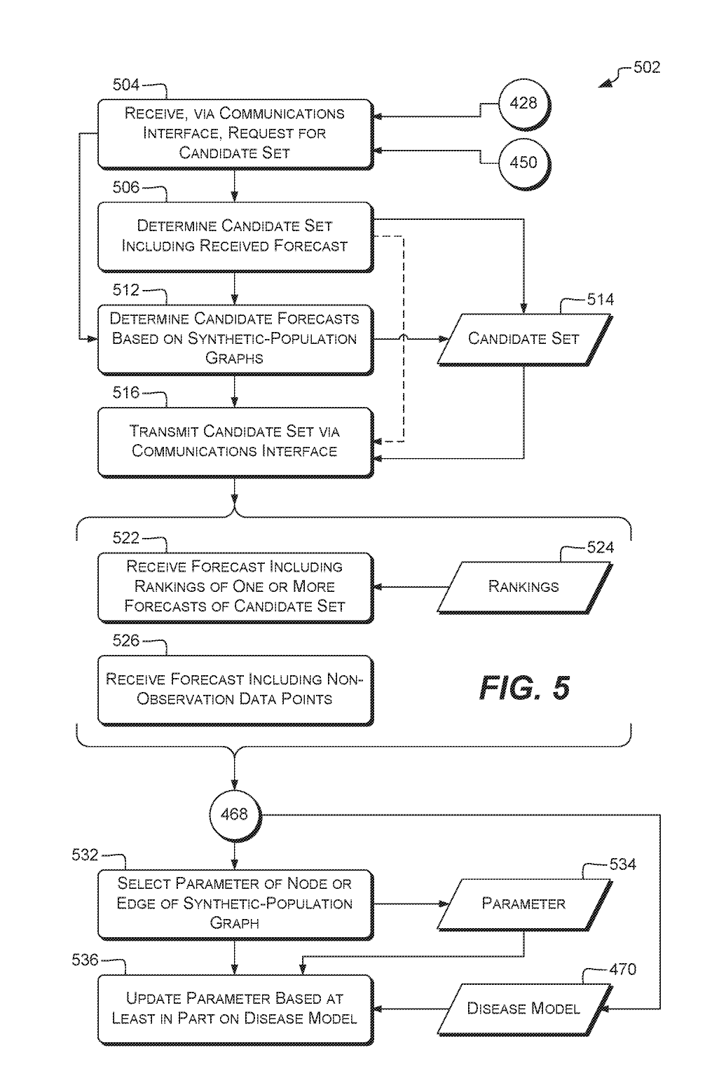

FIG. 5 illustrates an example process 502 for determining a disease model (or other progress model of an event), and associated data items. In some examples, block 504 can be preceded by block 428 or block 450 of receiving attributes. In some examples, blocks 504-516 can precede at least one of blocks 436 or 464. In some examples, any of blocks 504-526 can precede block 468. In some examples, blocks 532 and 536 can follow block 468.

In some examples, at block 504, the server 126 can receive, via a communications interface 298, a request for a candidate set. For example, block 504 can include receiving an HTTP request, e.g., an AJAX GET from the front end 114 or the client 304, indicating that the candidate set is desired. An example URL for such a GET is </api/v1.0/seasons/{id}/system-batch-predictions/latest>, for season {id}. In some examples in which block 504 precedes block 436, the request can be associated with the first forecast 438. In some examples in which block 504 precedes block 464, the request can be associated with the second forecast 466. For example, the request can be for candidate forecasts that will be ranked or edited as discussed herein with reference to FIGS. 10-17, and the forecast received after the request can include the ranked or edited versions of the candidate forecasts. In some examples, block 504 can be followed by block 506 or block 512.

In some examples, block 506 can be used when block 504 follows at least one of block 436 of receiving the first forecast or block 464 of receiving the second forecast. In some examples, at block 506, server 126 can determine the candidate set 514 including a plurality of candidate forecasts, e.g., at least three candidate forecasts of the epidemic. In some examples in which block 504 follows block 436 and precedes block 464, the first forecast 438 can be one of the candidate forecasts. In some examples in which block 504 follows block 464 and precedes block 436, the second forecast 466 can be one of the candidate forecasts. In this way, forecasts provided by one user can be included in the data provided to that user or to another user for evaluation. In some examples, block 506 can be followed by block 512 or (as indicated by the dashed arrow) block 516. In some examples, multiple forecasts provided by one or more users can be included in the candidate set 514.

In some examples, at block 512, the server 126 can determine the candidate set 514 comprising a plurality of candidate forecasts of the epidemic based at least in part on at least one synthetic-population graph, e.g., SP graphs 434 or 456. In some examples, each candidate forecast can include a plurality of observed data points and a separate plurality of candidate data points. The candidate data points can, but are not required to, include any of: disease-model outputs, simulation results, forecasts provided by user(s), regression-based extrapolations, computational-model outputs (e.g., as discussed herein with reference to FIG. 12), or other values.

In some examples, the at least one SP graph used at block 512 can include the at least one of the first synthetic-population graph 434 and the second synthetic-population graph 456 corresponding to the at least one of the first forecast 438 or the second forecast 466 with which the request is associated. For example, if the request is for candidate forecasts to present to the user before receiving the second forecast 466 from the user, the server 126 can determine the candidate set 514 using the second SP graph 466 since that SP graph is pertinent to the region or other attributes 452 pertaining to the request or otherwise of interest. In this way, the candidate forecasts presented to the user can be determined using the corresponding SP graph. This can provide more pertinent candidate forecasts, improving the accuracy of the resulting system.

In some examples, at block 516, server 126 can transmit candidate set 514, e.g., the plurality of candidate forecasts, via the communications interface 298. For example, individual candidate forecasts can be transmitted as any of: images of graphs; numerical data of graphs; model parameters to be plotted or otherwise presented by the front end 114; or statistics or key values pertaining to the candidate (e.g., time of peak and height of peak on an epicurve). The candidate set 514 can be transmitted in various forms, e.g., any of: MIME multipart/mixed; XML; JSON; spreadsheet formats such as CSV; image formats such as PNG; HTML; JAVASCRIPT; archive formats such as gzip; or others. In some examples, block 516 can be followed by at least one of, or any combination of, blocks 522 or 526. Processing at blocks 504-516 can permit, e.g., transmitting candidate forecasts to front end 114 so that a user can rank or adjust them. Examples of ranking and adjusting are described herein with reference to blocks 522 and 526, and FIGS. 10-17.

In some examples, at block 522, server 126 can receive at least one of the first forecast 438 or the second forecast 466 including a set of rankings 524. The set of rankings 524 can include respective rankings of one or more of the plurality of candidate forecasts. For example, the set of rankings 524 can include respective rankings of some of, or each of, the plurality of candidate forecasts in the candidate set 514. Examples of rankings are described herein with reference to FIGS. 10-15.

In some examples, at block 526, server 126 can receive at least one of the first forecast 438 or the second forecast 466 comprising a plurality of non-observation data points. This is an example of techniques referred to herein as “individualized forecasting,” e.g., described herein with reference to FIG. 10-12, 16, or 17. For example, the non-observation data points can represent any data not determined by observation, e.g., surveillance as described herein (including such techniques as receiving reports of influenza counts from doctors or other public health officials). In some examples, the non-observation points can be received from a user, e.g., as discussed herein with reference to FIGS. 12 and 17.

In some examples, at least one of blocks 522 or 526 can be followed by blocks including (and depicted for brevity as) block 468 of determining disease model 470. In some examples, block 468 can be followed by blocks 532 and 536.

In some examples, at block 532, server 126 can select at least one parameter 534 of at least one node or edge of at least one of the first SP graph 434 or the second SP graph 456. For example, the parameter can represent a social interaction of an entity; a location at which the entity interacts with other entities (e.g., work or school); a prophylactic or intervention intended to counter the effect of an epidemic or other event with respect to an entity; or other parameters governing the simulated behavior of the entity during the simulated event. Server 126 can select the parameter 534, e.g., based at least in part on the first forecast 438 or the second forecast 466. For example, the parameter 534 can be a parameter that, when adjusted, causes the progress of the event with respect to the entity or entities being simulated to more closely match the received forecast(s).

In some examples, at block 536, server 126 can update the at least one parameter 534 based at least in part on the disease model 470. For example, the disease model 470 can indicate that the progress of the epidemic will more closely match the forecasts if the parameter is increased rather than decreased, or vice versa. The parameter can be adjusted in accordance with the disease model 470 to provide increased accuracy of forecasts based on SP graphs.

FIG. 6 illustrates an example process 634 for determining a disease model (or other progress model of an event), and associated data items. In some examples, block 464 or block 468 can precede block 654. In some examples, block 468 can include any or all of blocks 636-652. In some examples, process 634 can include using information from multiple forecasts to provide a combined forecast that can have improved accuracy compared to forecasts in some prior schemes.

In some examples, at block 636, server 126 can determine first parameters 638 of a first candidate disease model 640 based at least in part on the first forecast 438. For example, candidate disease model 640 can represent a curve, e.g., an epicurve, controlled by the first parameters 638, e.g., number of peak(s), time of peak(s), or height of peak(s). Server 126 can use regression or other fitting techniques to determine the first parameters 638 so that the resulting first candidate disease model 640 fits the first forecast 438 within a predetermined level of mathematical accuracy. In examples using non-observation data points (e.g., block 526), the curve can be fit directly to the non-observation data points. In examples using rankings 524 (e.g., block 522), the curve can be fit to the highest-ranked candidate forecast in the candidate set 514. Additionally or alternatively, the curve fitting can include a term penalizing similarity between the candidate disease model 640 and the lowest-ranked candidate forecast in the candidate set 514.

In some examples, at block 642, server 126 can determine second parameters 644 of a second candidate disease model 646 based at least in part on the second forecast 466. This can be done as discussed herein with reference to block 636.

In some examples, at block 648, server 126 can determine at least one common attribute 650 that is represented in both the first attributes 430 of the first synthetic population and the second attributes 452 of the second synthetic population. For example, the attributes 430, 452 may indicate different regions, but within the same country. In that example, the common attribute 650 may be the country. In another example, the attributes 430, 452 may indicate the same geographic region, but different sub-populations (e.g., adults vs. children). In that example, the common attribute 650 may be connection with a particular place, e.g., a particular school. Server 126 can determine the common attribute 650, e.g., using set-covering algorithms or set- or graph-intersection algorithms, e.g., associative array tests for membership of particular nodes in particular subgraphs defined by respective, different attributes that are candidates for selection as the common attribute 650.

In some examples, at block 652, server 126 can determine the disease model 470 by fitting the first candidate disease model 640 and the second candidate disease model 646 to the historical data 472 of the epidemic, e.g., using regression techniques described herein. The fitting at block 652 can include modifying parameters of the disease model 470 associated with the at least one common attribute 650. In some examples, accordingly, the fitting at block 652 can modify parameters of the disease model 470 for which both the first forecast 438 and the second forecast 466 provide information. This can improve the accuracy of the disease model 470 with reduced risk of overtraining or otherwise skewing the disease model 470 for sub-populations not represented in either forecast 438, 466, or represented in only one of the forecasts 438, 466.

In some examples, at block 654, server 126 can determine a third forecast 656 of progress of the epidemic based at least in part on the disease model 470. For example, serve 126 can simulate the progress of the epidemic in at least one of the first SP graph 434 or the second SP graph 456 based at least in part on the updated disease model 470. Additionally or alternatively, server 126 can compute a curve function described in the updated disease model 470 for future times to provide the third forecast 656. As shown, block 654 can follow block 468 or block 652. Block 654 can be used in conjunction with other blocks shown in FIG. 6, or separately therefrom.

Additionally or alternatively, server 126 can determine third forecast 656 based at least in part on at least one of the first forecast 438, the second forecast 466, the historical data 472, or any combination of any of those. This can be done, e.g., using simulation as described in the preceding paragraph. In some examples using block 654, block 468 is not used, and block 654 follows block 464. Examples are discussed herein, e.g., with reference to FIG. 20 and the ensemble simple average yₒ discussed with reference thereto.

In some examples, when determining third forecast 656, forecasts such as the first forecast 438 or the second forecast 466 can be weighted based on the rankings 524. For example, each forecast 438, 466 can be given a score based on the rankings 524, e.g., three points for each first-place ranking, two points for each second-place ranking, and one point for each third-place ranking. The forecasts can then be combined, e.g., in a weighted average, with the weights being the respective scores.

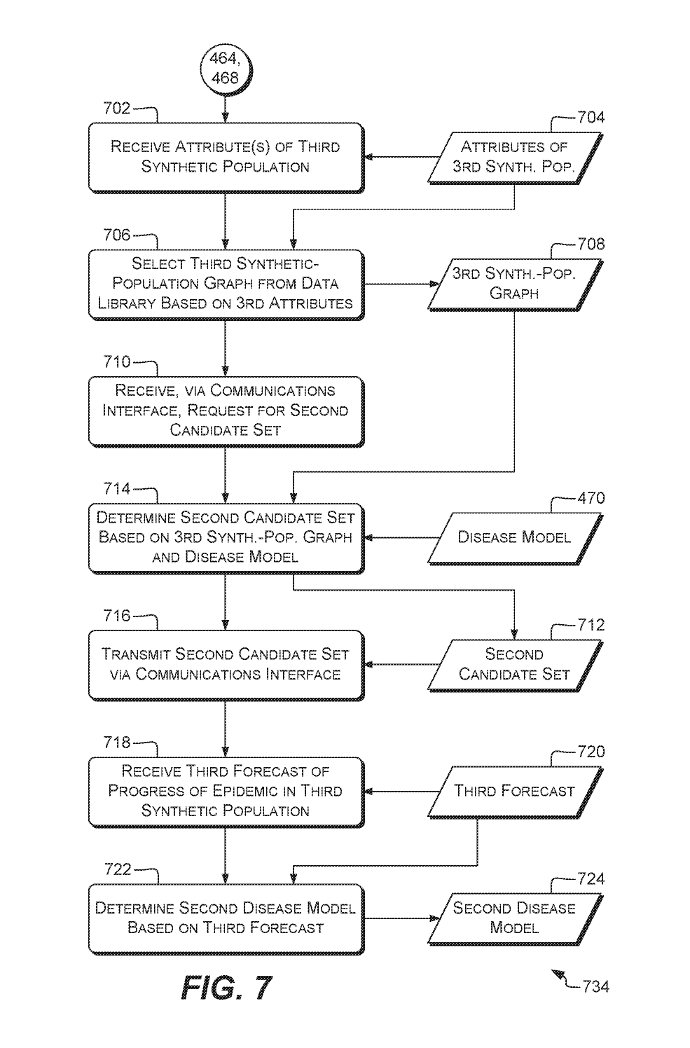

FIG. 7 illustrates an example process 700 for determining a disease model (or other progress model of an event), and associated data items. In some examples, block 464 or block 468 can be followed by block 702. Various examples permit iteratively adjusting forecasts or disease models to improve their accuracy.

In some examples, at block 702, server 126 can receive third attributes 704 of a third synthetic population. Examples are discussed herein, e.g., with reference to blocks 428 or 450. The third synthetic population can correspond with at least one of the first or the second synthetic populations, or can be different from both of those.

In some examples, at block 706, server 126 can select a third synthetic-population graph 708 from data library 122 based at least in part on the third attributes 704. Examples are discussed herein, e.g., with reference to blocks 432 or 454.

In some examples, at block 710, server 126 can receive a request for a second candidate set 712. Examples are discussed herein, e.g., with reference to block 504. For example, the third attributes 704 and the request can correspond to a different user session than the request described herein with reference to block 504.

In some examples, at block 714, server 126 can determine the second candidate set 712 comprising a plurality of candidate forecasts of the epidemic. Examples are discussed herein, e.g., with reference to blocks 506 or 512. At least one of the plurality of candidate forecasts can be based at least in part on the third synthetic-population graph 708 and on the disease model 470. In this way, the previously-determined disease model 470 can be used as input in an iterative process for determining more accurate disease models.

In some examples, at block 716, server 126 can transmit the candidate set 712 via the communications interface 298. Examples are discussed herein, e.g., with reference to block 516.

In some examples, at block 718, server 126 can receive a third forecast 720 of progress of an epidemic in the third synthetic population. Block 718 can be performed subsequent to the transmitting at block 716. The third forecast 720 can be associated with the second candidate set 712. Examples are discussed herein, e.g., with reference to blocks 436, 464, 522, or 526.

In some examples, at block 722, server 126 can determine a second disease model 724 based at least in part on the third forecast 720. The second disease model 724 can be associated with the epidemic and at least one of the third attributes 704. In some examples, block 722 can include determining the second disease model 724 additionally or alternatively based at least in part on the historical data 472, or other historical data of the epidemic. For example, the other historical data can include historical data specific to a region or other attribute of the third synthetic population not shared by the first and second synthetic populations. Examples are discussed herein, e.g., with reference to blocks 468 or 652. In some examples, server 126 can determine a forecast based on the second disease model 724, e.g., as discussed herein with reference to block 654.

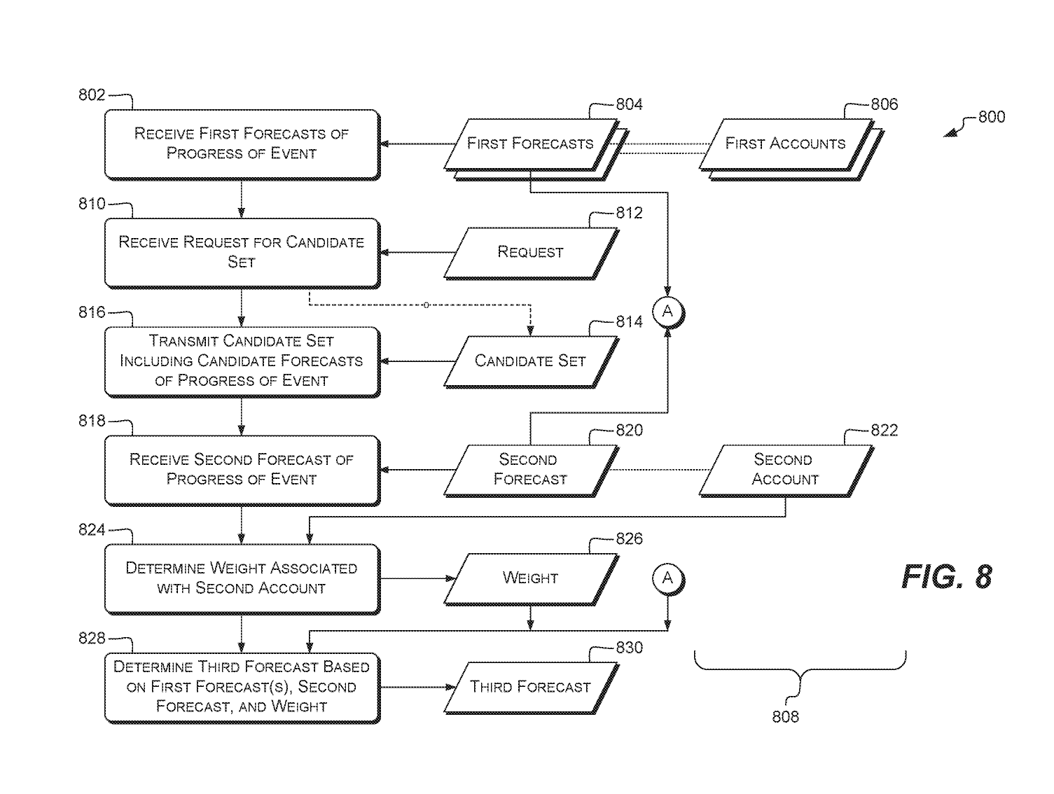

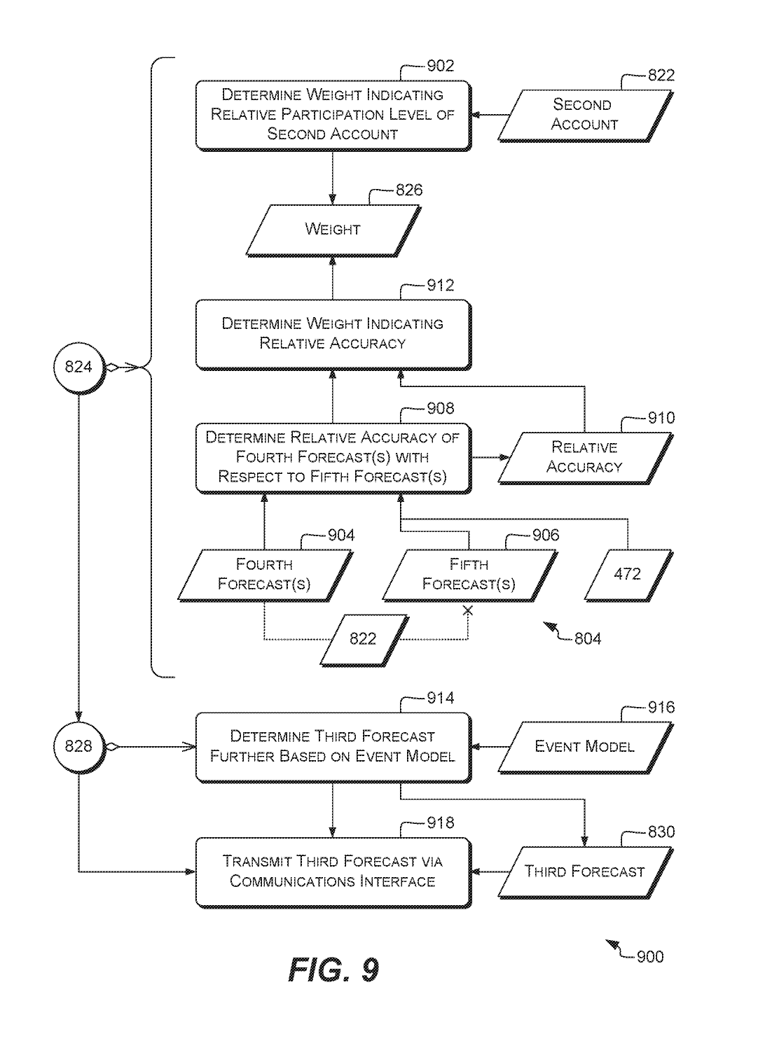

FIG. 8 illustrates an example process 800 for determining forecasts of progress of an event (e.g., an epidemic), and associated data items. In some examples, operations described below with reference to FIGS. 8 and 9 can be performed by a server 126 including one or more computing devices or processors, e.g., in response to computer program instructions of modules on computer-readable media 280.

In some examples, at block 802, server 126 can receive first forecasts 804 of progress of an event. For example, the first forecasts 804 can include prior forecasts for a current time period or prior time periods. Each first forecast of the first forecasts 804 can be associated with a corresponding first account 806 of a plurality of accounts 808, as indicated by the stippled lines. The first forecasts 804 may be associated with one or more first accounts 806. Examples are discussed herein, e.g., with reference to blocks 436 or 464.

In some examples, at block 810, server 126 can receive, via communications interface 298, a request 812 for a candidate set 814. Examples are discussed herein, e.g., with reference to block 504. In some examples, as indicated by the dashed line, server 126 can determine the candidate set 814 in response to the request 812, e.g., as discussed herein at least with reference to blocks 506, 512, or 714.

In some examples, at block 816, server 126 can transmit, via the communications interface 298, the candidate set 814 comprising a plurality of candidate forecasts of progress of the event. Examples are discussed herein, e.g., with reference to block 516. Candidate set 514 can be determined, e.g., as discussed herein with reference to blocks 506 or 512.

In some examples, at block 818, server 126 can receive, via the communications interface 298, a second forecast 820 of progress of the event. Examples are discussed herein, e.g., with reference to blocks 436, 464, 522, or 526. The second forecast 820 can be associated with a second account 822 of the plurality of accounts 808. For example, the second forecast 820 can be a ranking or individualized prediction provided by a user 242 associated with the second account 822.

In some examples, at block 824, server 126 can determine a weight 826 associated with the second account 822. Various examples of determining the weight 826 are described herein with reference to FIG. 9. In some examples, server 126 can determine the weight 826 based on, e.g., accuracy, timeliness, or participation data associated with the second account 822. In some examples, server 126 can determine the weight 826 based on how often other accounts 806 register votes in favor of (e.g., rank highly) forecasts provided by the second account 822.

In some examples, at block 828, server 126 can determine a third forecast 830 of progress of the event based at least in part on the second forecast 820, the weight 826, and at least one of the first forecasts 804. For example, server 126 can compute a weighted ensemble average (e.g., FIG. 20) in which the second forecast 820 is weighted by the weight 826. The at least one of the first forecasts 804 can be weighted by the quantity unity minus weight 826. Additionally or alternatively, the at least one of the first forecasts 804 can be weighted as described herein with reference to block 824, with respect to the corresponding at least one first account 806.

FIG. 9 illustrates an example process 900 for determining forecasts of progress of an event (e.g., an epidemic), and associated data items. In some examples, block 824 of determining the weight 826 can include at least one of blocks 902-912. In some examples, block 828 can include block 914. In some examples, block 828 can be followed by block 918. Block 918 can be used together with any of blocks 902-914, or separately therefrom. In some examples, blocks 902 and 912 can be used together. For example, the weight 826 can be determined as an average, weighted by predetermined weights, of a candidate weight determined at block 902 and a candidate weight provided at block 912.

In some examples, at block 902, server 126 can determine the weight 826 indicating a participation level of the second account 822 with respect to respective participation levels of other accounts of the plurality of accounts 808. For example, forecasts provided by relatively more active accounts 808 can be weighted relatively more highly (heavily). This can improve accuracy by placing more value in estimates provided by users who have experience with the system.

In some examples, heavier weight can be placed on forecasts provided by accounts 808 with a history of providing more accurate predictions. This can improve accuracy in forecasting events for which past accuracy correlates with future accuracy. In some examples, the first forecasts 804 include at least one fourth forecast 904 associated with the second account 822, e.g., prior forecast(s) provided by the user with respect to whom (or which) the weight 826 is being determined. The first forecasts 804 can also include and at least one fifth forecast 906 not associated with the second account 822 (“X”), e.g., provided by a different user.

In some examples, at block 908, server 126 can determine a relative accuracy 910 of the at least one fourth forecast 904 with respect to the at least one fifth forecast 906 based at least in part on historical data 472 of the event. For example, server 126 can determine fitting coefficients (e.g., R²) or root-mean-square (or other) differences between the fourth forecast 904 and the historical data 472, and between the fifth forecast 906 and the historical data 472. The server 126 can determine the relative accuracy 910 indicating, e.g., an additive or multiplicative difference between the accuracies of the forecasts 904, 906.

In some examples, at block 912, server 126 can determine the weight 826 indicating the relative accuracy 910. For example, server 126 can determine a relatively larger weight 826 if the relative accuracy indicates the fourth forecast 904 is relatively more accurate compared to the fifth forecast 906. Blocks 908 and 912 can be performed with respect to any number of fourth forecasts 904 or fifth forecasts 906, and server 126 can determine the resulting weight 826 as an average or weighted average of the results.

In some examples, the system can determine virtual points to be awarded to users based on the quantity or quality of their forecasts, e.g., based on the determined relative accuracy 910 or other activity associated with the accounts 808 (e.g., as discussed herein with reference to block 902). In some examples, the system can display a dashboard via UI 240. The UI 240 can present the cumulative points for various users, or users' rankings based on those points.

In some examples, at block 914, server 126 can determine the third forecast 830 further based at least in part on an event model 916 associated with the event. The event model 916 can represent the disease model 470, in some examples. For example, the server 126 can determine a reference curve as a weighted average of the first forecasts 804 and the second forecast 820 based on the weight 826. The server 126 can then determine the third forecast 830 by fitting a curve specified in the event model 916 to the reference curve. Examples are discussed herein, e.g., with reference to block 654.

In some examples, at block 918, server 126 can transmit, via the communications interface 298, the third forecast 830. For example, server 126 can format data of the third forecast 830 according to any of the example formats described herein with reference to block 436. Server 126 can then transmit the formatted data, e.g., in response to an HTTP request, in a push manner (e.g., Comet or reverse AJAX), via Websockets, or via another transport supported by communications interface 298.

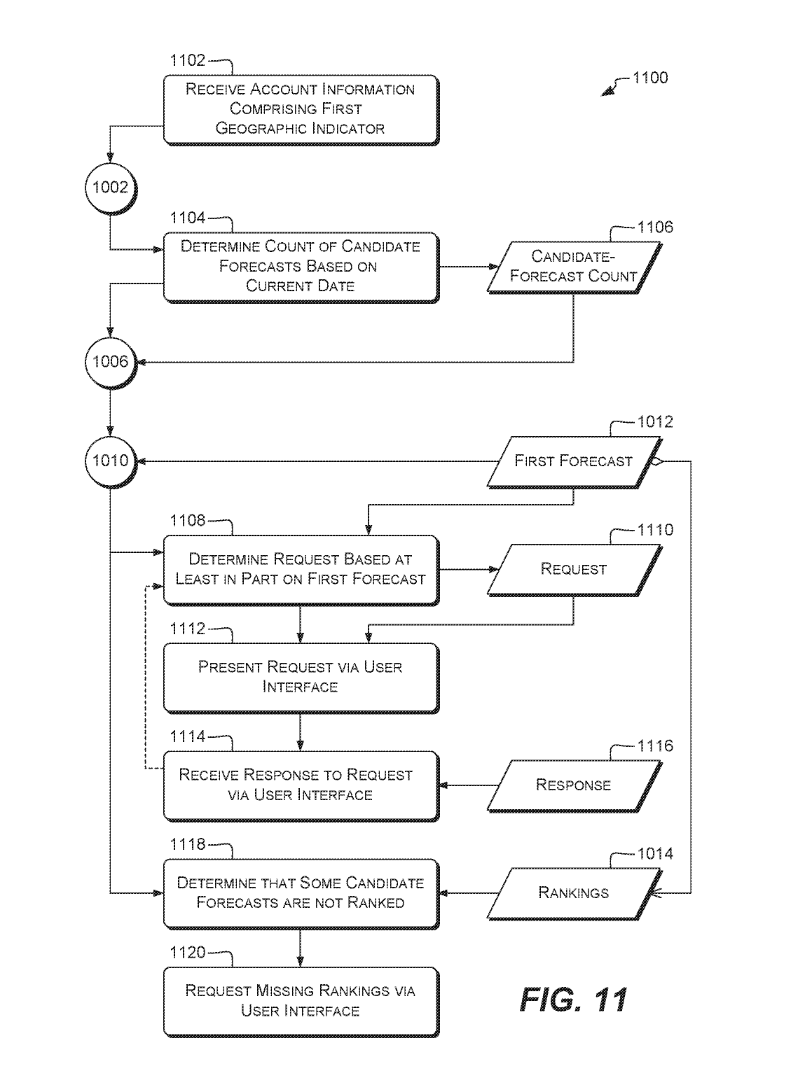

FIG. 10 illustrates an example process 1000 for collecting forecasts of an epidemic, and associated data items. Throughout the discussion of FIGS. 10-11, techniques for collecting forecasts of an epidemic can additionally or alternatively be used for collecting progress forecasts of other types of events. In some examples, operations described below with reference to FIGS. 10 and 11 can be performed by a front end 114 or tool 128 including one or more computing devices or processors, e.g., in response to computer program instructions of interaction module 246.

In some examples, at block 1002, the front end 114 can receive, via a user interface (UI) 240, attributes 1004 of a synthetic population. Examples of attributes are discussed herein, e.g., with reference to blocks 428 and 450. Example types of attributes that can be received are illustrated in FIGS. 18 and 19. For example, the UI 240 can present a textual choice field (e.g., a drop-down list, listbox, combobox, set of radio buttons or checkboxes, text-entry field, or any of those combined with a search field) or a clickable map (e.g., an imagemap) for selecting a geographical region; a textual choice field for selecting a type of event (e.g., a type of disease); or at least one textual choice field for defining a subpopulation (e.g., including fields for at least one of age, occupation, work status, school status, or socioeconomic level).

In some examples, at block 1006, the front end 114 can present, via the UI 240, a plurality of candidate forecasts 1008 of an epidemic, each candidate forecast 1008 associated with the attributes and comprising respective forecast data of progress of the epidemic over time. Examples of candidate forecasts 1008 are described herein with reference to blocks 504-516, 710-716, or 810-816. Examples of UIs 240 presenting candidate forecasts 1008 are described herein with reference to FIG. 12-14 or 16. For example, the front end 114 can receive the candidate forecasts 1008 from the server 126, which can transmit them as described herein, e.g., with reference to block 516.

In some examples, at block 1010, the front end 114 can receive, via the UI 240, a first forecast 1012 of the epidemic. The first forecast 1012 can include at least one of the following: rankings 1014 of ones of the plurality of candidate forecasts; first data 1016 of progress of the epidemic over time (e.g., individualized forecasts); or at least one parameter 1018 of a model of the epidemic (e.g., individualized forecasting by parameter adjustment), the model providing estimated progress of the epidemic as a function of time. The model can represent disease model 470 or event model 916. The rankings 1014 can represent rankings 524, e.g., as discussed herein with reference to FIGS. 12-15. The first data 1016 can include non-observation data, e.g., as discussed herein with reference to block 526 or FIG. 12,16, or 17.

FIG. 11 illustrates an example process 1100 for collecting forecasts of an epidemic, and associated data items. In some examples, block 1102 can precede block 1002. In some examples, block 1002 can be followed by block 1104. In some examples, block 1010 can be followed by block 1108 or block 1118.

In some examples, at block 1102, the front end 114 can receive, via the UI 240, account information comprising a first geographic indicator, e.g., a location of the user or a CDC flu region in which the user is located. Block 1102 can be followed by block 1002.

In some examples using block 1102, at block 1002, the front end 114 can receive the attributes 1004 comprising a second geographic indicator associated with the first geographic indicator. For example, the attributes 1004 can indicate that the user wishes to provide forecasts within the user's local area. Additionally or alternatively, the attributes 1004 can indicate that the user wishes to provide forecasts of areas other than the user's local area. In some examples, block 824 can include determining a higher weight 826 for users forecasting within their own areas than for users forecasting outside their own areas, or vice versa.

In some examples, at block 1104, the front end 114 can determine a count 1106 of candidate forecasts of the plurality of candidate forecasts based at least in part on a current date. The count can indicate how many candidate forecasts will be presented at block 1006, which can follow block 1104. Block 1104 can additionally or alternatively be performed by the server 126. For example, as the event (e.g., flu season) progresses, the count 1106 can be increased, to provide users with more options as more historical data 472 are available, or decreased, to reduce user workload towards the end of a long flu season or other long-duration event.

In some examples, at block 1108, the front end 114 can determine, based at least in part on the first forecast 1012, a request 1110. For example, the request 1110 can be a request intended to solicit input from a user 242. The front end 114 can retrieve the request from data library 122 or another database, in some examples.

In some examples, at block 1112, the front end 114 can present, via the UI 240, the request. For example, the front end 114 can present the request in a pop-up, text field, sidebar, or other UI control.

In some examples, at block 1114, the front end 114 can receive, via the UI 240, a response 1116 to the request 1110. For example, the UI 240 can receive the request via a textual choice control or other input control that can be processed by the front end 114 or the server 126. As shown by the dashed arrow, block 1114 can be followed by block 1108 to solicit additional information. In some examples, the front end 114 can implement branching survey logic to collect data in addition to that collected via ranking or individualized forecasting. Examples of such data include confidence data such as described herein with reference to FIG. 13 (“How do you feel about your ranking”).

In some examples, at block 1118, the front end 114 can determine that some of the candidate forecasts 1008 were not ranked. This can be done by determining that the rankings 1014 comprise rankings for fewer than all of the plurality of candidate forecasts 1008.

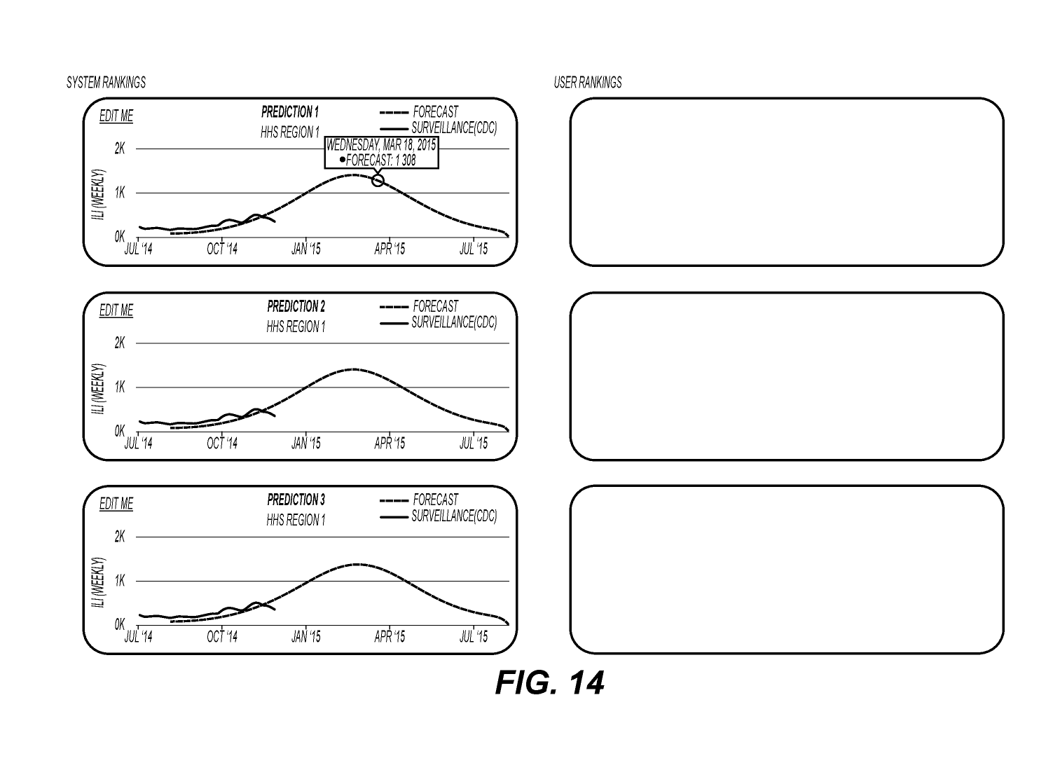

In some examples, at block 1120, the front end 114 can request, via the UI 240, second rankings for ones of the plurality of candidate forecasts not included in the rankings. For example, the front end 114 can provide rich modeless visual feedback, e.g., a highlight around any remaining empty boxes on the right side of FIG. 14. Additionally or alternatively, the front end 114 can provide a pop-up or other prompt requesting the user to rank all of the candidates. Additionally or alternatively, the front end 114 can disallow progressing beyond the ranking interface (e.g., FIG. 13 or 14) until all candidates have been ranked, e.g., by presenting a “continue” button in a disabled state (visual but not actuatable) at block 1120).

In some examples, blocks 1118 and 1120 can provide forced-choice ranking, in which data from a user 242 are only used in determining models or forecasts once that user 242 has ranked all the candidates. Forced-choice ranking can improve accuracy of forecasts when two candidates are very similar, for example.

FIG. 12 illustrates an example process 1200 for collecting and processing event forecasts, and for determining models or forecasts of the progress of events. FIG. 12 also illustrates related data items and components. Circled numbers in FIG. 12, e.g., “\textcircled{1},” are referred to in the following discussion as “stages.” In the following sections, although these stages are described in the context of forecasting models generated for a particular disease, geographical region, and season, the pipeline can be used for any other combination of epidemic parameters or other events since the system is built to support a variety of geographical regions, diseases, etc.

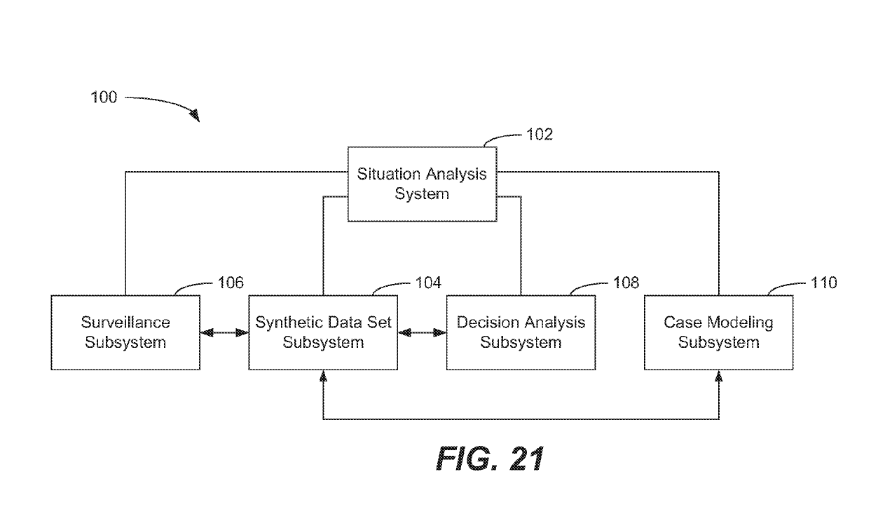

Throughout the discussion of FIGS. 12-26, some actions are described as being taken “by the user” for brevity. These refer to the systems 112 or 208, or components of either of those, taking action in response to activation of a user-interface control, e.g., by a user. For example, language such as “the user starts an experiment” denotes that the system receives a command to start an experiment, e.g., via user interface 240, and does so. That command may come from a user 242 via front end 114. Additionally or alternatively, that command may come from an outside system, e.g., a computational agent, a broker (e.g., as discussed herein with reference to FIGS. 21-26), or another automated system.

In Stage 1, a set of forecasting model outputs, e.g., system-generated forecasts, is determined or received using the data ingestion component 318. Any type of forecasting model may be utilized to generate the system-generated forecasts. In some embodiments, the forecasting models may generate a prediction in a particular format or set of formats. For example, in some epidemic forecasting embodiments, the forecasting models may generate output data used to predict an epidemic curve, or epicurve, representing progression of an epidemic over time. In some embodiments, the data ingestion component 318 may integrate output data from a large number of different forecasting models, one or more of which may have uncertainty bounds. In some embodiments, scripts may be used to translate/transform the different output formats of the forecasting models into common format or set of formats used by the system. The system may also allow users to manually add data into the system, such as through a portion of the front end 114 client 124 user interface 240.

In some examples, in the first stage, a set of forecasting model outputs is received by the system using the data ingestion component 318. The process of generating different forecasting models is external to the system, and it is assumed that these models are likely generated using, e.g., compartmental, agent-driven, statistical, or data-driven methods. The only constraint for these forecasting models is that they should predict the epicurve. The system is flexible enough to handle large numbers of forecasting models and each model, if applicable, can also have uncertainty bounds. The models could be injected by a requester/web administrator using scripts which have the necessary logic to do the translation and transformation into the system data format. However, in the absence of any such scripts for the new forecasting models, the user could use the web interface to manually add the data into the system.

In Stage 2, the forecasting model outputs are stored in a database, e.g., data library 122. The forecasting model outputs may be stored in a relational-database format or other format permitting flexible queries to be performed. In some examples, in the second stage, the model outputs are stored in a relational format in a permanent database. This format allows performing flexible queries in an efficient manner. Example queries may include, in some examples, “Find the mean and standard deviation of all forecasting models for a particular geographic region and disease,” “Find the distribution of a peak date predicted by different forecasting models,” or “Find all the user forecasting models that are different from the system-generated predictions given a certain measure of dissimilarity.”

In Stage 3, the user 242 selects one or more attributes through the front end 114, e.g., via user interface 240 or client 304. The attributes can be examples of attributes 430, 452, 704, or 1004 of synthetic populations. The system can use the attributes to determine the type of output data to be used in generating forecasting outputs to be presented to the user. In some implementations, the user 242 selects a disease and a geographic region, and the selection triggers the front end 114 to communicate with the back end 116 (or MBE 132, and likewise throughout the discussion of process 1200) to retrieve forecasting or other data outputs based on the disease and geographic region selections (or other attributes). In some implementations, the front end may also retrieve previous responses corresponding to the attributes from the back end 116. Such responses can include, e.g., previous responses by other users 242. Examples are discussed herein, e.g., with reference to block 506 or FIG. 7.

In some examples, in the third stage, the user selects a “disease” and “geographical region” (or other attributes 430) after logging into the client 304. This action from the user triggers the front end to communicate with the back end to retrieve the forecasting and surveillance data outputs, and previous responses corresponding to the user's selection, by using RESTful APIs provided by the back end.

In Stage 4, the forecasting data retrieved from the back end 116 (e.g., at Stage 1) is provided to the user 242 via a user interface 240. The UI 240 can also prompt the user to complete one or more tasks with respect to the data. Examples are discussed herein, e.g., with reference to blocks 504-516. In some examples, if the user has already provided a previous response (e.g., in a previous session), an indication of the response may be provided within the front end interface.

For example, the user may be invited to rank multiple different forecasting data options according to preference/perceived likelihood of occurrence. The UI 240 can receive from the user 242 the rankings 524 or 1014, shown as model ranks 1202.

The user may additionally or alternatively be invited to modify a portion of one or more of the forecasts and/or provide individualized data through the UI 240. The data received from the user 242 via the UI 240 can thus include forecast, e.g., forecasts 438, 466, 720, or 1012, in some examples. Such modified portions, individualized data, or forecasts can include non-observation data points (block 526), first data 1016, or parameters 1018, in various examples. All the types of received data discussed in this paragraph are shown as user models 1204.

The received data may be used to generate a third forecast 656, as discussed below, e.g., third forecast 830. The received data from the user 242 is then stored in the back end database, e.g., data library 122. In some examples, user models 1204 do not include rankings such as those included in model ranks 1202.

In some examples, in the fourth stage, the forecasting data pulled from the back end is used to determine ranking and individualized forecasting tasks for users. If the user has already provided his response to the task, the front end visualization widgets are designed to reflect this state. This allows the user to evaluate his earlier response and provide a new response in the case of new evidence. The collected data are then stored in the back end database for later data transfer into the analytical engine.

In Stage 5, received data from multiple users (e.g., all users), such as model ranks 1202 from multiple users or user models 1204 from one or more users, are provided to the analytics component 322. The analytics component 322 can use these data to generate a third forecast 656, e.g., third forecast 830, in a “fusion” process. In some examples, the user-provided data is combined (“fused”) with the system-generated predictions generated by the forecasting models (Stage 1) to produce the third forecast 656. For example, multiple predictions can be combined via an ensemble average to produce the third forecast 656.

The user-provided data may be combined with the system-generated predictions using machine learning and data analytics methods, e.g., supervised or unsupervised learning methods. For example, a computational model can be trained, or operated on, the user-provided data. Example types of computational models that can be used to analyze or process the user-provided data can include, but are not limited to, at least one of the following: multilayer perceptrons (MLPs), neural networks (NNs), gradient-boosted NNs, deep neural networks (DNNs), recurrent neural networks (RNNs) such as long short-term memory (LSTM) networks or Gated Recurrent Unit (GRU) networks, decision trees such as Classification and Regression Trees (CART), boosted trees or tree ensembles such as those used by the “xgboost” library, decision forests, autoencoders (e.g., denoising autoencoders such as stacked denoi sing autoencoders), Bayesian networks, support vector machines (SVMs), or hidden Markov models (HMMs). Such computational models can additionally or alternatively include regression models, e.g., that perform linear or nonlinear regression using mean squared deviation (MSD) or median absolute deviation (MAD) to determine fitting error during the regression; linear least squares or ordinary least squares (OLS); fitting using generalized linear models (GLM); hierarchical regression; Bayesian regression; or nonparametric regression. Computational models can include parameters governing or affecting the output of the model for a particular input. Parameters can include, but are not limited to, e.g., per-neuron, per-input weight or bias values, activation-function selections, neuron weights, edge weights, tree-node weights, or other data values. The system can determine computational models, e.g., by determining values of parameters in the computational models. For example, neural-network or perceptron computational models can be determined using an iterative update rule such as gradient descent (e.g., stochastic gradient descent or AdaGrad) with backpropagation.

In some implementations, the user-provided data may be weighted based on individual users or groups of users, or characteristics thereof, or accounts associated therewith, or characteristics thereof. For example, if input from a particular user has been more accurate than average (e.g., if the user has predicted an actual future occurrence more closely, or predicted the future occurrence with a tolerance more frequently, than an average across multiple users), the input from that user may be weighted to have a greater impact on the final forecast. Similarly, if a user has been less accurate than average, the input from that user may be weighted to deemphasize the input. Examples are discussed herein, e.g., with reference to blocks 908 and 912. While some examples focus on weighting individual users, the same manner of weighting could be applied to groups of users, such as users associated with a particular organization, users from a particular geographic region, or groups of users organized in other manners or according to other characteristics. In some examples, accounts can be associated with users or groups, and weighting can be determined based on the account data. In other examples, forecasts from more-active users can be weighted more heavily than forecasts from less-active users. Examples are discussed herein, e.g., with reference to block 902.

In some implementations, multiple system-generated forecasts may be averaged to generate the final forecast, and the average may be weighted according to the user feedback. For example, a user- or system-generated forecast selected more often by the user base as likely to be accurate can have a greater impact on the final forecast than one selected by the user base less frequently. Examples are discussed herein, e.g., with reference to block 654.

In some examples, in the fifth stage, collected data from multiple (e.g., all) users, e.g., outputs of the ranking and individualized forecasting tasks, are fused with system-generated predictions (the models provided as inputs to the system in stage 1) using machine learning and data analytical methods to produce a final forecast. For these fusion algorithms, the analytical engine can take the user's previous performance into consideration. Various examples provide a modular architecture and platform with which various fusion algorithms can be used. In some examples, the analytics component 322 depicted by dotted lines can be changed without changing other components of the system.

In some examples, analytics component 322 can perform an ensemble average for a set of predictions. These predictions could be system generated predictions or the ones selected by the user. An example ensemble average is described herein with reference to FIG. 20.

In Stage 6, the third forecast 656 generated by the analytics component 322 is stored in the back end database, e.g., data library 122. In some examples, timestamp information can be stored in association with the third forecast 656.

In Stage 7, the resulting output is displayed to the user via the front end 114 client 304 user interface 240. The resulting output can include the third forecast 656 or the disease model 470, or graphical representations of either of those.

FIG. 13 shows an example user interface including a ranking widget (“Arrange them here”) permitting users to rank system predictions. The illustrated ranking widget supports ranking up to three predictions at a time.

As shown, the widget also shows “reference” data, e.g., from previous years or previous similar events. In an example of flu epidemics, reference data is displayed to the user for past four flu seasons. Based on this data user can predict what flu trend to expect in the ongoing season. In the illustrated example, the graphs are plotted for infection count vs dates. These graphs can be viewed in a zoomed view by hovering on it.

The “feedback” portion of the widget permits a user to provide data of confidence levels of a ranking.

FIG. 14 shows an example user interface including a different ranking widget. The user can provide model ranks 1202 by dragging predictions from the “system rankings” to the “user rankings” area. FIG. 14 shows the prediction curves as seen by the user before ranking. System Rankings on the left panel shows the forecasts generated by the system for the user to rank. The user can complete the task by dragging the forecast curves from the system ranking panel on the left to the user ranking panel on the right.

FIG. 14 shows an ordered list of predictions, e.g., system-generated predictions for the ranking task, and Pi represents individual forecasts.

In some examples, before presenting the UI of FIG. 14, the system can present a map permitting the user to click on a region of interest, search for a region of interest by name, or otherwise select a region of interest. The region of interest is an example of an attribute.

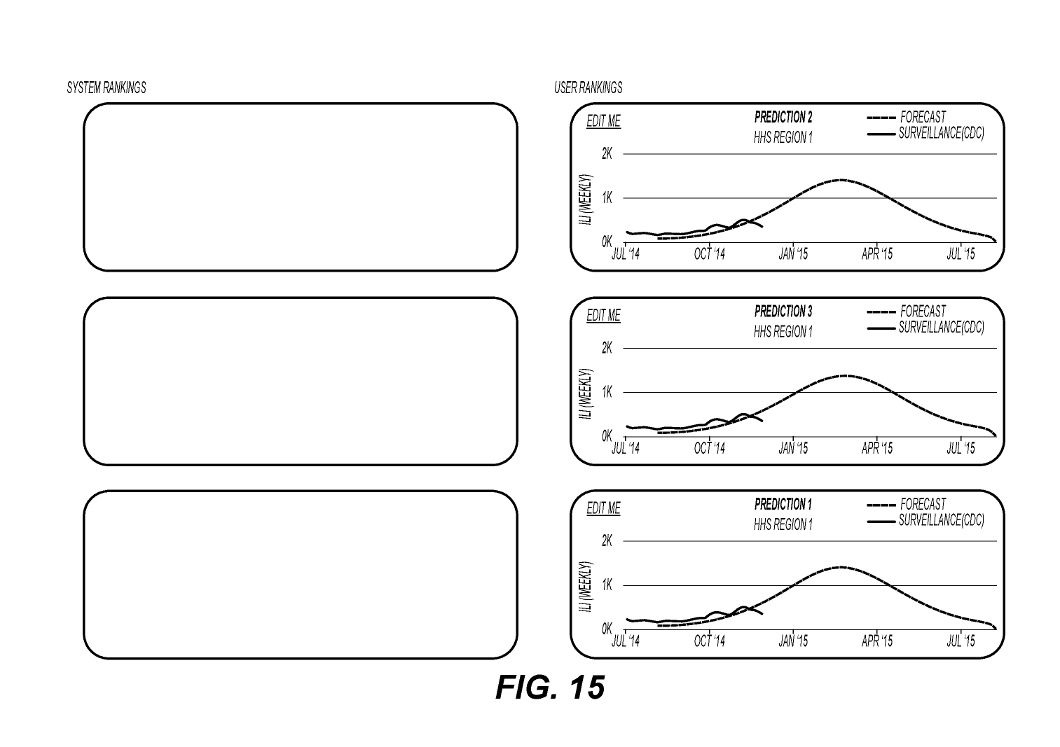

FIG. 15 shows the state of the ranking widget of FIG. 14 after the user saves the ranking task. In some examples, when the user logs into the system at a later stage, his/her previous ranking responses are communicated in a similar fashion as illustrated in FIG. 15. Any number of predictions can be supported, e.g., stacked vertically. For example, rankings of four predictions can be solicited via the widget.

FIG. 15 shows the ranked results. The system can express the rankings, e.g., as a permutation of the set of predictions. The permutation can be processed, e.g., using machine-learning techniques as described above.

In some examples, users can update their ranking results by canceling earlier answers. In some examples, the backend is designed to preserve all the answers, even cancelled ones. In order to reduce bias while ranking prediction curves, the users can only see the aggregate opinion of the crowd once they complete the ranking task. For example, the vote distribution can be shown as stacked bar chart with a bar per rank, each bar divided into a range per prediction. In some examples, rankings and individual forecasts predicted by a user are not visible to other users. In some examples, users can view aggregate data, e.g., in the form of visualizations or summary tables.

FIG. 16 shows an example widget permitting user modification of a forecast curve. The widget can receive drag-and-drop input of modifications to the “predicted” portion of the curve. Unlike the ranking task, this task provides direct access to the forecasted curve and permits collecting users' knowledge at a finer level of detail. The widget permits users to make individualized predictions by manipulating an existing prediction made by the system. This allows subject matter experts to submit their own beliefs about how the season is headed and to express (or modify) their information regarding epidemic forecasting measures like peak value (or time), first-take off value (or time), intensity duration, velocity of the epidemic, and the start time of flu season. FIG. 16 shows one of the forecast plots made by the system before user improvements/modifications. To facilitate identification of the different forecasting models created by the user, the widget requires the users enter a unique name for each new forecasting model they create. Also, the individualized ranking widget allows users to revert their changes by providing “undo” and “cancel” options. The widget provides options for users to save, undo, or cancel their changes.

FIG. 17 shows the widget of FIG. 16 after receiving user modifications to the forecast, e.g., a new forecasting model created by receiving user modifications of the system-generated prediction. In some examples, the UI 240 can present a “My Models”′ tab, e.g., on a main dashboard, that shows the list of individualized models created by the user.

In some examples, modification of at least one data point results in a new forecast. The resulting time series (shown dashed) captures otherwise-inaccessible data from the user about the ongoing influenza season or other epidemic, and these data are stored in the backend database associated with the user's account. The forecast provided by the user can then be used to revise backend models, e.g., disease model 144, to make more accurate predictions, e.g., if the user has made consistently good predictions in the past (see, e.g., blocks 908 and 912).

FIG. 18 shows an example system model. The system model depicts various entities and the relationships between them. This model is kept simple by including only the relevant entities and relationships. In order to store and provide analytics for surveillance and forecasting data from past seasons, a “season” entity is used in the system. The idea of what constitutes a season is loosely defined to generalize the definition for multiple diseases. A season is identified by a combination of geographical region, disease, and season name. Generally, it is observed that data reported through traditional methods for illnesses such as flu lag by 2 to 3 weeks, and, further, that these reports are revised retrospectively after the first report. To account for this uncertainty associated with surveillance data, a single season entity can have multiple surveillance data sources.

In various examples, APIs are used to access data, e.g., as described herein. In some examples, RESTful APIs are used to provide access to system resources and data analysis methods. The APIs are designed using best RESTful patterns, and can include at least one of the following features: Multiple versions for backward compatibility; Multiple representations/formats for system resources like prediction data, surveillance data sources, etc.; a unique URL for each system resource; authentication for secure system resources; or queries, like filtering and selection, built into the URL as query parameters.

In some examples, since every resource that needs to be retrieved from the system is uniquely identified by a URL, the responses to APIs can be cached at multiple levels (server-side caching and client-side caching) to improve the system's scalability and efficiency. The client 304 (e.g., front end 114 application) and back end 116 can employ caching to reduce load on the server 308 or database (e.g., data library 122).

FIG. 19 shows an example database schema illustrating information stored and processed by the system, e.g., by front end 114, back end 116, tool 128, or MBE 132.

FIG. 20 shows an example ensemble simple average used to combine forecasts, e.g., as discussed herein with reference to FIG. 12 and analytics component 322. Denote a set of predictions yᵢ, iε[1,K]. Each prediction includes values for various times t, e.g., weeks or months, so yᵢ={y_{t,i}}ₜ₌₁ⁿ. The limit n can represent the epidemic outbreak period, which may be unknown. Then the ensemble simple average yₒ is

$${y}_{o} = {\sum }_{i - 1}^{K} {w}_{i} {y}_{i} = {\{ \frac{1}{K} {\sum }_{i - 1}^{K} {y}_{t , i} \}}_{t = 1}^{n}$$

where wᵢ=1/K. FIG. 20 shows an example of three predictions and a simple ensemble average. Shown for comparison is measured data through approximately December 2014 (“observed”).

### Example Features

Various examples include one or more of, including any combination of any number of, the following example features.

In various examples, the system may analyze characteristics of the user base when generating the output data. For example, the system may track user-related events and/or geographically locate users based on their IP address or other information. For example, geographic location information for a user base may be presented to users as part of the output data (e.g., within a map interface) to help the users understand the origin of the user contributions. Examples are discussed herein, e.g., with reference to block 1102. The system may provide some tools for monitoring the user base and determining whether users are returning and repeatedly providing data, approaching a sign-up interface and leaving without signing up, etc.

In various examples, the system tracks user-related events, and geolocates users, e.g., based on their IP address. The system is capable of running statistical analysis on the user-related data. The results can be communicated to the user in the form of visualizations using the client 304 application.

In some examples, the geolocation information collected by the system is plotted on a high-resolution interactive map using markers. This feature helps to analyze how the participants are dispersed geographically.

In various examples, the system provides tools to monitor user participation and contributions, e.g., a graph of the total number of hours spent by users per day. These tools can permit determining how effective incentive mechanisms and analytical features are in motivating and retaining user participation over time; whether communicating with users via email and social media have any impact on system usage; or what happens to system usage after a targeted campaign ends.

Various examples relate to platforms for collecting human knowledge or other data that are not generated in a form accessible to computing systems. Various examples relate to evaluation of various techniques for harnessing such data in improving forecasting models for infectious diseases, such as Influenza and Ebola.

Various examples provide a Web-accessible system that simplifies the collection of such data by: (i) asking users to rank system-generated forecasts in order of likelihood; and (ii) allowing users to improve upon an existing system-generated prediction. The structured output collected from querying users can then be used in building better forecasting models. Various examples provide an end-to-end analytical system, and provide access to data collection features and statistical tools that are applied to the collected data. The results are communicated to the user, wherever applicable, in the form of visualizations for easier data comprehension. Various examples contribute to the field of epidemiology by providing previously-inaccessible data and an infrastructure to improve forecasts in real time.

Various examples relate to forecasting the epidemic curve (“epicurve”) associated with an epidemic outbreak. An epidemic curve displays either the daily or weekly number of infected cases observed during the outbreak period. Forecasting as described herein can include determining predicted epicurve values for days or weeks in the future.

A number of mathematical and computational models exist for forecasting the dynamics of infectious diseases. Among them, the compartmental (population) models are widely used. These forecasting models split the population of interest into different compartments, and allow people to move between the compartments, such as suspected to infected, or infected to dead (or recovered). Although these models are parsimonious in nature and are relatively easy to set up, they make simplistic assumptions that people within a compartment have uniform mixing. Moreover, some prior models don't account for dynamic adaptation of human behavior in response to the developing epidemic.

At the other end of the spectrum of compartmental models are agent-based models (ABM), where the population is represented as a network (e.g., an SP graph 434 or 456), and each node corresponds to an individual entity, e.g., a software agent in a virtual world. The agents' movements and contact patterns in the virtual world are modeled by the edges in the network. ABMs are simulated over a certain disease model, such as Susceptible-Infectious-Recovered (SIR) or Susceptible-Exposed-Infectious-Recovered (SEIR). Each agent is assigned a certain disease state before the beginning of the simulation, and, additionally, agents are assigned rules which mimic human behavior, such as fear, bias, etc., seen in real-time epidemic scenarios. During the progress of the simulation over several replicates, the model keeps track of agents, and updates their states as they move around in the virtual world. ABMs provide the opportunity to explore how individual behavior affects epidemic dynamics, and allows for the evaluation of the effect of various intervention scenarios, and thus plays an important role in determining public policy decisions. However, deployment of ABM models requires realistic contact networks with fine-grained geographic and demographic information which may be unavailable for a particular region. Another challenge involves determining an accurate set of rules to simulate human behavior.

Apart from the models based on traditional surveillance data sources, new models have been developed using novel data sources such as climate data, using digital data sources such as Google search keywords, Twitter, HealthMap, and table reservation data available through OpenTable APIs to forecast Influenza-like Illness (ILI) case counts. Additionally, systems have been developed which make forecasts by combining multiple data streams. Moreover, some studies indicate that digital data sources need not always provide good signals for Influenza trends.

Some prior forecasting approaches make certain assumptions regarding the infectious disease, such as disease transmission, effect of disease control measures, etc., and exhibit limitations in modeling the real epidemic outbreak given the challenges in obtaining reliable surveillance case data. Thus, there is a need to confirm the strength and weakness of models and determine if there is a vector for improvement. Various examples herein permit collecting data from, e.g., microbiologists, pharmacists, field experts, physicians, and nurses regarding future epidemic activity.

Flu season is an annual event in the United States due to the prevalence of the influenza virus. The Centers for Disease Control and Prevention (CDC) report that the flu vaccine is only 60% effective in all the cases. Recent estimates put the annual influenza cost to the US economy at $71-$167 billion due to hospitalizations, missed work days, and lives lost. It is estimated that roughly 5 to 20 percent of the US population contracts influenza every season, resulting in approximately 36,000 deaths. Reliable and timely predictions of flu dynamics could help public health officials in making informed decisions concerning allocation of resources. Earlier prediction of flu forecasts can enable policy makers to choose the appropriate control and preventive measures so that the impact of the disease is reduced.

However, reliable forecasting of influenza epidemics is challenging for at least the following reasons: (i) each flu season exhibits variations in timing and intensity with respect to the previous year's outbreaks; (ii) non-availability of reliable surveillance data; and (iii) the incidence rate depends on climatic, behavioral (contact patterns, age groups) and biological factors (immunity etc.), which are difficult to account for. This situation is further complicated when a novel strain of the virus is introduced, as was the case during the 2009 flu season.

In some examples herein, user data are collected, e.g., ranking and individual forecasting as discussed herein with reference to FIG. 12. Various examples determine epidemic forecasts based on several factors which include the type of disease, geographical region, data source, and forecasting model; therefore, the platform is designed to handle a diverse set of epidemiological forecasting models, surveillance data sources, multiple diseases, and geographical regions. The platform also stores historical surveillance data to provide useful insights and trends.

In some examples, active users' data are weighted more heavily than inactive users' data, e.g., in predicting influenza activity. In some examples, analytics support is provided. In some examples, the system includes leaderboard to drive competition among users to make better predictions.

Various examples described in FIGS. 1-20 provide multiple dimensions for forecasting models. Epidemiological or other event models can be functions of several input parameters, and the system is not restricted to a particular disease or model. The system can permit distinguishing at least some of the following characteristics of an event: Type of infectious disease; geographical region; forecasting model; uncertainty bounds for model; seasons (time periods); surveillance data sources; or quality metrics for evaluating forecasting methods.

Various examples provide improved data ingestion. Various examples provide data-ingestion automation, e.g., using PYTHON scripts. Various examples provide a Functional User Interface (UI) permitting end users who configure the tasks as described above to develop scripts for populating data from different surveillance and forecasting data sources. Various examples of the back end provide a functional UI which can be used for data population. This UI abstracts many of the complex details by providing a simple web form for entering and modifying data dynamically. For example, the UI can present a web form permitting modifying the epidemic curve data for a particular forecasting model.

Various examples provide Web Services APIs. In some examples, the front end and back end are completely decoupled with each other, and data flows between them through carefully designed RESTful APIs. This design provides a lot of flexibility and allows the system to scale horizontally. Various classes of APIs can provide access to various system resources and can hide the complexity of the back end infrastructure. These APIs can be used by both internal and external clients.

Various examples reduce the amount of time and effort involved in launching new diseases, geographical regions, and forecasting models. Also, the framework provided by the system makes it easy and fast to deploy new web APIs.

Various examples of an analytical platform provide access to flexible queries, data collection features, and machine-learning algorithms. Various examples provide a framework for operating or testing different algorithms.

Various examples track user participation and compute user-related analytics. Some examples track at least one of the following types of information: Login IP address; geolocation data (latitude, longitude, city, state, country, etc.); Login and logout time; or Responses to queries. Various examples store this information in a relational database to manage and retrieve the data efficiently.

### Example Modeling Implementations

FIGS. 21-26 show examples of computer modeling of interactions among multiple entities, e.g., as discussed herein with reference to at least FIGS. 1-20. These and other examples are described herein with reference to n U.S. Pat. No. 8,423,494, titled “Complex Situation Analysis System,” filed Apr. 14, 2010, which claims priority to U.S. Provisional Patent Application No. 61/169,570, entitled “Complex Situation Analysis and Support,” filed Apr. 15, 2009, and U.S. Provisional Patent Application No. 61/323,748, filed Apr. 13, 2010, titled “Situation Analysis System,” all of which are incorporated herein by reference in their entireties. Statements made in the referenced patent and applications may be specific to a particular example embodiment, or a specific aspect of the example embodiment, and should not be construed as limiting other example embodiments described herein. Features described with regard to one type of example embodiment may be applicable to other types of example embodiments as well; it should be appreciated that the features discussed in the referenced patent and applications are not limited to the specific case models with respect to which they are discussed.

Computer-generated models are frequently used to replicate various real-life scenarios. Such models, for example, may be used to model traffic congestion in a particular area during a particular time of day. Using these models, researchers can estimate the effect that a change in certain variables related to the models may have on the outcome of the scenarios being replicated. Example scenarios can include events as described herein, e.g., epidemics or other occurrences having consequences that may occur during the progress of the event.

Computer models may be limited in their usefulness by various factors, including the availability of information with which to construct the network underlying the model. Social contact networks are a type of network representing interactions between entities within a population. Large-scale social contact networks may be particularly complicated to model because of the difficulty in collecting reliable data regarding entities and social contacts within the population. Some social contact network models have addressed this difficulty by utilizing only small data sets in constructing the social contact network. In some types of network models (e.g., the Internet, the power grid, etc.), where the real network structure is not easily available due to commercial and security concerns, methods have been developed to infer the network structure by indirect measurements. However, such methods may not apply to large-scale social contact networks (e.g., large heterogeneous urban populations) because of the variety of information sources needed to build them.

Accordingly, various examples include a complex situation analysis system that generates a social contact network, uses edge brokers and service brokers, and dynamically adds brokers. An example system for generating a representation of a situation is disclosed. The example system comprises one or more computer-readable media including computer-executable instructions that are executable by one or more processors to implement an example method of generating a representation of a situation. The example method comprises receiving input data regarding a target population. The example method further comprises constructing a synthetic data set including a synthetic population based on the input data. The synthetic population includes a plurality of synthetic entities. In some examples, each synthetic entity has a one-to-one correspondence with an entity in the target population, although this is not required. In some examples, each synthetic entity is assigned one or more attributes based on information included in the input data. The example method further comprises receiving activity data for a plurality of entities in the target population.

In some examples, the example method further comprises generating activity schedules for each synthetic entity in the synthetic population. Each synthetic entity is assigned at least one activity schedule based on the attributes assigned to the synthetic entity and information included in the activity data. An activity schedule describes the activities of the synthetic entity and includes a location associated with each activity. The example method can further comprise receiving additional data relevant to the situation being represented. The additional data is received from at least two distinct information sources. For example, at least some of the additional data can be received from a user 242, e.g., as discussed herein with reference to FIG. 1-5, 8, 10, or 12-17. The example method can further comprise modifying the synthetic data set based on the additional data. Modifying the synthetic data set includes integrating at least a portion of the additional data received from each of the at least two distinct information sources into the synthetic data set based on one or more behavioral theories related to the synthetic population. The example method can further comprise generating a social contact network, e.g., social-interaction graph, based on the synthetic data set. The social contact network can be used to generate the representation of the situation.

Referring generally to FIGS. 21-26, a situation analysis system for representing complex systems is shown and described, according to various example embodiments. The situation analysis system is configured to build a synthetic data set including a synthetic population representing a target population of interest in an experiment. At least one of the synthetic data set or the synthetic population can be, or be included in, a data library 122. A synthetic population may be a collection of synthetic entities (e.g., humans, plants, animals, insects, cells within an organism, etc.), each of which represents an entity in a target population in an abstract fashion such that the actual entity in the target population is not individually identifiable (e.g., for anonymity and/or security purposes) but the structure (e.g., time-varying interaction structure) and properties (e.g., statistical properties) of the target population are preserved in the synthetic population. The situation analysis system is configured to modify the synthetic data set to include information regarding interactions between synthetic entities that are members of the synthetic population. The synthetic data set can be used to generate a social contact network (e.g., represented as a graph) representing a situation associated with the experiment, which can in turn be used to analyze different decisions and courses of action that may be made in relation to the experiment. The situational analysis system may allow a user to efficiently study very large interdependent societal infrastructures (e.g., having greater than 10 million interacting elements) formed by the interaction between infrastructure elements and the movement patterns of entities in the population of interest.

FIG. 21 shows an organizational chart 100 for a situation analysis system 102, according to an example embodiment. Situation analysis system 102 is an integrated system for representation and support of complex situations. System 102 is configured to construct a synthetic data set including a synthetic population representing an actual population of interest and utilize various data sources (e.g., surveillance data, simulations, expert opinions, etc.) to construct a hypothetical representation of a situation. System 102 can then use simulation-based methods to determine outcomes consistent with the hypothesis and use the determined outcomes to confirm or disprove the hypothesis. In various embodiments, system 102 may be configured to create representations of a situation (e.g., involving a large-scale urban infrastructure) involving a large number of interacting entities (e.g., at least ten million interacting entities). In some embodiments, system 102 may be scalable to represent interactions between 100-300 million or more interacting entities and five to fifteen billion interactions.

According to various embodiments, system 102 may be implemented as software (e.g., computer-executable instructions stored on one or more computer-readable media) that may be executed by one or more computing systems. System 102 may be implemented across one or more high-performance computing (“HPC”) systems (e.g., a group of two or more computing systems arranged or connected in a cluster to provide increased computing power). In some embodiments, system 102 may be implemented on HPC architectures including 20,000 to 100,000 or more core systems. System 102 may be implemented on wide-area network based distributed computing resources, such as the TeraGrid or the cloud. In further embodiments, one or more components of system 102 may be accessible via mobile communication devices (e.g., cellular phones, PDAs, smartphones, etc.). In such embodiments, the mobile communication devices may be location-aware and one or more components of system 102 may utilize the location of the digital device in creating the desired situation representation.

In the example embodiment of FIG. 21, situation analysis system 102 is shown to include several subsystems. Synthetic data set subsystem 104 is configured to construct a synthetic population based on an actual population of interest for the situation being represented. Throughout much of the present disclosure, the synthetic population is discussed as representing a population of human beings in a particular geographic area. However, it should be appreciated that, according to various embodiments, the synthetic population may represent other types of populations, such as other living organisms (e.g., insects, plants, etc.) or objects (e.g., vehicles, wireless communication devices, etc.). Synthetic data set subsystem 104 may be used to represent populations including hundreds of millions to billions of interacting entities or individuals. Once a synthetic population has been constructed, synthetic data set subsystem 104 may utilize data from one or more different data sources to construct a detailed dynamic representation of a situation. The data sources utilized in constructing the representation may be dependent upon the situation being analyzed.

Surveillance subsystem 106 is configured to collect and process sensor and/or surveillance information from a variety of information sources (e.g., surveillance data, simulations, expert opinions, etc.) for use in creating and/or modifying the synthetic data set. The data may be received from both proprietary (e.g., commercial databases, such as those provided by Dun & Bradstreet) and publicly available sources (e.g., government databases, such as the National Household Travel Survey provided by the Bureau of Transportation Statistics or databases provided by the National Center for Education Statistics). Surveillance subsystem 106 may be used to integrate and/or classify data received from diverse information sources (e.g., by the use of voting schemes). Standard classification schemes used in machine learning and statistics (e.g., Bayes classifiers, classification and regression trees, principal components analysis, support vector machines, clustering, etc.) may be used by surveillance subsystem 106 depending on the desired application. In some embodiments, surveillance subsystem 106 may allow the flexibility to utilize new techniques developed for a specific application. The data collected and processed by surveillance subsystem 106 may be used by synthetic data set subsystem 104 and/or other subsystems of system 102 to create, modify, and/or manipulate the synthetic data set and, accordingly, the situation representation. Synthetic data set subsystem 104 may in turn provide cues to surveillance subsystem 106 for use in orienting surveillance and determining what data should be obtained and/or how the data should be processed.

Decision analysis subsystem 108 is configured to analyze various possible courses of action and support context-based decision making based on the synthetic data set, social contact network and/or situation representation created by synthetic data set subsystem 104. Decision analysis subsystem 108 may be used to define a scenario and design an experiment based on various alternatives that the user wishes to study. The experiment design is utilized by the other subsystems of system 102, including synthetic data set subsystem 104, to build and/or modify the synthetic data set (including, e.g., the synthetic population) and construct the social contact network used to represent the situation. Decision analysis subsystem 108 uses information related to the synthetic data set and/or situation representation received from synthetic data set subsystem 104 to support decision making and analysis of different possible courses of action. Experiment design, decision making, analysis of alternatives, and/or other functions of decision analysis subsystem 108 may be performed in an automated fashion or based on interaction with and input from one or more users of system 102.

In some embodiments, various subsystems of system 102 may utilize one or more case-specific models provided by case modeling subsystem 110. Case modeling subsystem 110 is configured to provide models and/or algorithms based upon the scenario at issue as defined by decision analysis subsystem 108. According to various embodiments, example case models may be related to public health (e.g., epidemiology), economics (e.g., commodity markets), computing networks (e.g., packet switched telecommunication networks), civil infrastructures (e.g., transportation), and other areas. In some embodiments, portions of multiple case models may be used in combination depending on the situation the user desires to represent.

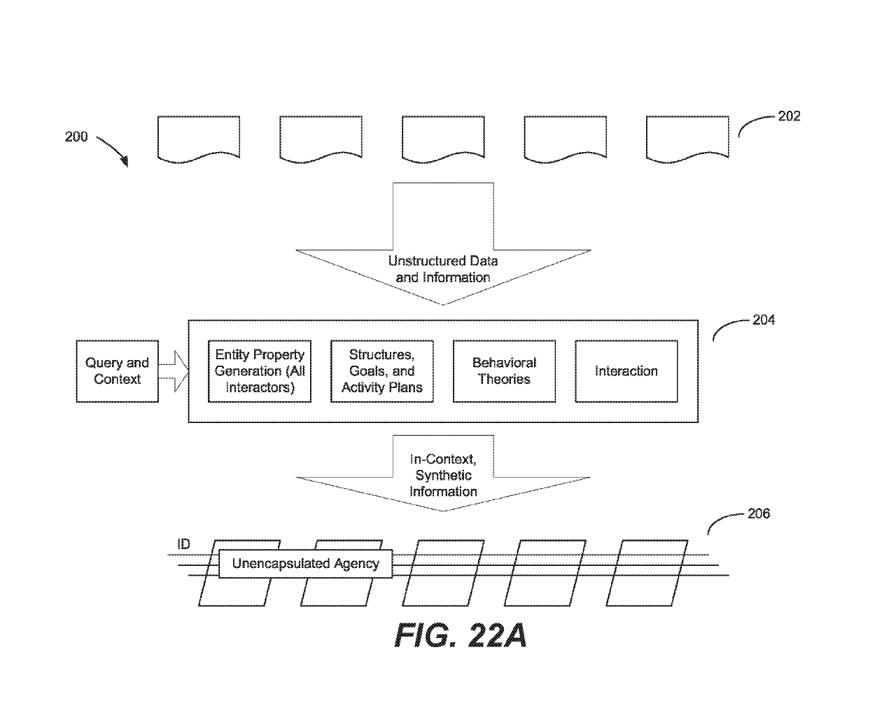

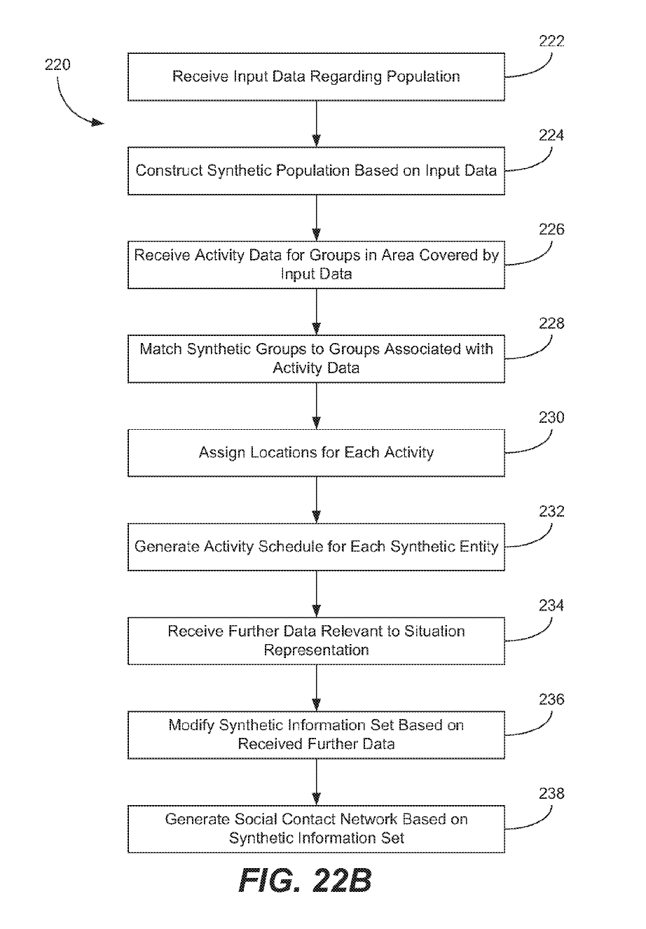

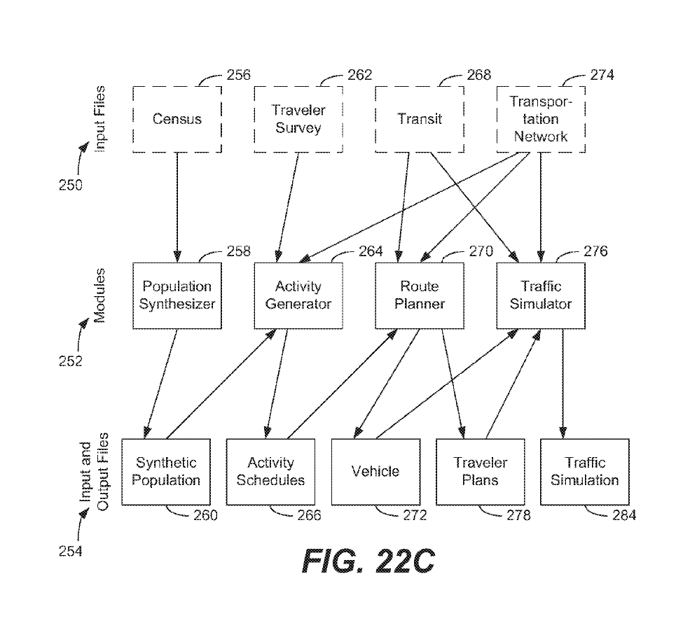

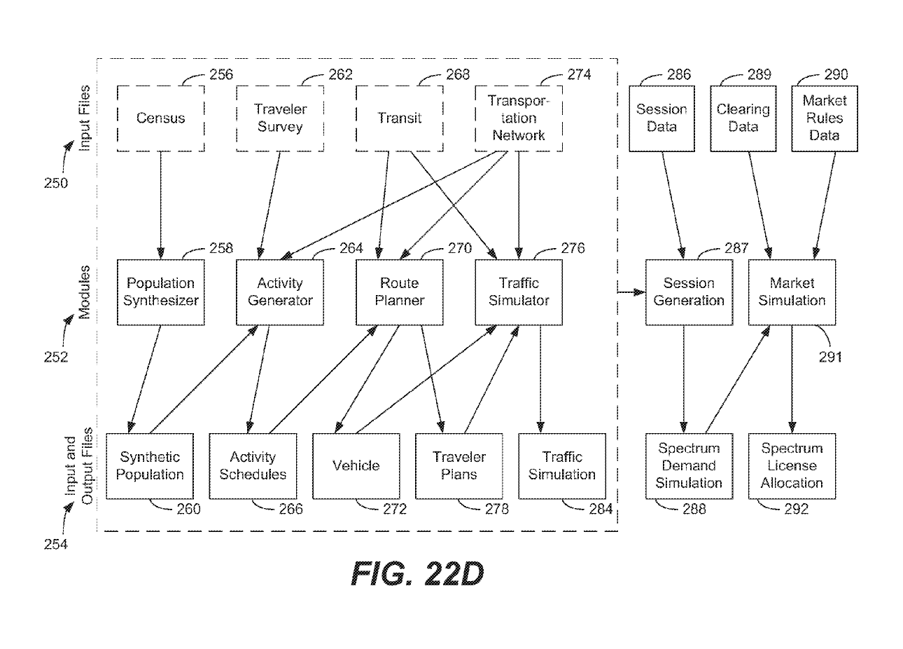

FIG. 22A shows a flow diagram illustrating the flow and structure of information using system 102, according to an example embodiment. At block 202, unstructured data is collected by surveillance subsystem 106 for use in forming the desired situation representation. The data may be collected from various proprietary and/or public sources, such as surveys, government databases, proprietary databases, etc. Surveillance subsystem 106 processes the information into a form that can be utilized by synthetic data set subsystem 104.

At block 204, synthetic data set subsystem 104 receives the unstructured data, provides context to the data, and creates and/or modifies a synthetic data set, including a synthetic population data set, and constructs a social contact network used to form the desired situation representation. Synthetic data set subsystem 104 may provide context to the unstructured data using various modules that may be based on, for example, properties of the individuals or entities that comprise the synthetic population, previously known goals and/or activities of the members of the synthetic population, theories regarding the expected behavior of the synthetic population members, known interactions between the synthetic population members, etc. In some embodiments, unstructured data obtained from multiple sources may be misaligned or noisy and synthetic data set subsystem 104 may be configured to use one or more behavioral or social theories to combine the unstructured data into the synthetic data set. In various embodiments, synthetic data set subsystem 104 may be configured to contextualize information from at least ten distinct information sources. Synthetic data set subsystem 104 may be configured to construct multi-theory networks, such that synthetic data set subsystem 104 includes multiple behavioral rules that may be utilized by various components of synthetic data set subsystem 104 to construct and/or modify the synthetic data set depending on the situation being represented and the types of interactions involved (e.g., driving behavior, disease manifestation behavior, wireless device use behavior, etc.). Synthetic data set subsystem 104 may also be configured to construct multi-level networks, such that separate types of social contact networks (e.g., transportation networks, communications networks) may be created that relate to distinct types of interactions but are coupled through common synthetic entities and groups. Because context is provided to the unstructured information through the use of behavioral theories and other factors, in some embodiments synthetic data set subsystem 104 may be configured to incorporate information from new data sets into the synthetic data set as they become available for use by system 102. For example, synthetic data set subsystem 104 may be configured to incorporate usage data regarding new wireless communication devices.

Once context has been provided to the unstructured data, the relevant data is integrated into the synthetic data set, which is provided by situational awareness module 104 at block 206. According to various embodiments, the synthetic data set provided at block 206 may be modified (e.g., iteratively) to incorporate further data from surveillance subsystem 106, for example based on experiment features or decisions provided by decision analysis subsystem 108. As further questions are posed via decision analysis subsystem 108 and further data is integrated into the synthetic data set, system 102 may require fewer computing resources to produce a desired situation representation. In some embodiments, the synthetic information resource may be stored or preserved and utilized (e.g., by the same or a different user of system 102) to form representations of other (e.g., similar) situations. In such embodiments, fewer computing resources may be required to create the newly desired situation representation as one or more types of information needed to create the representation may already be incorporated into the previously created synthetic data set.

FIG. 22B shows a flow diagram of a process 220 that may be used by system 102 to construct a synthetic data set. At step 222, system 102 receives input data regarding a target population of interest in forming the desired situation representation. For example, if the desired situation representation relates to the spread of an illness in Illinois, the input data may include information regarding people living in or near the state of Illinois. The input data may be collected by surveillance subsystem 106 and processed for use by synthetic data set subsystem 104. The input data may be any of various types of data received from public and/or proprietary sources. For the purposes of this example embodiment, the input data is data from the U.S. Census.

Synthetic data set subsystem 104 uses the input data to construct a synthetic population based on the received input data (step 224). The synthetic population includes a plurality of interacting synthetic entities, which may be living organisms (e.g., humans, animals, insects, plants, etc.) and/or inanimate objects (e.g., vehicles, wireless communication devices, infrastructure elements, etc.). In some embodiments, the synthetic population may model all entities within an area (e.g., geographic area) of interest, such that each synthetic entity in the synthetic population represents an actual entity in the location (e.g., geographic location) of interest. The synthetic entities may be assigned characteristics based on information reflected in the input data. In the example noted above, wherein the synthetic entities represent human beings and the input data is data from the U.S. Census, the demographic data reflected in the U.S. Census may be used to generate the synthetic population (e.g., age, income level, etc.).

The synthetic entities may also be placed in one or more blocks or groups with other synthetic entities. For example, synthetic entities representing human beings may be placed in households with other synthetic entities based on the census data. The households may be placed geographically in such a way that the synthetic population reflects the same statistical properties as the underlying census data (i.e., the synthetic population is statistically indistinguishable from the census data). Because the synthetic population is composed of synthetic entities created using census demographic data and not actual entities or individuals, the privacy and security of the actual entities within the population of interest can be protected. In other embodiments, the synthetic entities may be grouped into other types of synthetic blocks or groups based on characteristics other than household membership (e.g., genus, species, device type, infrastructure type, etc.). In some embodiments, a synthetic data set may not previously exist and synthetic data set subsystem 104 may create a new synthetic data set including the constructed synthetic population. In other embodiments, a previously existing synthetic data set may be modified to include part or all of the created synthetic population.

System 102 may also obtain or receive a set of activity or event templates including activity data for entities or groups of entities in the target population (step 226). For example, activity templates related to a human population may include activity data for households in the geographic area of interest. The activity templates may be based on information from one or more sources, such as travel surveys collected by the government, marketing surveys (e.g., proprietary surveys conducted by marketing agencies), digital device tracking data (e.g., cellular telephone or wireless communication device usage information), and/or other sources. The activity data may be collected and processed by surveillance subsystem 106 and used by synthetic data set subsystem 104 to construct or modify a social contact network based on the synthetic population. In some embodiments, data may be collected from multiple sources, which may or may not be configured to be compatible with one another, and surveillance subsystem 106 and/or synthetic data set subsystem 104 may be configured to combine and process the data in a way that may be used by synthetic data set subsystem 104 to create and/or modify the synthetic data set. The activity templates may describe daily activities of the inhabitants of the household and may be based on one or more information sources such as activity or time-use surveys. The activity templates may also include data regarding the times at which the various daily activities are performed, priority levels of the activities, preferences regarding how the entity travels to the activity location (e.g., vehicle preference), possible locations for the activity, etc. In some embodiments, an activity template may describe the activities of each full day (i.e., 24 hours) for each inhabitant of the associated household in minute-by-minute or second-by-second detail.

Once the activity templates are received, synthetic data set subsystem 104 matches each synthetic group (e.g., household) with one of the survey groups (e.g., survey households) associated with the activity templates (step 228). The synthetic groups may be matched with survey groups (e.g., using a decision tree) based on information (e.g., demographic information) contained in the input data (e.g., census data) and information from the activity surveys (e.g., number of workers in the household, number of children in the household, ages of inhabitants, etc.). Synthetic data set subsystem 104 then assigns each synthetic group the activity template of its matching survey group.

Once activity templates have been assigned to each synthetic group, a location is assigned for each synthetic group and each activity reflected in the synthetic group's activity template (step 230). The locations may be assigned based on observed land-use patterns, tax data, employment data, and/or other types of data. Locations may be assigned in part based on an identity or purpose of the activity, which, in the example where the synthetic population represents a human population, may include home, work, and school or college, shopping, and/or other identities. Locations for the activities may be chosen using data from a variety of databases, including commercial and/or public databases such as those from Dun & Bradstreet (e.g., for work, retail, and recreation locations) and the National Center for Educational Statistics (e.g., for school and college locations). In some embodiments, the locations may be calibrated against observed travel-time distributions for the relevant geographic area. For example, travel time data in the National Household Travel Survey may be used to calibrate locations. Once locations for each activity have been determined, an activity schedule is generated for each synthetic entity describing the activities of the synthetic entity, including times and locations (step 232). The activity templates and/or activity schedule may be based in part on the experiment and/or desired situation representation. The synthetic data set may be modified to include the activity schedules, including locations.

In some embodiments, system 102 may be configured to receive further data based on the desired situation representation (step 234). Referring to the example above, if the desired situation representation is related to spread of an illness in Illinois, the further data may include information regarding what areas of Illinois have recorded infections, what the level of infection is in those areas, etc. The received further data may be used to modify, or add information to, the synthetic data set (step 236). In various embodiments, steps 234 and 236 may be repeated one or more times (e.g., iteratively) to integrate additional information (e.g., user-provided information) that is relevant to the desired situation representation into the synthetic data set. At step 238, a social contact network (e.g., represented as a graph) may be created based on the entities and interactions reflected in the synthetic data set. The resultant social contact network can be used to model the desired situation representation such that appropriate decisions can be made using decision analysis subsystem 108.

FIG. 22C shows an example of the flow of information described in FIGS. 22A and 22B using system 102, according to an example embodiment. The example shown in FIG. 22C is a possible flow of information to create a synthetic data set. FIG. 22C illustrates several example input data sets 250 that may be used by system 102 to construct a synthetic data set, including a synthetic population. FIG. 22C also illustrates several example modules 252 (e.g., software modules) that may be used by system 102 to manipulate the input data sets and integrate the input data into the synthetic data set. Modules 252 may be a part of synthetic data set subsystem 104, case modeling subsystem 110, or other components of system 102. FIG. 22C also illustrates several output data sets 254 that may result from processing performed by modules 252 on input data sets 250. One or more of output data sets 254 may in turn be utilized by various modules 252 to form and/or further modify the synthetic data set. Each of output data sets 254 may be saved as separate data files or as part of the synthetic data set, such that previous experiments directed to similar questions may require fewer calculations to generate the desired situation representation.

In the example shown in FIG. 22C, census data 256 is used by population synthesizer 258 to form a synthetic population 260 for the relevant geographic area. In other embodiments, the data used by population synthesizer 258 to form synthetic population 260 may include marketing surveys, satellite images, and other data. The information included in census data 256 may include demographic data such as income, age, occupation, etc. that may be used by population synthesizer to assign each synthetic entity to a synthetic group or block. For example, synthetic entities representing people may be assigned to synthetic households based on land use data (e.g., value of house, type of house, such as single-family, multi-family, etc.).

Activity generator 264 then uses synthetic population 260 and traveler survey data 262 to form activity schedules 266 for each of the synthetic entities in the synthetic population. Traveler survey data 262 may include surveys conducted by government entities and may include activity participation and travel data for all members of households in the target area. In other embodiments, activity generator 264 may use other data, such as marketing surveys (e.g., commercial surveys conducted by marketing firms), digital device tracking data (e.g., usage data regarding wireless communication devices), and other information to create activity schedules 266. In some embodiments, activity generator 264 may also utilize location information to construct activity schedules 266, such as locations of activities (e.g., including land use and/or employment information). The location information may be included as part of census data 256, traveler survey 262, or one or more other data sources. In various embodiments, activity schedules 266 may be assigned to synthetic entities based on synthetic groups to which the synthetic entities belong. Activity generator 264 is also configured to assign a location to each activity in each activity schedule 266. Locations may be assigned using various methods. One method is to utilize a distance-based distribution that accounts for the reduction in likelihood that an activity location is accurate the further away from an anchor location (e.g., home, work, school, etc.) it is. Locations may be assigned using an iterative process, wherein locations are assigned to activities and compared to the activity time data in the relevant activity schedule 266 to determine if the time needed to travel between locations matches time data reflected in the activity schedule 266. If not, locations may be reassigned iteratively until the time data matches. Synthetic population 260 and activity schedules 266 may be integrated as part of a synthetic data set.

Additional modules are provided in FIG. 22C that are directed to modifying the synthetic data set and/or producing additional output data sets 254. Route planner 270 is configured to receive information from activity schedules 266, transit usage data 268, and transportation network data 274 and generate vehicle data 272 (e.g., vehicle ownership information for each synthetic individual and/or synthetic group) and traveler plans 278 (e.g., information regarding the travel behavior of or travel routes used by each of the synthetic entities in the synthetic population to fulfill the activities reflected in activity surveys 266). According to one embodiment, the transit usage data may include survey data obtained from a publicly available source (e.g., administrative data from a government source) and may include, for example, data regarding transit activity and usage in the relevant geographic area, such as type of transit used, time of day transit is used, average commute time, average delay due to traffic, and other data. Transportation network data 274 may also include data obtained from a publicly available source (e.g., a U.S. Department of Transportation or Bureau of Transportation Statistics database), and the data may include, for example, streets databases, transit density and type information, traffic counts, timing information for traffic lights, vehicle ownership surveys, mode of transportation choice surveys and measurements, etc. Traveler plans 278 produced by route planner 270 may include, for example, vehicle start and finish parking locations, vehicle path through transportation network 274, expected arrival times at activity locations along the path, synthetic entities present in the vehicle at one or more points along the path, transit mode changes (e.g., car to bus), and/or other information. In one embodiment, route planner 270 may be configured to generate traveler plans 278 that may be multi-modal, such that a synthetic entity may use multiple modes of transportation to arrive at various activities reflected in activity survey 266 (e.g., a car to take a child to school, a train to get to and from work, and a car to shop).

Traffic simulator 276 is configured to use information from vehicle data 272, traveler plans 278, transit data 268, and transportation network 274 to generate a traffic simulation 284 (e.g., a time-dependent simulation of traffic for the relevant geographic area). Traffic simulation 284 may simulate the flow of traffic over the entire range of times reflected in activity surveys 266 or a portion of the time range. In one embodiment, traffic simulator 276 may be configured to simulate traffic on a second-by-second basis. Traffic simulator 276 is configured to generate traffic simulation 284 based on the detailed travel routes reflected in traveler plans 278, which in turn are based in part on activity schedules 266, such that traffic simulation 284 simulates traffic conditions based on transit patterns related to the activities of each synthetic individual reflected in activity schedules 266. Traffic simulator 276 may be configured to check the generated traffic simulation 284 against transit information from transit data 268 and/or transportation network 274 to determine the reasonableness and/or accuracy of the simulation. For example, traffic simulator 276 may check the amount of traffic in a particular area at a particular time reflected in traffic simulation 284 against traffic count information received from transportation network 274. If the values produced using the simulation are not comparable to the corresponding traffic counts for the relevant area, route planner 270 may be configured to generate a different set of traveler plans 278. In one embodiment, the traveler plan generation and traffic simulation process may be repeated until the traffic simulation 284 corresponds to the information from transit data 268 and transportation network 274 within a given (e.g., user-specified) tolerance.

FIG. 22D shows an example flow of information that may be used to allocate portions of wireless spectrum, according to an example embodiment. As shown, the example embodiment of FIG. 22D is an extension of the example embodiment shown in FIG. 22C. The embodiment shown in FIG. 22D may be used, for example by the Federal Communications Commission (“FCC”), to allocate portions of a limited wireless spectrum, such as the radio frequency spectrum.

Session generation module 287 is configured to generate a time and location-based representation of demand for spectrum. Session generation module 287 is configured to receive session input data 286 and utilize the input data, together with the synthetic data set created by the example embodiment shown in FIG. 22C, to simulate the spectrum demand. Session generation module 287 may receive device ownership data in session input data 286 describing the types of devices owned by members of the target population (e.g., cell phones) and assign devices to entities in the synthetic population based on information (e.g., age, income level, etc.) contained in the device ownership data. In one embodiment, the device ownership data may be a survey such as the National Health Interview Survey collected by the Centers for Disease Control and Prevention. Session input data 286 may also contain data regarding call sessions (e.g., call arrival rate, call duration, etc.) for each cell in the relevant geographic area. A cell may be defined for each tower serving spectrum in the geographic area and may be based on the coverage area of the associated tower. The call session data included in session input data 286 may be aggregated data for each cell. Using the call session data, session generation module 287 may generate and assign call sessions, including times, to entities in the synthetic population. Session input data 286 may also include spatial or geographic data regarding each of the cells in the geographic area, which session generation module 287 may use, together with data from transportation network 274 and/or activity location data from the synthetic data set, to determine call volumes for each service provider's tower in the geographic area. The call volumes may be used by session generation module 287 to generate a simulation of the spectrum demanded at each tower, which is provided in spectrum demand simulation 288.

Market modeling module 291 is configured to utilize the generated spectrum demand simulation 288 to determine a proposed spectrum license allocation 292. Market modeling module 291 may receive input data from clearing data 289. Clearing data 289 may include market clearing mechanism data describing the market clearing mechanism(s) (e.g., auction, Dutch auction, ascending bid auction, etc.) used by the supplier to allocate spectrum. Clearing data 289 may also include physical clearing mechanism data describing any physical clearing mechanisms used to address physical limitations to spectrum allocation (e.g., frequency interference between adjacent cells). Market modeling module 291 may also receive information from market rules data 290. Market rules data 290 may include information regarding requirements of one or both of the supplier(s) (e.g., the FCC) and the service provider(s) (e.g., cellular voice and data service providers, radio stations, television stations, etc.) regarding the use of the spectrum. Market modeling module 291 may utilize the spectrum demand simulation 288, clearing data 289, and market rules data 290 to generate a proposed spectrum license allocation 292 that allocates the available spectrum in an efficient manner.

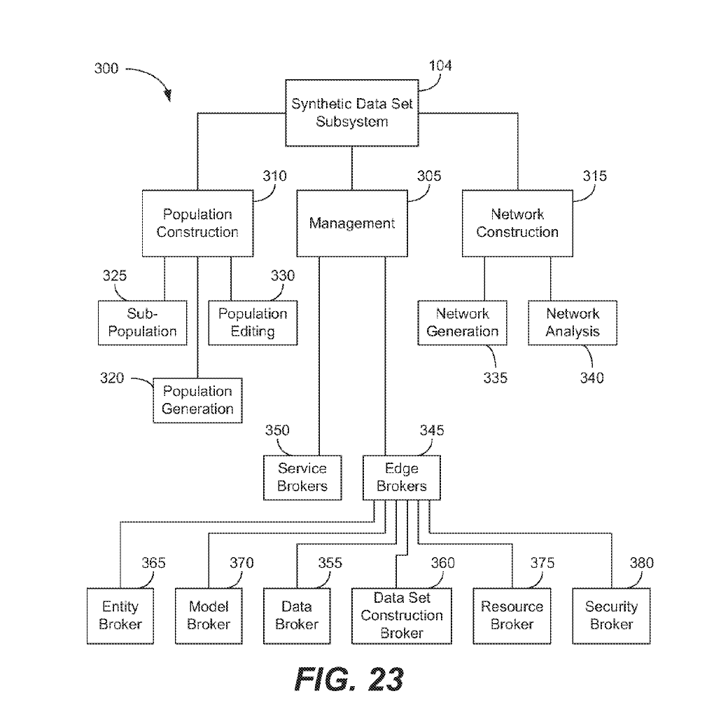

FIG. 23 shows a hierarchical block diagram 300 illustrating components of synthetic data set subsystem 104, according to an example embodiment. According to the example embodiment shown in FIG. 23, synthetic data set subsystem 104 includes a management module 305, a population construction module 310, and a network construction module 315. Management module 305 is generally configured to manage the flow of information in synthetic data set subsystem 104 and direct construction of the desired situation representation. Population construction module 310 is configured to construct and/or modify a synthetic population representing entities in a population of interest in creating the desired situation representation. Network construction module 315 is configured to generate a social contact network (e.g., represented as a graph, such as a hypergraph) based on the interactions between synthetic entities in the synthetic population and to measure and analyze the generated network.

Management module 305 is configured to manage the flow of information in synthetic data set subsystem 104 and organize the construction of a synthetic data set for use in creating a desired situation representation. In various embodiments, the use of management module 305 and/or other components of system 102 may be based on the use of service-oriented architectures. Service-oriented architectures provide a flexible set of services that may be used by multiple different kinds of components and applications. Service-oriented architectures allow different components of system 102 to publish their services to other components and applications. The use of service-oriented architectures may provide for improved software reuse and/or scalability of system 102.

In the illustrated example embodiment, management module 305 controls the flow of information through the use of different types of brokers. Brokers are software modules, or agents, that operate with a specific purpose or intent. In some embodiments, the brokers may be algorithmic (i.e., implemented as high level abstractions rather than as ad hoc constructions that are used in grid-based computing systems). The two primary types of brokers utilized to manage the flow of information are edge brokers 345 and service brokers 350. Edge brokers 345 mediate access to a particular resource (e.g., simulation, data, service, etc.) so that resources need not communicate directly with one another. Service brokers 350 receive high-level requests (e.g., a request for data) and spawn any edge brokers 345 needed to service the requests. If information is required to fulfill a request that is not immediately available to an edge broker 345 (e.g., results of a simulation, data from another database, etc.), a new service broker 350 may be spawned to produce the required information. Multiple service brokers 350 may collaborate to solve a larger problem requiring the utilization of a variety of resources. In some embodiments, service brokers 350 may also provide a resource discovery function, locating resources needed to fulfill a request (e.g., data, resources, models or simulations, etc.).

In various embodiments, brokers may be used to solve a problem or access resources that span across many organizations and locations. If all communication occurs between brokers rather than directly between services, users need not have knowledge of the entire problem being addressed or be aware of or have access to all resources needed to solve the problem. In some embodiments, by using a trusted third party to host the computation, one user or organization may provide a proprietary model that uses proprietary data from a second party without either organization needing to have a trust relationship with the other.

Edge brokers 345 and service brokers 350 may have a number of components. Both edge brokers 345 and service brokers 350 may have an information exchange on which data and requests may be placed for sharing with other brokers and/or applications. An information exchange accepts requests for service and offers the service. If a preexisting edge broker 345 is capable of fulfilling the request, that edge broker 345 may offer to fulfill the request and may be selected by the information exchange. If no preexisting edge broker 345 offers to fulfill the request, one or more new brokers may be spawned to fulfill the request. The spawned, or child, broker (e.g., an edge broker) obtains specifications for the required information from the information exchange of the parent broker (e.g., a service broker), and returns results by writing to the parent broker's information exchange. The information exchange of an edge broker 345 allows data and requests to be shared among all applications served by the edge broker 345. The information exchange of a service broker 350 may be shared among all edge brokers 345 connected to the service broker 350, such that all connected edge brokers 345 can directly share information via the information exchange of service broker 350.

Edge brokers 345 may also have additional components. Edge brokers 345 may have an edge broker interface that provides a universal interface for querying and using the services and/or applications that are made available through the edge brokers 345. Edge brokers 345 may also have a service wrapper that allows legacy applications to be used within the framework of management module 305 by taking requests from the information exchange, formatting them in a way that the application can understand, requesting computational resources, running the application using the resources, gathering the results of the application, and making the results available on the information exchange. Edge brokers 345 may further include a service translator that allows applications that are not able to access the information exchange to be used within the framework of management module 305 by translating requests from the information exchange into service calls and placing the results of the service calls on the information exchange. Further, edge brokers 345 may include one or more user interfaces configured to provide direct access (e.g., user access) to the applications served by the broker. The user interfaces may be specific to the purpose of the broker or associated applications. In some embodiments, user interfaces may be provided for some edge brokers 345 and not provided for others.

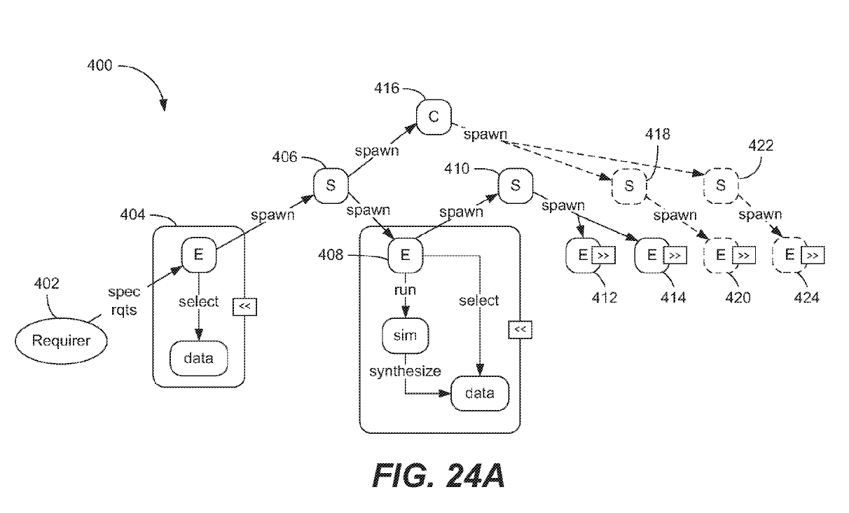

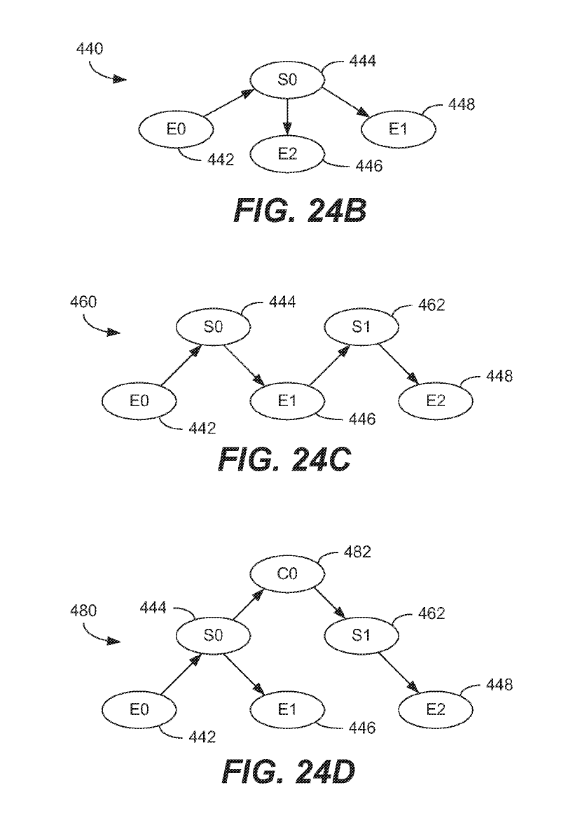

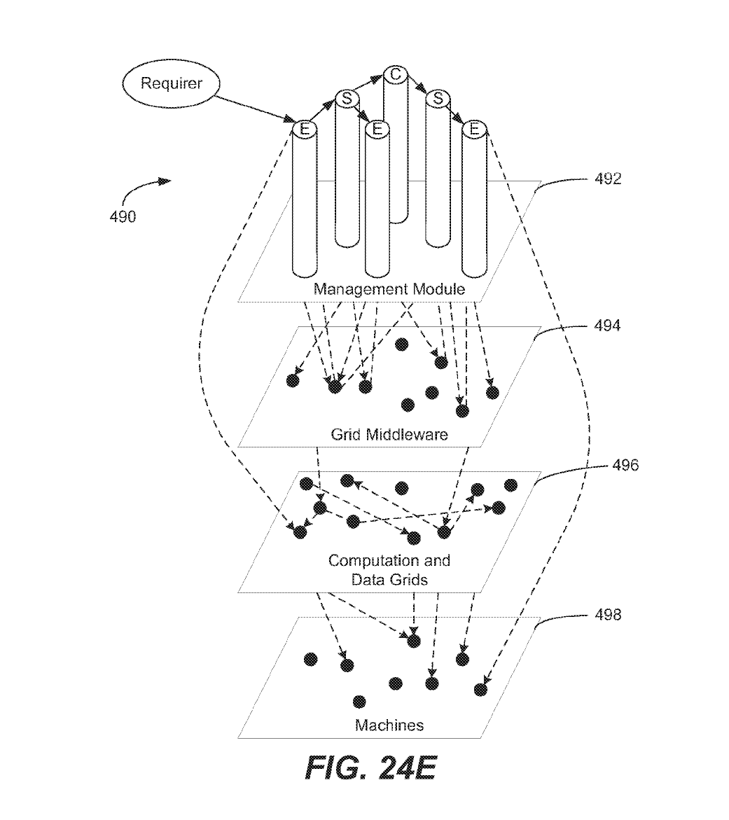

FIG. 24A shows a flow diagram illustrating an example data retrieval and broker spawning process 400, according to an example embodiment. In an initial step, a request is made (e.g., for access to particular data) by a requirer 402. An edge broker 404 responds to the request and collects certain data relevant to the request that it is able to access. Edge broker 404 determines that it is unable to access certain information required to complete the request and spawns service broker 406 to retrieve the required information that it is unable to access. Service broker 406 spawns an edge broker 408 to run a simulation needed to complete the request. In order to run the simulation, edge broker 408 requires information from sources to which it does not have access and, accordingly, edge broker 408 spawns service broker 410 to retrieve the needed information. Service broker 410 in turn spawns edge brokers 412 and 414 to collect the information and write it to the information exchange of service broker 410.

In addition to the simulation results provided by edge broker 408, service broker 406 determines that additional data is needed to complete the request. In some embodiments, management module 305 may include coordination brokers that may spawn one or more service brokers and provide even higher-level coordination than service brokers for fulfilling requests. In the example shown in FIG. 24A, service broker 406 spawns a coordination broker 416, which in turn spawns two service brokers 418 and 422 to collect the required information. Service brokers 418 and 422 spawn edge brokers 420 and 424, respectively, to retrieve the remaining information. In some examples, at least one of the brokers may request information from a user 242 as described herein, e.g., with reference to FIGS. 1-20. The information received from the user may include, for example, information the user deems pertinent to the forecast being determined or other simulation being run.

FIGS. 24B-24D show, respectively, three example broker structures illustrating different ways of partitioning information using brokers, according to example embodiments. In the example structure 440 shown in FIG. 24B, an edge broker 442 spawns a service broker 444, which in turn spawns two edge brokers 446 and 448. Service broker 444 is the parent of edge brokers 446 and 448 and has access to all the information resources available to edge brokers 446 and 448. The example structure 460 shown in FIG. 24C includes the same edge brokers 442, 446, and 448 and service broker 444 as in structure 440 and also includes a service broker 462. However, in structure 460 service broker 444 is only the parent of edge broker 446. Edge broker 446 spawns service broker 462, which in turn spawns edge broker 448. In structure 460, service broker 462 has access to all the information resources available to edge broker 446 but does not have access to the information resources of edge broker 448. Service broker 462, the parent of edge broker 448 in structure 460, has access to the information resources of edge broker 448. The example structure 480 shown in FIG. 24D includes the same brokers as in FIG. 24C and also includes a coordination broker 482. Service broker 444 spawns edge broker 446 and also spawns coordination broker 482. Coordination broker 482 spawns service broker 462, which spawns edge broker 448. In structure 480, coordination broker 482 and service broker 462 have access to all of the information resources available to edge broker 448, but service broker 444 does not have access to the information resources available to edge broker 448 except as they may be represented to service broker 444 by coordination broker 482. As can be seen from comparison of structures 440, 460, and 480, access to information resources can be controlled and partitioned in different ways based on the relationship between brokers and how brokers are spawned.

FIG. 24E shows a diagram of a control structure 490 relating to management module 305, according to an example embodiment. Control structure 490 includes a management module level 492, a grid middleware level 494, a computation and data grid level 496, and a machine resource level 498. As shown in control structure 490, edge brokers at management module level 492 interact with grid middleware in grid middleware level 494 to provide access to information resources. Grid middleware utilized by the edge brokers may include Globus, CondorG, Narada, etc. Edge brokers may also interact directly with lower-level resources, such as computational and/or data resources in computation and data grid level 496 or physical machine resources in machine resource level 498.

According to different embodiments, communication can be performed in different ways, depending on the performance needed and the quantity of data to be exchanged. In one embodiment, exchange of data can be mediated completely through levels of brokers, following the interaction paths shown in the examples above. If higher performance is needed, edge brokers connected to the same service broker may be allowed to directly access the service broker's information exchange, allowing data to be placed on or retrieved from the information exchange with no intermediate steps. If higher performance yet is desired, a service address may be communicated between two components and the components may use the service to directly exchange data. The service may be a web service, a communication protocol such as HTTP or FTP, a specialized protocol designed to transfer large amounts of data, or another type of service. The components may use the service to negotiate a communication protocol that they both understand.

Referring back to FIG. 23, management module 305 may also include several types of brokers directed to specific purposes. Management module 305 may include one or more data brokers 355 to manage data utilized by management module 305, including storing, retrieving, organizing, and/or cataloguing the data. Data broker 355 may interact with any broker requiring access to data associated with management module 305. Data broker 355 may offer general interfaces (e.g., where data can be accessed without prior knowledge of data location, organization, storage method, format, etc., such as through using exchanges of metadata with the client) and/or specific interfaces (e.g., an SQL query to a relational database) to access data.

Data broker 355 may include a request component that provides a user interface that can be used to interact with management module 305 data. In one embodiment, the user interface is a graphical user interface provided in a web browser that allows a user to browse, select, modify, and store data. Input may be provided via a form (e.g., an HTML form) submitted via the web browser, and output may include forms submitted back to the user via the web browser and requests submitted to a data service component of data broker 355, discussed below, via the information exchange of data broker 355.

Data broker 355 may also include a data service component that serves as a database-type-specific manager for management module 305 data. The data service component may service both database-independent and database-specific requests. Each data broker 355 may require a separate data service component for each type of database being serviced by the data broker 355. For example, if a data broker 355 is configured to service both relational databases and XML repositories, the data broker may require at least two separate data service component instances. The data service component may receive requests for data, metadata, data updates, etc. and provide response submissions, requested data, metadata, data modifications, etc. Output data may be placed in a database table, placed in a URL, provided directly to a user's web browser, or stored and/or communicated in another way.

Management module 305 may also include one or more data set construction brokers 360 configured to construct and manage input data sets used by management module 305. Data set construction may include at least three phases: (1) identifying data for extraction/modification, (2) for selected data, performing data set-specific construction operations and extracting subsets of the selected data, and (3) for selected data, outputting resultant data sets. The first two phases may be generally applicable to all tasks addressed by data set construction broker 360. In some embodiments, the third phase may be application-specific and may be determined at least in part based on the needs of the desired application.

In some embodiments, data set construction broker 360 may provide interactive and automated capabilities in which new behavior can be acquired by recording and abstracting sequences of interactive operations. First, users may interactively explore available data, extract data, create or modify data operations, develop chained operation sequences, save result data subsets for future use, and/or perform other tasks. Further, scripts may be selected from a catalogued library, automating the data set creation process. Additionally, an automated template generation component may be activated whereby sequences of interactive operations are recorded, aggregated into scripts, parameterized for more general use, and catalogued in a library.

Data set construction broker 360 may include a request component through which a user may interact with and/or manipulate management module 305 input data sets. The request component of data set construction broker 360 may share properties similar to that of data broker 355 (e.g., web browser interface). The request component may also include subcomponents such as a database request subcomponent, a broker-specific request subcomponent, a script request subcomponent, and a data extraction request subcomponent. The database request subcomponent is configured to provide an interface to guide a user through building database-independent requests for data and/or data updates. In some embodiments, the database request subcomponent may utilize database metadata provided through a web browser interface to build the requests. The broker-specific subcomponent is configured to provide data set-specific user interfaces for data set construction (e.g., customized based on the input data, such as transportation-related data, epidemic-related data, etc.). The script request subcomponent is configured to provide control of generation and parameterization of data set construction scripts. The data extraction request subcomponent is configured to work with other subcomponents to facilitate generation of chained sequences of database operations to construct a management module 305 input data set. Data set construction broker 360 may also include a core service component, including subcomponents (e.g., database service, broker-specific service, script service, or data extraction service) directed to processing requests received from the subcomponents of the request component of data set construction broker 360.

Management module 305 may further include one or more entity brokers 365 configured to assist in the creation and modification of the synthetic population. Entity broker 365 functions as an edge broker for accessing services of population construction module 310. Entity broker 365 has knowledge of and access to the services of population construction module 310 and publishes those services on its information exchange. Entity broker 365 includes the same components of an edge broker (e.g., information exchange, interface, service translator, service wrapper, etc.) and may also include specialized components for managing interactions between management module 305 and population construction module 310. Greater detail regarding population construction and modification is provided below with reference to the components of population construction module 310.

Management module 305 may include further specialized brokers as needed to perform various functions of management module 305. In various embodiments, management module 305 may include one or more model brokers 370 configured to provide access to models and simulations, one or more resource brokers 375 configured to manage requests for computational resources, and/or one or more security brokers 380 configured to provide security (e.g., authentication and authorization) services within management module 305.

Population construction module 310 is configured to construct and/or modify the synthetic population used by management module 305, network construction module 315, and/or other components of synthetic data set subsystem 104 to create the desired situation representation. The synthetic population includes synthetic entities that may represent entities in a real geographic area (e.g., the United States) or a virtual universe. Each synthetic entity has a set of characteristics or attributes that may be assigned based on information from one or more input data sets (e.g., the U.S. Census). Each synthetic entity may be assigned to one or more subpopulations of the synthetic population (e.g., military unit, factory workers for a specific factory, students or teachers at a specific school, etc.). Further, each synthetic entity may be associated with a sequence of actions that may define what the actions are and where and when the actions occur. The interactions between synthetic entities in the synthetic population may be based at least in part on the activity sequences of the synthetic entities. Population construction module 310 receives requests from management module 305 and responds to the requests through one or more entity brokers. Population construction module 310 may also utilize external data (e.g., received from surveillance subsystem 106) and/or information about the experiment or desired situation representation (e.g., received from management module 305 and/or decision analysis subsystem 108) in constructing and modifying the synthetic population. In one embodiment, all information required to generate the synthetic population may be collected via entity brokers.

Population construction module 310 may include several component modules. Population generation module 320 is configured to generate the synthetic population for use in constructing the desired situation representation. Population generation module 320 may be configured to construct the synthetic population by performing steps shown in FIG. 22B (e.g., steps 222 through 232). External input data used to initially construct the synthetic population (e.g., define the synthetic entities that comprise the synthetic population) may be based upon the type of synthetic population being constructed. For example, synthetic population representing a population of humans may be derived from census data, survey data, etc. Attributes assigned to each synthetic entity may also be based upon the population type. A synthetic human population derived from census or marketing data may be assigned attributes such as age, income, vehicle ownership, gender, education level, etc. A synthetic insect population may be assigned attributes such as genus and genotype. Synthetic entities may be assigned to one or more groups, which may also be dependent upon the type of population. For example, synthetic entities in a synthetic human population may be grouped by household, occupation, communication device ownership, income level, etc. Synthetic entities in a synthetic plant population may be grouped by genetic modification or growth requirements. Synthetic entities in a synthetic insect population may be grouped by resistance to a particular insecticide or probability to transmit a disease.

Population generation module 320 may also assign activity templates and generate activity schedules in a manner similar to that described above with respect to FIG. 22B (e.g., steps 226 through 232). Activity sequence assignments may be made based on attributes of the synthetic entities in the synthetic population, group memberships of the synthetic entities, external data, random assignments, and/or other methods. Activity sequences may provide start times, durations and/or end times, and locations for each of the actions in the sequences. The locations may include geographic coordinates (e.g., an absolute identifier) in a real or virtual coordinate system or a location identifier (e.g., a relative identifier) that has meaning in the universe of the population.

Population editing module 325 is configured to modify and/or add information about synthetic entities in the synthetic population. Requests for modification may be made by management module 305 and conveyed to population editing module 325 by an entity broker. Based on a request, population editing module 325 may select one or more entities or groups from the synthetic population and add or modify attributes of the selected entities or groups. Population editing module 325 may utilize external data and/or scenario information in interpreting the requests and/or modifying the attributes.

Subpopulation module 330 is configured to define subpopulations from the synthetic population and apply modifications to the subpopulations. In some embodiments, synthetic entities may be members of multiple subpopulations. Subpopulation module 330 receives requests for creation or modification of subpopulations from management module 305 via an entity broker and generates a modification plan (e.g., sets of modifications to action sequences, attributes, etc.) that can be executed by management module 305, population construction module 310, and/or other modules of synthetic data set subsystem 104. Scenario information and/or external data may be used to process subpopulation requests and/or produce the modification plan.

In one embodiment, subpopulation module 330 may be configured to modify action sequences associated with one or more subpopulations of synthetic entities. The subpopulation to be modified may be based on a function of the demographics or attributes associated with the synthetic population and/or external data that is specific to the scenario being studied. Demographics may include, for example, income, home location, worker status, susceptibility to disease, etc. Examples of external data may include the probability that entities of a certain demographic class take airline trips or whether a specific plot of land has been sprayed with a pesticide. Once the subpopulation to be modified is identified, replacement activity sequences are identified for the subpopulation. The selected replacement activity sequences may be identified from a set of possible replacement activity sequences based on external data and/or information regarding the scenario being studied. Replacement activity sequences may include activities performed in a city other than a home city, military assignments, withdrawal to home during a pandemic, or other activities. In some embodiments, subpopulation module 330 may be configured to define multiple representations of one or more synthetic entities (e.g., having different attributes and/or activity sequences) and to determine which representation to select based on the external data and/or scenario information.

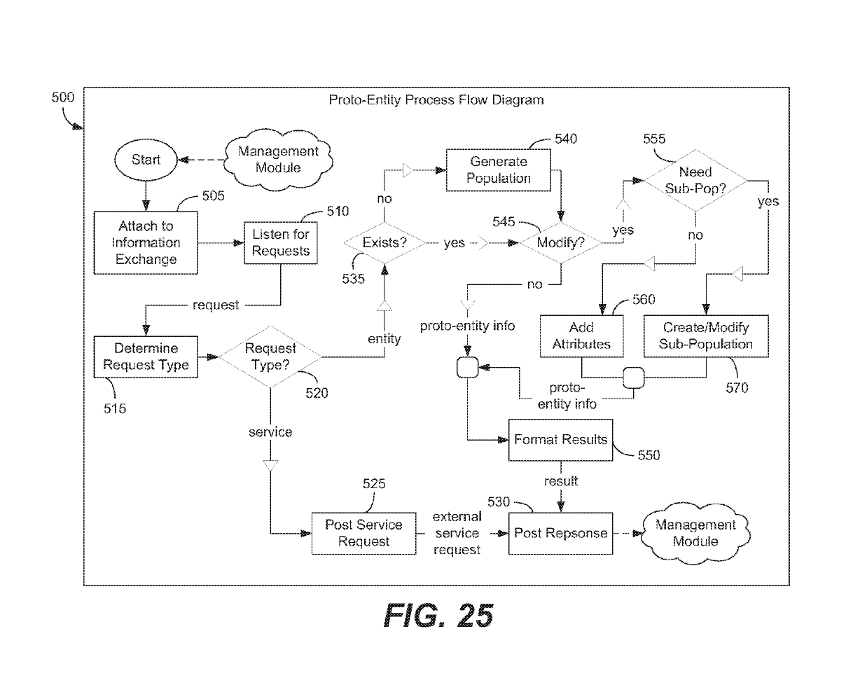

FIG. 25 shows a flow diagram for a process 500 that may be used by population construction module 310 to create and/or modify a synthetic population, according to an example embodiment. Process 500 begins with an entity broker monitoring the information exchange (step 505) and listening for requests (step 510). Once the entity broker receives a request, the type of the request is determined (steps 515 and 520). If the request is for a service not provided by population construction module 310, the entity broker posts the request to the information exchanges (step 525) and responds to management module 305 (step 530).

If the request is an entity request, or a request for a service provided by population construction module 310, it is determined whether the synthetic population and/or synthetic entity associated with the request already exists (step 535). If not, population generation module 320 generates the synthetic population and/or synthetic entity (step 540) and proceeds to step 545. If the synthetic population and/or synthetic entity already exists, process 500 proceeds to step 545. At step 545, it is determined whether the request is to modify the synthetic population. If the request does not include modifying the synthetic population, the desired information about the population is provided and formatted (step 550) and presented to management module 305 (step 530). If the request includes modifying the synthetic population, it is determined whether the creation or modification of a subpopulation has been requested (step 555). If not, population editing module 325 makes any requested changes or additions to the attributes of one or more of the synthetic entities of the synthetic population (step 560), and the entity broker formats the results (step 550) and posts the results to management module 305 (step 530). If the request includes creating or modifying a subpopulation, subpopulation module 330 performs the request subpopulation creation/modification (step 570), and the entity broker formats the results (step 550) and posts the results to management module 305 (step 530).

Referring again to FIG. 23, network construction module 315 is configured to generate a social contact network based on the interactions between synthetic entities in the synthetic population and to measure and analyze the generated network. Network construction module 315 may include a network generation module 335 and a network analysis module 340. Network generation module 335 is configured to generate a social contact network (e.g., represented as a graph such as a hypergraph) based on the interactions between synthetic entities from the synthetic population. The graphs generated by network generation module 335 may be time-dependent or static projections of time-dependent graphs. Each vertex of the graphs represents an entity related to the interactions between entities of the synthetic population and can be linked to attributes, group assignments, actions sequences, and/or other characteristics associated with the entity. Each edge of the graphs represents an interaction between synthetic entities and can be linked to an action from which it is derived. Network generation module 335 may also be configured to translate the desired situation representation into a mathematical specification of the simulation associated with the situation and generate the graph based on the mathematic specification of the simulation. Network generation module 335 may utilize entity brokers and/or other brokers to obtain population information and publish information about the generated graphs.

In one example embodiment, the situation being represented may relate to determining participation in a cellular phone connection. The vertices of the resulting graph may represent people, locations, and cellular towers. Edges may connect all vertices representing people on a particular cellular phone call, locations of those people, and cellular towers involved in the call.

Network analysis module 340 is configured to compute structural measurements on the graphs generated by network generation module 335. Types of measurement methods may include degree distribution, RO-distribution, shortest path distribution, shattering, expansion, betweenness, etc. The measurements performed by network analysis module 340 provide quantitative methods to compare different graphs and, accordingly, different situation representations (e.g., corresponding to different decisions and/or different action choices presented in decision analysis subsystem 108). The measurements may require less computational power than performing a complete simulation and may allow a more efficient understanding of the dynamics of the situation being represented. The measurements performed by network analysis module 340 may be used (e.g., in combination with features of other components of system 102 in some embodiments) to infer statistical and protocol level interactions, rank various (e.g., user-defined) policies in an order, and/or infer any inherent uncertainty in the output.

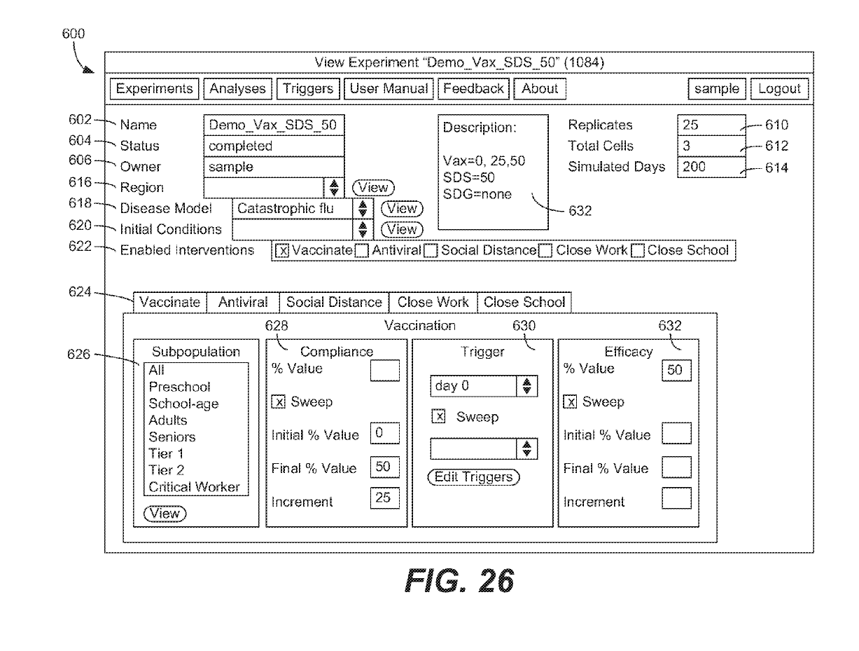

FIG. 26 shows a sample user interface 600 that may be utilized by a user to interact with system 102 is shown, according to an example embodiment. User interface 600 may be one user interface provided with regard to representing the spread of a disease in a particular geographic area. User interface 600 includes several fields that may be used to receive input from the user and/or provide information to the user. Name field 602 allows the user to view and edit the name of the experiment being conducted. Status field 604 presents the current status (e.g., incomplete, completed, etc.) of the experiment. Owner field 606 allows the user to view and edit the owner or creator of the experiment. Description field 608 provides a description of various characteristics of the experiment. Replicate field 610 allows the user to view and edit the number of replicates, or independent computer runs or cycles for a fixed set of input parameters, associated with the experiment. Cell field 612 allows the user to view and edit the number of cells, or scenarios for a specific set of input parameters, associated with the experiment. Time field 614 allows the user to view and edit the amount of time (e.g., number of days) that the experiment covers. Region field 616 permits the user to specify the relevant geographic region for the experiment. Region field 616 may include several predefined geographic regions from which the user can select (e.g., through a drop-down menu). Disease field 618 allows the user to specify the disease or diseases being studied in the experiment. Disease field 618 may include several predefined diseases from which the user can select. Initial conditions field 620 permits the user to select the conditions present at the onset of the experiment and may include several predefined conditions from which the user can select.

Intervention field 622 allows the user to select from one or more available intervention methods to define the methods that are enabled in the experiment. Intervention tabs 624 include tabs for each selected intervention method. In one embodiment, tabs may be displayed for all available intervention methods but only the tabs selected in intervention field 622 may be active. In the displayed example embodiment, the vaccination intervention tab has been selected and a vaccination menu is displayed. The vaccination menu includes a subpopulation field 626 that may be used to select some or all of the subpopulations defined by subpopulation module 330 to receive the defined vaccination intervention. Compliance field 628 allows the user to specify parameters regarding compliance of the selected subpopulation(s) in obtaining vaccinations (e.g., percent of selected entities that obtain vaccination, initial vaccination percentage, final vaccination percentage, etc.). Trigger field 630 allows the user to specify when the vaccination intervention is triggered in the experiment (e.g., the day of the experiment on which the vaccination is provided to the selected subpopulation(s)). Efficacy field 632 permits the user to define how effective the vaccine is in fighting the disease (e.g., percent of selected population for which the vaccine is effective, initial effectiveness, final effectiveness, etc.).

User interface 600 is only one possible interface that may be provided by system 102. A wide variety of options and information may be provided to the user based on the type of experiment being conducted. The user interfaces presented to the user may be modified to include different and/or additional information and options based on the models in case modeling subsystem 110. In some embodiments, users may be permitted to select the level of detail with which to specify the parameters of the experiment (e.g., permit system 102 to define certain parameters of the experiment using default values). Other example user interfaces and components thereof are described herein, e.g., with reference to FIG. 12-17 or 20.

### Example Clauses

Various examples include one or more of, including any combination of any number of, the following example features. Throughout these clauses, parenthetical remarks are for example and explanation, and are not limiting. Parenthetical remarks given in this Example Clauses section with respect to specific language apply to corresponding language throughout this section, unless otherwise indicated.

A: A method comprising, under control of at least one processor: receiving first attributes of a first synthetic population; selecting a first synthetic-population graph from a data library based at least in part on the first attributes; receiving a first forecast of progress of an epidemic in the first synthetic population; receiving second attributes of a second synthetic population; selecting a second synthetic-population graph from the data library based at least in part on the second attributes; receiving a second forecast of progress of the epidemic in the second synthetic population; and determining a disease model based at least in part on: the first forecast; the second forecast; and historical data of the epidemic; wherein the disease model is associated with: the epidemic; at least one of the first attributes; and at least one of the second attributes.

B: The method according to paragraph A, further comprising determining a third forecast of progress of the epidemic based at least in part on the disease model.

C: The method according to paragraph A or B, further comprising, before receiving at least one of the first forecast or the second forecast: receiving, via a communications interface, a request for a candidate set, the request associated with the at least one of the first forecast or the second forecast; determining the candidate set comprising a plurality of candidate forecasts of the epidemic based at least in part on at least one synthetic-population graph, wherein: each candidate forecast includes a plurality of observed data points and a separate plurality of candidate data points; and the at least one synthetic-population graph comprises the at least one of the first synthetic-population graph and the second synthetic-population graph corresponding to the at least one of the first forecast or the second forecast; and transmitting the candidate set via the communications interface.

D: The method according to paragraph C, wherein the plurality of candidate forecasts of the epidemic includes at least three candidate forecasts of the epidemic.

E: The method according to paragraph C or D, further comprising receiving at least one of the first forecast or the second forecast comprising respective rankings of one or more of the plurality of candidate forecasts.

F: The method according to paragraph E, further comprising receiving the at least one of the first forecast or the second forecast comprising respective rankings of each of the plurality of candidate forecasts.

G: The method according to any of paragraphs C-F, further comprising receiving at least one of the first forecast or the second forecast comprising a plurality of non-observation data points.

H: The method according to any of paragraphs C-G, further comprising: receiving the request for the candidate set after receiving the first forecast and before receiving the second forecast; and determining the plurality of candidate forecasts comprising the first forecast as one of the candidate forecasts.

I: The method according to any of paragraphs A-H, further comprising: determining first parameters of a first candidate disease model based at least in part on the first forecast; determining second parameters of a second candidate disease model based at least in part on the second forecast; determining at least one common attribute that is represented in both the first attributes and the second attributes; and determining the disease model by fitting the first candidate disease model and the second candidate disease model to the historical data of the epidemic, the fitting comprising modifying parameters of the disease model associated with the at least one common attribute.

J: The method according to any of paragraphs A-I, further comprising: selecting at least one parameter of at least one node or edge of at least one of the first synthetic-population graph or the second synthetic-population graph; and updating the at least one parameter based at least in part on the disease model.

K: The method according to any of paragraphs A-J, further comprising: receiving third attributes of a third synthetic population; selecting a third synthetic-population graph from a data library based at least in part on the third attributes; receiving a request for a second candidate set; determining the second candidate set comprising a plurality of candidate forecasts of the epidemic, wherein at least one of the plurality of candidate forecasts is based at least in part on the third synthetic-population graph and on the disease model; transmitting the candidate set via the communications interface; subsequent to the transmitting, receiving a third forecast of progress of an epidemic in the third synthetic population, wherein the third forecast is associated with the second candidate set; determining a second disease model based at least in part on the third forecast, wherein the disease model is associated with the epidemic and at least one of the third attribute.

L: A method, comprising: receiving first forecasts of progress of an event, each first forecast associated with a corresponding first account of a plurality of accounts; receiving, via a communications interface, a request for a candidate set; transmitting, via the communications interface, the candidate set comprising a plurality of candidate forecasts of progress of the event; receiving, via the communications interface, a second forecast of progress of the event, the second forecast associated with a second account of the plurality of accounts; determining a weight associated with the second account; and determining a third forecast of progress of the event based at least in part on: the second forecast; the weight; and at least one of the first forecasts.

M: The method according to paragraph L, further comprising transmitting, via the communications interface, the third forecast.

N: The method according to paragraph L or M, further comprising determining the weight indicating a participation level of the second account with respect to respective participation levels of other accounts of the plurality of accounts.

O: The method according to any of paragraphs L-N, wherein: the first forecasts comprise at least one fourth forecast associated with the second account and at least one fifth forecast not associated with the second account; and the method further comprises: determining a relative accuracy of the at least one fourth forecast with respect to the at least one fifth forecast based at least in part on historical data of the event; and determining the weight indicating the relative accuracy.

P: The method according to any of paragraphs L-O, further comprising determining the third forecast further based at least in part on an event model associated with the event.

Q: A method, comprising: receiving, via a user interface (UI), attributes of a synthetic population; presenting, via the UI, a plurality of candidate forecasts of an epidemic, each candidate forecast associated with the attributes and comprising respective forecast data of progress of the epidemic over time; and receiving, via the UI, a first forecast of the epidemic with respect to the synthetic population, the first forecast comprising at least one of: rankings of ones of the plurality of candidate forecasts; first data of progress of the epidemic over time; or at least one parameter of a model of the epidemic, the model providing estimated progress of the epidemic as a function of time.

R: The method according to paragraph Q, further comprising, before presenting the plurality of candidate forecasts, determining a count of candidate forecasts of the plurality of candidate forecasts based at least in part on a current date.

S: The method according to paragraph Q or R, further comprising, after receiving the first forecast: determining, based at least in part on the first forecast, a request; presenting, via the UI, the request; and receiving, via the UI, a response to the request.

T: The method according to paragraph S, further comprising, after receiving the first forecast comprising the rankings: determining that the rankings comprise rankings for fewer than all of the plurality of candidate forecasts; and requesting, via the UI, second rankings for ones of the plurality of candidate forecasts not included in the rankings.

U: The method according to any of paragraphs Q-T, further comprising: receiving, via the UI, account information comprising a first geographic indicator; and receiving the attributes comprising a second geographic indicator associated with the first geographic indicator.

V: A computer-readable medium, e.g., a computer storage medium, having thereon computer-executable instructions, the computer-executable instructions upon execution configuring a computer to perform operations as any of paragraphs A-K recites.

W: A device comprising: a processing unit; and a computer-readable medium, e.g., a computer storage medium, having thereon computer-executable instructions, the computer-executable instructions upon execution by the processing unit configuring the device to perform operations as any of paragraphs A-K recites.

X: A system comprising: means for processing; and means for storing having thereon computer-executable instructions, the computer-executable instructions including means to configure the system to carry out a method as any of paragraphs A-K recites.

Y: The device as paragraph X recites, wherein the processing unit comprises at least one of: an FPGA, an ASIC, a PLD, a GPU (or GPGPU) and accompanying program memory, or a CPU and accompanying program memory.

Z: A computer-readable medium, e.g., a computer storage medium, having thereon computer-executable instructions, the computer-executable instructions upon execution configuring a computer to perform operations as any of paragraphs L-P recites.

AA: A device comprising: a processing unit; and a computer-readable medium, e.g., a computer storage medium, having thereon computer-executable instructions, the computer-executable instructions upon execution by the processing unit configuring the device to perform operations as any of paragraphs L-P recites.

AB: A system comprising: means for processing; and means for storing having thereon computer-executable instructions, the computer-executable instructions including means to configure the system to carry out a method as any of paragraphs L-P recites.

AC: The device as paragraph AB recites, wherein the processing unit comprises at least one of: an FPGA, an ASIC, a PLD, a GPU (or GPGPU) and accompanying program memory, or a CPU and accompanying program memory.

AD: A computer-readable medium, e.g., a computer storage medium, having thereon computer-executable instructions, the computer-executable instructions upon execution configuring a computer to perform operations as any of paragraphs Q-U recites.

AE: A device comprising: a processing unit; and a computer-readable medium, e.g., a computer storage medium, having thereon computer-executable instructions, the computer-executable instructions upon execution by the processing unit configuring the device to perform operations as any of paragraphs Q-U recites.

AF: A system comprising: means for processing; and means for storing having thereon computer-executable instructions, the computer-executable instructions including means to configure the system to carry out a method as any of paragraphs Q-U recites.

AG: The device as paragraph AF recites, wherein the processing unit comprises at least one of: an FPGA, an ASIC, a PLD, a GPU (or GPGPU) and accompanying program memory, or a CPU and accompanying program memory.

### CONCLUSION

Example data transmissions (parallelograms) and example blocks in the process diagrams herein represent one or more operations that can be implemented in hardware, software, or a combination thereof to transmit or receive described data or conduct described exchanges. In the context of software, the illustrated blocks and exchanges represent computer-executable instructions that, when executed by one or more processors, cause the processors to transmit or receive the recited data. Generally, computer-executable instructions, e.g., stored in program modules that define operating logic, include routines, programs, objects, modules, components, data structures, and the like that perform particular functions or implement particular abstract data types. Except as expressly set forth herein, the order in which the operations or transmissions are described is not intended to be construed as a limitation, and any number of the described operations or transmissions can be executed or performed in any order, combined in any order, subdivided into multiple sub-operations or transmissions, and/or executed or transmitted in parallel to implement the described processes.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on particular circumstances. Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

Conditional language such as, among others, “can,” “could,” “might” or “may,” unless specifically stated otherwise, are understood within the context to present that certain examples include, while other examples do not include, certain features, elements or steps. Thus, such conditional language is not generally intended to imply that certain features, elements or steps are in any way required for one or more examples or that one or more examples necessarily include logic for deciding, with or without user input or prompting, whether certain features, elements or steps are included or are to be performed in any particular example.

The word “or” and the phrase “and/or” are used herein in an inclusive sense unless specifically stated otherwise. Accordingly, conjunctive language such as, but not limited to, at least one of the phrases “X, Y, or Z,” “at least X, Y, or Z,” “at least one of X, Y or Z,” and/or any of those phrases with “and/or” substituted for “or,” unless specifically stated otherwise, is to be understood as signifying that an item, term, etc., can be either X, Y, or Z, or a combination of any elements thereof (e.g., a combination of XY, XZ, YZ, and/or XYZ). Any use herein of phrases such as “X, or Y, or both” or “X, or Y, or combinations thereof” is for clarity of explanation and does not imply that language such as “X or Y” excludes the possibility of both X and Y, unless such exclusion is expressly stated. As used herein, language such as “one or more Xs” shall be considered synonymous with “at least one X” unless otherwise expressly specified. Any recitation of “one or more Xs” signifies that the described steps, operations, structures, or other features may, e.g., include, or be performed with respect to, exactly one X, or a plurality of Xs, in various examples, and that the described subject matter operates regardless of the number of Xs present.

Furthermore, although the subject matter has been described in language specific to structural features or methodological acts, it is to be understood that the subject matter defined in the appended claims is not necessarily limited to the specific features or acts described. Rather, the specific features and acts are disclosed as example forms of implementing the claims. Moreover, in the claims, any reference to a group of items provided by a preceding claim clause is a reference to at least some of the items in the group of items, unless specifically stated otherwise.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “example” as used herein to describe various embodiments is intended to indicate that such embodiments are possible examples, representations, and/or illustrations of possible embodiments. It should be noted that the orientation of various elements may differ according to other example embodiments, and that such variations are intended to be encompassed by the present disclosure. The construction and arrangement of elements shown in the various example embodiments is illustrative only. Other substitutions, modifications, changes, and omissions may also be made in the design and arrangement of the various example embodiments without departing from the scope of the present disclosure.

The present disclosure contemplates methods, systems and program products on any non-transitory (i.e., not merely signals in space) machine-readable media for accomplishing various operations. The embodiments of the present disclosure may be implemented using existing integrated circuits, computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although figures and/or description provided herein may show a specific order of method steps, the order of the steps may differ from what is depicted. Also two or more steps may be performed concurrently or with partial concurrence. In various embodiments, more, less or different steps may be utilized with regard to a particular method without departing from the scope of the present disclosure. Such variation will depend on the software and hardware systems chosen and on designer choice. All such variations are within the scope of the disclosure. Likewise, software implementations can be accomplished with standard programming techniques with rule based logic and other logic to accomplish the various connection steps, processing steps, comparison steps and decision steps.

1. A method comprising, under control of at least one processor:
receiving first attributes of a first synthetic population;
selecting a first synthetic-population graph from a data library based at least in part on the first attributes;
receiving a first forecast of progress of an epidemic in the first synthetic population;
receiving second attributes of a second synthetic population;
selecting a second synthetic-population graph from the data library based at least in part on the second attributes;
receiving a second forecast of progress of the epidemic in the second synthetic population; and
determining a disease model based at least in part on:
the first forecast;
the second forecast; and
historical data of the epidemic;
wherein the disease model is associated with:
the epidemic;
at least one of the first attributes; and
at least one of the second attributes.

2. The method according to claim 1, further comprising determining a third forecast of progress of the epidemic based at least in part on the disease model.

3. The method according to claim 1, further comprising, before receiving at least one of the first forecast or the second forecast:
receiving, via a communications interface, a request for a candidate set, the request associated with the at least one of the first forecast or the second forecast;
determining the candidate set comprising a plurality of candidate forecasts of the epidemic based at least in part on at least one synthetic-population graph, wherein:
each candidate forecast includes a plurality of observed data points and a separate plurality of candidate data points; and
the at least one synthetic-population graph comprises the at least one of the first synthetic-population graph and the second synthetic-population graph corresponding to the at least one of the first forecast or the second forecast; and
transmitting the candidate set via the communications interface.

4. The method according to claim 3, wherein the plurality of candidate forecasts of the epidemic includes at least three candidate forecasts of the epidemic.

5. The method according to claim 3, further comprising receiving at least one of the first forecast or the second forecast comprising respective rankings of one or more of the plurality of candidate forecasts.

6. The method according to claim 3, further comprising receiving at least one of the first forecast or the second forecast comprising a plurality of non-observation data points.

7. The method according to claim 3, further comprising:
receiving the request for the candidate set after receiving the first forecast and before receiving the second forecast; and
determining the plurality of candidate forecasts comprising the first forecast as one of the candidate forecasts.

8. The method according to claim 1, further comprising:
determining first parameters of a first candidate disease model based at least in part on the first forecast;
determining second parameters of a second candidate disease model based at least in part on the second forecast;
determining at least one common attribute that is represented in both the first attributes and the second attributes; and
determining the disease model by fitting the first candidate disease model and the second candidate disease model to the historical data of the epidemic, the fitting comprising modifying parameters of the disease model associated with the at least one common attribute.

9. The method according to claim 1, further comprising:
selecting at least one parameter of at least one node or edge of at least one of the first synthetic-population graph or the second synthetic-population graph; and
updating the at least one parameter based at least in part on the disease model.

10. The method according to claim 1, further comprising:
receiving third attributes of a third synthetic population;
selecting a third synthetic-population graph from a data library based at least in part on the third attributes;
receiving a request for a second candidate set;
determining the second candidate set comprising a plurality of candidate forecasts of the epidemic, wherein at least one of the plurality of candidate forecasts is based at least in part on the third synthetic-population graph and on the disease model;
transmitting the candidate set via the communications interface;
subsequent to the transmitting, receiving a third forecast of progress of an epidemic in the third synthetic population, wherein the third forecast is associated with the second candidate set;
determining a second disease model based at least in part on the third forecast, wherein the disease model is associated with the epidemic and at least one of the third attribute.

11. A method, comprising:
receiving first forecasts of progress of an event, each first forecast associated with a corresponding first account of a plurality of accounts;
receiving, via a communications interface, a request for a candidate set;
transmitting, via the communications interface, the candidate set comprising a plurality of candidate forecasts of progress of the event;
receiving, via the communications interface, a second forecast of progress of the event, the second forecast associated with a second account of the plurality of accounts;
determining a weight associated with the second account; and
determining a third forecast of progress of the event based at least in part on:
the second forecast;
the weight; and
at least one of the first forecasts.

12. The method according to claim 11, further comprising transmitting, via the communications interface, the third forecast.

13. The method according to claim 11, further comprising determining the weight indicating a participation level of the second account with respect to respective participation levels of other accounts of the plurality of accounts.

14. The method according to claim 11, wherein:
the first forecasts comprise at least one fourth forecast associated with the second account and at least one fifth forecast not associated with the second account; and
the method further comprises:
determining a relative accuracy of the at least one fourth forecast with respect to the at least one fifth forecast based at least in part on historical data of the event; and
determining the weight indicating the relative accuracy.

15. The method according to claim 11, further comprising determining the third forecast further based at least in part on an event model associated with the event.

16. A method, comprising:
receiving, via a user interface (UI), attributes of a synthetic population;
presenting, via the UI, a plurality of candidate forecasts of an epidemic, each candidate forecast associated with the attributes and comprising respective forecast data of progress of the epidemic over time; and
receiving, via the UI, a first forecast of the epidemic with respect to the synthetic population, the first forecast comprising at least one of:
rankings of ones of the plurality of candidate forecasts;
first data of progress of the epidemic over time; or
at least one parameter of a model of the epidemic, the model providing estimated progress of the epidemic as a function of time.

17. The method according to claim 16, further comprising, before presenting the plurality of candidate forecasts, determining a count of candidate forecasts of the plurality of candidate forecasts based at least in part on a current date.

18. The method according to claim 16, further comprising, after receiving the first forecast:
determining, based at least in part on the first forecast, a request;
presenting, via the UI, the request; and
receiving, via the UI, a response to the request.

19. The method according to claim 18, further comprising, after receiving the first forecast comprising the rankings:
determining that the rankings comprise rankings for fewer than all of the plurality of candidate forecasts; and
requesting, via the UI, second rankings for ones of the plurality of candidate forecasts not included in the rankings.

20. The method according to claim 16, further comprising:
receiving, via the UI, account information comprising a first geographic indicator; and
receiving the attributes comprising a second geographic indicator associated with the first geographic indicator.
